(19) United States
(12) Patent Application Publication
(10) Pub. No.: US 2025/0200956 A1
(43) Pub. Date: Jun. 19, 2025

(54) MULTISPECTRAL CAMOUFLAGE TESTING AND DEFEAT CAPABILITY

(71) Applicant: HUNAMIS, LLC, Southern Pines, NC (US)

(72) Inventor: Nicholas D.P. DRAKOS, Southern Pines, NC (US)

(21) Appl. No.: 18/982,178

(22) Filed: Dec. 16, 2024

Related U.S. Application Data
(60) Provisional application No. 63/610,971, filed on Dec. 15, 2023.

(51) Int. Cl. G06V 10/80; G06V 10/143; G06V 20/40; G06V 20/50; G06V 40/10; G06V 40/40

(52) U.S. Cl. CPC G06V 10/803; G06V 10/143; G06V 20/49; G06V 20/50; G06V 40/10; G06V 40/45; G06V 2201/05

(57) ABSTRACT

A camouflage defeat and testing system (1200) includes a network platform (1202) and one or more edge devices (1204). The platform (1202) and/or the edge device (1204) receive inputs from one or more sensor devices (1210-1213) monitoring an area of interest (1214). For example, the area of interest 1214 may be a battlefield or staging area of an adversary. In this case, the area of interest (1214) includes a target (1216) utilizing a camouflage technology (1218) such as multispectral camouflage. The system (1200) employs spatial and/or temporal processing to process images and the sensor devices (1210-1213) to defeat the camouflage technology (1218). The system (1200) can also be employed to test and optimize multispectral camouflage capabilities.

### RELATED APPLICATION INFORMATION

The present application is a non-provisional of U.S. Provisional Pat. Appl. Ser. No. 63/610,971 entitled, “Predictive Diagnostic Information/Intelligence Capability-Technology (PreDICT) Applications for Camouflage Defeat and Counter Camouflage Defeat Signature Management” filed on Dec. 15, 2023 (“the Parent Application”). The content of the Parent Application is incorporated herein by reference as if set forth in full and priority is claimed to the full extent allowable under U.S. law and regulations.

The present application also includes subject matter related to U.S. patent application Ser. No. 17/125,720, entitled “Predictive Diagnostic Information System,” filed on Dec. 17, 2020, and now issued as U.S. Pat. No. 11,978,558, and U.S. patent application Ser. No. 18/944,395, entitled, “Reliability Analysis for Time-Based Information Streams,” filed on Nov. 12, 2024 (“the Related Applications”). The Related Applications are incorporated herein by reference as if set forth in full though priority is not claimed. The Related Applications and the Parent Application are referred to herein as “the Hunamis Applications.”

### FIELD OF THE INVENTION

The present invention relates generally to camouflage technology and, in particular, to a system for defeating camouflage strategies including advanced detection countermeasures and for testing camouflage strategies.

### BACKGROUND OF THE INVENTION

Borrowing from nature, camouflage has been widely used by people for hundreds or even thousands of years. Camouflage may be used in military environments, hunting, intelligence, counter surveillance, and concealing or obscuring unsightly infrastructure, among other things. In the military context, as the range and accuracy of weaponry increased, camouflage became increasingly important to protect warfighters, equipment, and other resources from enemy fire, thus providing a tactical advantage. Early camouflage techniques often involved visual camouflage, e.g., adopting uniforms, paint schemes, other disruptive coloration, texturing, and constructions so that a protected target was difficult to distinguish from the background, the shape or movement of the target was difficult to determine or confused, or enemy tactics were otherwise thwarted. Note, in the context of the present invention, unless otherwise noted, “target(s)” refers broadly to human subjects, equipment, infrastructure, and any number of resources that a party may seek to detect and characterize through visual inspection and/or through the use of sensor technology for the purposes of, for example, warfare, intelligence, law enforcement, or even general interest.

Over time, technologies were developed to defeat camouflage. Camouflage defeat technologies include spectral detection, image analysis, and others. In spectral detection, an environment can be scanned using sensors operating in the UV, visual, near infrared, infrared, radar, and other spectral bands. These sensors can detect signals indicative of warfighters, equipment, or other resources, even if those resources have camouflage protection. Image analysis involves applying various image processing and software analysis to identify patterns or signatures indicative of resources of interest. Clearly, if one side in a conflict has a greater ability to defeat camouflage and identify military targets, that is a significant advantage.

Unsurprisingly, significant effort has been devoted to developing countermeasures or advanced camouflage techniques intended to counteract technologies for defeating camouflage. These include fabrics, suits (e.g., Ghillie suits), uniforms, screens, netting, and other products to interfere with spectral detection, image analysis, and other camouflage defeat technologies. These products may be desired to counteract sensors operating in specific spectral ranges or may be multispectral. Modern camouflage technologies include advanced stealth technologies such as multispectral camouflage clothing, tarps, netting, paints, and composites that block, absorb, or alter radiation signatures across multiple spectral ranges including ultraviolet, visible spectrum, infrared, and radio frequencies to camouflage human subjects, equipment, and other targets of interest from detection. Commercial companies producing multispectral camouflage technologies include, but are not limited to, Ametrine, FibroTex, Spectral X, Saab, HyperStealth Biotechnology Corporation, Hyper Stealth Technology, and HiderX. It is apparent that advanced camouflage defeat technologies will be critical to achieving and maintaining tactical advantages in response to such countermeasures.

### SUMMARY OF THE INVENTION

The present invention concerns a system and method for employing logic (e.g., software, firmware, and/or hardware) to process images and video from multiple sensor types to defeat camouflage technologies capable of concealing human subjects, equipment, infrastructure, and other targets of interest across the visible and invisible electromagnetic spectrum. For convenience, such logic is sometimes referred to as “software” below. These camouflage technologies are broadly referred to as multispectral camouflage. The present invention can also be employed to test and optimize multispectral camouflage capabilities. The nature and intended use of the present invention primarily applies to sensitive military and intelligence applications.

Signature management and signature management defeat are critical issues on the modern battlefield. The U.S. Special Operations Command (USSOCOM) lists Signature Management as one of the three Special Operations Forces “hard problems” requiring particular focus for research, development, acquisition, and operational deployment in order to maintain the advantage of U.S. special operations Warfighters. Given the technological evolution of warfare, signature management will be even more important in the future. Warfare has evolved to rely heavily on remotely piloted systems, commonly referred to as “drones”, that act in the air, at sea, and on land to gather intelligence, perform critical functions, and deliver kinetic effects to the enemy.

This evolution was a salient feature of the U.S. Global War on Terror (GWOT) in the first two decades of the twenty-first century. The conflict between Armenia and Azerbaijan over the disputed Nagorno-Karabakh in the Fall of 2020 highlighted the powerful impact of drones on a conventional battlefield between closely matched combatants and the importance of air defense measures to counter drones and their effects. Azerbaijan employed drones very effectively both to disable high-value Armenian targets and for coordinating complex integrated attacks on Armenian forces. Drones have been a central narrative in the Russia-Ukraine conflict since the largescale Russian invasion of Ukraine in February of 2022 with both aerial and maritime drones being deployed with significant battlefield effects. In September 2024, China set a record for the number of aerial drones in a single drone display and the number of drones controlled by a single computer: 10,197. In November of 2024, North Korea's leader, Kim Jong-Un, announced that the development and manufacture of drones was a top military priority.

Warfare is now evolving from remotely piloted systems to near or fully autonomous systems and swarms of systems. Future large scale combat operations (LSCO) will likely see the employment of hundreds-of-thousands to millions of drones in multiple roles and across every echelon of the conflict. The ability to evade detection by the enemy sensors informing these systems and the ability to detect the enemy regardless of their signature management capabilities will determine dominance on the battlefield. Whichever side can achieve this will have tactical and strategic overmatch. The biggest risk to any combatant is a future where your adversaries can see you and you can't see them.

### Overview: Signature Management and Multispectral Camouflage

Signature management, in the military and intelligence context, refers to the effort and ability of an entity to avoid detection and/or to obscure its true characteristics relative to some sensing modality and parameters. Entities may include individual humans or groups of humans, equipment, hardware or some combination thereof. Sensing modalities may include, but are not limited to, natural human senses; Red-Green-Blue or greyscale video and static imagery; ultraviolet, electro-optical, infrared, thermal, polarization enhanced thermal imaging, and hyperspectral imaging techniques; active sensors such as RADAR, LiDAR, SONAR, and microwave; radiofrequency and electromagnetic; acoustic; and chemical detection techniques. Parameters include such factors as entity behavior patterns, so called patterns of life (POL), timing, location, interactions, and other information that may be gained by different sensing modalities.

Signature management requires an entity to maintain profile characteristics, relative to sensing modalities and/or parameters, below a so-called noise floor and/or consistent with a noise background to avoid detection at some signature threshold. For example, an entity is trying to manage its signature relative to electromagnetic sensing modalities in an urban environment. Cellphone electromagnetic radiofrequency signatures are ubiquitous in this environment and thus establish a noise floor and background. Air surveillance RADAR electromagnetic signatures are unusual in this environment. If the entity employs air surveillance RADAR in this environment it will create a distinct signature relative to the noise floor and noise background that may compromise the entity's signature management and enable detection of the entity. As another example, an entity in this same environment is trying to manage its signature relative to behavioral patterns. The entity is only using a cellphone and thus, remains at or below the electromagnetic noise floor. However, the entity only turns the cell phone on near a specific national embassy and in the vicinity of several sensitive military sites in the host country where the embassy is located. This creates a distinct, and, from a counter-surveillance standpoint, potentially concerning pattern that may compromise the entity's signature management relative to the noise background as most cellphone devices are not consistently turned on and off and only in sensitive locations.

Military camouflage is a form of signature management that traditionally seeks to conceal or obscure military personnel, equipment, and/or infrastructure relative to a visual noise floor or background in the visible light spectrum as perceived through direct human visual perception and/or through technical means such as imaging from drones, satellites, or other sensor imaging devices. For example, militaries employ uniforms, paint schemes, netting, and natural materials to help personnel, equipment, and infrastructure blend into the visual environment and to disrupt silhouettes, such as linear edges, that do not naturally occur in many environments. These traditional camouflage approaches are particularly effective in low light conditions that further challenge human and technical perception in the visible light spectrum. Over the past several decades, infrared (IR) imaging technologies have improved and proliferated to enable detection of human subjects, equipment, infrastructure, and other targets of interest even when they are employing traditional visible spectrum camouflage and under low light conditions. IR imaging and detection technologies include electro-optical image intensifiers, such as night-vision devices, and heat seeking and thermal imaging capabilities. These advances in battlefield imaging have precipitated advances in signature management technologies beyond the visible spectrum, so called multispectral camouflage, to defeat sensors across the electromagnetic spectrum, including but not limited to, ultraviolet, night-vision, and IR/thermal sensing capabilities.

Approaches to multispectral camouflage include, but are not limited to, decreasing IR reflectance; blocking or trapping IR/thermal energy; rapid equilibration of IR/thermal energy with the ambient environment; bending and scattering of light across the electromagnetic (EM) spectrum, to include the IR/thermal spectrum; and approaches that alter an entity's IR/thermal signature to conceal its true nature, for example, making a military vehicle look like a civilian vehicle. Additional approaches include: structural designs and paints, such as with stealth aircraft, to minimize effective reflectance of and to maximize absorption of RADAR signals, respectively, and fabrics with selective radio frequency bandpass filters to allow certain communication frequencies to pass while otherwise minimizing electromagnetic radiofrequency signature. These approaches may be employed individually or in combination and may be active or passive.

During the U.S. conflicts in Iraq and Afghanistan, adversaries used improvised techniques to camouflage themselves from U.S. IR/thermal sensors with reasonable success. These techniques included employing wet blankets as ponchos and hiding under blankets or other material while maintaining standoff from the body to allow a thermal heat trapping and dispersion layer. Others have employed improvised techniques using reflective thermal heat shells, such as the mylar-type blankets used for battlefield casualty hypothermia prevention, to trap IR/thermal radiation and evade detection by IR/thermal sensors. The internet, particularly sites like YouTube™, have videos where individuals discuss and demonstrate these techniques.

Today, there are an increasing number of advanced, purpose-manufactured, multispectral camouflage technologies, which correlates to a growing demand for these technologies driven by increasingly sophisticated military sensor technologies. One segment of this sector, the Global Thermal Countermeasure Market, is anticipated to nearly double from approximately $13 billion to $24 billion from 2023 to 2033, per Research and Markets, a market research firm. Multispectral camouflage is designed to provide concealment from some or all sensors across the electromagnetic spectrum, from UV to radio waves in the ultraviolet, visual, near IR, shortwave IR, mid and longwave IR, including thermal, RADAR, and communications radio bands. Current uniform, netting, and tarp systems generally focus on the UV-LWIR but some also include radio bands. It is anticipated that these multispectral camouflage technologies will improve to each encompass camouflage across more of the electromagnetic spectrum and to provide more effective camouflage within each spectral band. Manufactures of multispectral camouflage include, but are not limited to: Ametrine™ and FibroTex™, with a combined over $500 million in contracts with the U.S. military to provide multispectral camouflage uniforms, netting, and tarp type systems (Ultra-Lightweight Camouflage Net System (ULCANS)); SpectralX™ a manufacture of multispectral camouflage systems that can be rapidly formed to look like natural terrain features, such as rocks; HiderX, a Russian multispectral camouflage manufacturer with products similar to Ametrine™ and FibroTex™; and Saab Defense, which manufactures their Barracuda multispectral camouflage system for personnel, small equipment, and large equipment, such as heavy military vehicles. Saab Barracuda multispectral camouflage is advertised as a “true multispectral” capability against a wide range of sensors including: ultraviolet (UV), visual (VIS), near infrared (NIR), short-wave infrared (SWIR), thermal infrared (TIR), and RADAR. However, it should be noted, the other manufactured camouflage brands mentioned herein advertise similar or identical capabilities to Saab. HyperStealth Biotechnology Corporation developed a technology called Quantum Stealth™ that provides an example of another approach to multispectral camouflage. Quantum Stealth™ bends and scatters the light of objects or human subjects behind it to conceal or otherwise alter their signature from observation and detection by humans or sensors across the UV, visible, and IR spectrum.

This section provided a broad, though not exhaustive, overview of signature management and multispectral camouflage. The present invention integrates sensor technologies, computing platforms, software processing, and artificial intelligence machine learning approaches to aid in detection of human subjects, equipment, infrastructure, and other targets of interest concealed or obscured by the full range of existing and developing multispectral camouflage technologies. However, by way of example, the descriptions herein will primarily focus on infrared (IR) multispectral camouflage technologies that provide protection against some of the most common visual battlefield sensors, which operate in the near IR (NIR) to thermal IR (TIR) range and include electro-optical image enhancement (night-vision) and thermal vision sensors.

### Multispectral Camouflage Testing and Defeat: A Critical Capability on the Contemporary and Future Battlefield

A multispectral camouflage uniform, tarp, or netting that costs several thousand dollars can hide the IR/thermal signature of a human subject, piece of equipment, or other target of interest from a multi-million dollar intelligence, surveillance, and reconnaissance (ISR) platform or a multi-billion dollar satellite system. Adversary multispectral camouflage threatens key technological advantages of the U.S. Warfighter and nullifies billions of dollars in U.S. defense and intelligence spending on advanced sensor capabilities and related platforms and infrastructure to deploy and maintain those sensor capabilities.

Several countries, including U.S. adversaries, are currently developing multispectral camouflage capabilities. Russia began deploying an advanced manufactured multispectral camouflage uniform and tarp technology (HiderX) on the battlefield in Ukraine in early 2024. Notably, the U.S. appears to have a limited commercial base of organic multispectral camouflage research and development. The two primary suppliers of multispectral camouflage uniforms, tarps, and netting to the U.S. military are Ametrine™ and FibroTex™, which are both Israeli companies with U.S. subsidiaries that supply the U.S. military.

The first country to have both advanced multispectral camouflage and multispectral camouflage defeat capabilities will be positioned to rapidly extend their advantage over their adversaries. The synergy between the two capabilities enables the use of multispectral camouflage to develop multispectral camouflage defeat capabilities, which allows the use of the defeat capabilities to improve the multispectral camouflage, which enables the use of the improved multispectral camouflage to further advance the defeat capabilities and so on in a reinforcing cycle.

Deployable adversary multispectral camouflage defeat technologies that leave U.S. and allied forces vulnerable are within reach. The present invention (currently named PreDICT™, a software for multispectral camouflage testing and defeat, developed by Hunamis, LLC) has demonstrated the ability to defeat both Ametrine™ and FibroTex™ multispectral camouflage technologies. Ametrine™ and FibroTex™ have a combined over $500 million in contracts with the U.S. military and their products are currently being purchased and tested by U.S. special operations forces. The present invention has also demonstrated the ability to defeat Russian HiderX multispectral camouflage and a Ukrainian multispectral camouflage poncho, which is likely based on the same multispectral technology purchased by the U.S. military. Both HiderX and the Ukrainian multispectral camouflage poncho are currently being fielded on the battlefield in Ukraine. If the present invention is within the capabilities of Hunamis, LLC, a start-up company, then a conceptually similar technology is within the capability of a state actor adversary of the U.S. Russia is particularly well positioned to develop a deployable multispectral camouflage defeat technology and, given Russia's relationship and interdependence with China, North Korea, and Iran, other U.S. adversaries may have access to multispectral camouflage defeat technology in the near future.

Another potentially concerning indicator of U.S. vulnerability with respect to multispectral camouflage defeat is China's academic research output in the area of computer science termed camouflage object detection (COD), of which multispectral camouflage defeat is a sub-set. A search of “camouflage object detection” in Google Scholar reveals that of the top fifty most-relevant academic research papers from 2020-2024, thirty-four papers were authored in whole or part by scientists affiliated with Chinese universities or research institutes. Thirty-one of those thirty-four papers were authored exclusively by scientists affiliated with Chinese universities or research institutes. In contrast, only six papers were authored in whole or part by scientists affiliated with U.S. universities or research institutes. Only one of those six papers was authored exclusively by scientists affiliated with U.S. universities or research institutes. Two of those six papers were authored in collaboration with Chinese university or research institute affiliated scientists. Russia's advantage in the multispectral camouflage and multispectral camouflage defeat space stems from the current battlefield dynamics in Ukraine. The deadly cat-and-mouse game between ground-based personnel and equipment and unmanned aerial systems (UAS) sensors (i.e. Drones) is a central narrative of the conflict in Ukraine. IR/thermal signature detection from the air and IR/thermal management on the ground is a key component of this cat-and-mouse game. In response, both Ukraine and Russia deployed advanced manufactured multispectral camouflage capabilities for ground-based personnel in the late 2023 to early 2024 timeframe to improve IR/thermal signature management. Russia is positioned to improve their own multispectral camouflage technology (HiderX) and develop sensor capabilities to defeat multispectral camouflage in a real-time “battle lab.”

Development of multispectral camouflage defeat technology is enabled by a large video database of targets of interest concealed by multispectral camouflage. The more realistic the data the better the multispectral camouflage defeat technology derived from it is likely to be. Russia can gather IR/thermal sensor data on Ukrainian multispectral camouflage, as well as their own multispectral camouflage, in a real-world, kinetic conflict to build the ideal dataset for developing multispectral camouflage defeat technology. Russia has the technical capability and the motivation to exploit this data. Russian dominance over IR/thermal signature management and IR/thermal signature management defeat would provide a critical battlefield advantage over Ukraine today and represent a threat to U.S. military dominance in the future.

The development and proliferation of multispectral camouflage is tied to the proliferation of drone/counter-drone technology and will likely follow a similar evolutionary arc. Over roughly the past two decades, there was a phase of drone technology development that primarily focused on engineering effective drones and associated capabilities-range, speed, flight time, payloads, etc.—and determining how drones could best be employed-ISR, kinetic effects, etc. This was followed by a phase of counter drone technology development, which is evident in multiple ways on the battlefield in Ukraine. Chief among them is the highly contested electronic warfare (EW) environment between Russia and Ukraine that challenges the ability of drones to operate in multiple ways, such as interfering with communications between the drone and its operator and/or denying global positioning system (GPS) signals. Other examples are low-tech techniques, tactics, and procedures (TTPs), such as “turtle tanks” and tunneling into the sides of trench systems to hide from overhead drones. Multispectral camouflage is itself effectively a counter drone measure. The current phase of drone warfare evolution is counter-counter drone technology. In October 2024 the Wall Street Journal (WSJ) featured an article on U.S. drone company Shield AI. Their drones had recently demonstrated the ability to us artificial intelligence in GPS denied environments and operate in Ukraine's “brutal electronic warfare” environment after many U.S. drone companies had failed. The following month, the WSJ featured an article on Ukrainian produced drones that utilized a small onboard computer to guide them to their targets during the terminal attack phase. This innovation precludes tactical jamming systems from disrupting remote control signals to the drone during the final phase of attack and causing it to miss its target. Multispectral camouflage defeat is part of the counter-counter drone phase of drone evolution. Drones are a critical component of current and future warfare. Dominance in all three phases of drone technology-drone/counter-drone/counter-counter drone, including multispectral camouflage defeat-will be key to dominance on the battlefield. These concerns are addressed by the present invention.

In accordance with the present invention, a system and associated functionality (“utility”) is provided for defeat and testing of camouflage strategies. The utility involves providing a processing platform operative for one or both spatial analysis and temporal analysis of sensor data. The sensor information is processed to provide enhanced detection of a target in the sensor information. For example, the processing may render targets perceptible that would be invisible or difficult for a user to perceive from the unprocessed sensor data. The spatial analysis may involve implementing computer vision on the sensor data. In some implementations, the processing may involve an integrated analysis such as a multiple sensor analysis including multiple sensor feeds, a multimodal analysis using a number of detection modes (e.g., UV, visible, IR, RADAR, LiDAR, etc.), and/or multi-view analysis involving multiple views of an area of interest (e.g., from multiple drones). The temporal analysis may involve analyzing data obtained over a timeframe, e.g., video data. Such data may be analyzed to identify signature information consistent with a target of interest.

The utility further involves obtaining sensor information of an area of interest and processing the sensor information using one or both of the spatial analysis and the temporal analysis to obtain first signature information indicative of the presence or absence of a target of interest. The processing platform may be a network platform and/or an edge device (e.g., deployed on a battlefield) or user device. For certain applications, it will be appreciated that wireless transmissions to and from a remote network platform may be undesirable as such communications may be detectable by an adversary. The target may be a person or people, equipment, infrastructure, or other resource. The platform is further operative for processing the first signature information to provide an output concerning the presence or absence of the target. For example, the output may include an enhanced video display providing an indication of the target superimposed on or otherwise associated with video information.

The temporal analysis may involve obtaining video information, segmenting individual frames of the video information into elements, and monitoring changes of individual ones of said elements over a timeframe of said video information to obtain signature information. For example, the signature information may concern at least one of intensity, motion, color change, or a bio-physiologic signature. In certain implementations, the temporal data may be analyzed using a time-difference technique. A time-difference technique is a technique for detecting invisible and low-perceptibility signals in video primarily arising from motion and/or color change. One example of a time-difference technique is motion microscopy also referred to as motion amplification and related terms. Broadly, approaches to motion microscopy and motion amplification work by analyzing video in the time domain to amplify signals related to motion, color change, or other phenomena that manifest as pixel luminescence changes and processing the amplified signals to detect specific signals of interest. Various approaches to motion microscopy and amplification have been developed over the past several decades, including but not limited to Lagrangian and Eulerian techniques, and the camouflage defeat and testing system may employ any one of these techniques or novel techniques to process data and amplify invisible and low perceptibility signals. In this regard, a signal (e.g., associated with movement of a target) may be amplified in relation to a background or remaining portion of the video or other data stream. This may involve applying a first factor to emphasize the signal and/or a second factor to deemphasize the background or remaining portion. One specific approach that may be suitable for implementation on an edge device as described herein is a motion amplification technique that utilizes moving average differencing of information in the video time domain to obtain, for example, physiologic information from human subjects, including vital signs information, using live and/or recorded video of the subject. This approach to motion microscopy and amplification decreases the computing requirements of the system compared to other techniques. This moving average differencing approach is noted here as one of the motion microscopy and amplification approaches that may be utilized by the system as described in the Hunamis Applications.

The processing platform may be operative for distinguishing a human being from another living being or for distinguishing a living human being from a non-living human being or non-live entity, such as a piece of equipment. In this regard, the platform may determine information concerning signs of life or status of life. The camouflage strategies may include a cover, a concealment, or a camouflage material. In addition, the camouflage strategies may involve one of thermal, electromagnetic, acoustic, or other signature masking technique. The video may be a live video or a recorded video. Among other possibilities, the video may be a red-green-blue (RGB) or grayscale video, or a thermal, infrared, ultraviolet, or night-vision video.

Various processing techniques may be employed by the processing platform. In this regard, the processing platform may analyze the signature information using artificial intelligence/machine learning (AI/ML) processing. AI/ML processing includes both artificial intelligence functions where machines adapt like thinking humans as well as machine learning functions where machines learn to improve by identifying patterns, and specifically includes functionality such as convolutional neural network (CNN) algorithms and deep learning. Such technology enables the platform to continually learn to recognize signature information and patterns for revealing a camouflage target. The processing platform may receive sensor inputs separate from the video, such as audio inputs, secondary video source information, remote detection data, and the like. The processing platform may implement region of interest and/or signal of interest processing. The processing may be conducted in a time domain and a spatial domain. In some implementations, the signature information may be analyzed to identify or confirm a bio-physiological signature.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of the present invention, and further advantages thereof, reference is now made to the following detailed description taken in conjunction with the drawings, in which:

FIG. 1 is a schematic diagram of a risk stratification and medical diagnosis system in accordance with the present invention showing a first use case related to field use outside of a medical facility;

FIG. 2 is a schematic diagram of a risk stratification and medical diagnosis system in accordance with the present invention showing a second use case related to use within a medical facility;

FIGS. 3A-3B show a schematic diagram illustrating operation of a processing system of a risk stratification and medical diagnosis system in accordance with the present invention for data collection, correlation and model training;

FIG. 4 show a schematic diagram illustrating operation of a processing system of a risk stratification medical diagnosis system in accordance with the present invention for model deployment;

FIGS. 5A-11 are graphs depicting various time-risk relationships in various contexts and associated advantages of the present invention;

FIG. 12 is a schematic diagram of a camouflage defeat and testing system in accordance with the present invention;

FIG. 13 is a flow chart illustrating a camouflage defeat and testing process in accordance with the present invention; and

FIGS. 14A-23C are images illustrating the operation of the camouflage defeat and testing system of FIG. 12.

### DETAILED DESCRIPTION

The invention is set forth below in the context of a camouflage defeat and testing system for use in connection with military camouflage applications. Specific examples of camouflage defeat scenarios will be provided that may be used in detecting resources of adversaries or testing camouflage technologies. However, it will be appreciated that the invention is not limited to use in this context or these scenarios. Accordingly, the following description should be understood as exemplary and not by way of limitation.

The invention was developed in the context of, and leverages technologies developed for, the PreDICT system of Hunamis, LLC. That system is described in the Hunamis Applications which are incorporated herein by reference. That system can receive a variety of sensor inputs and employ time-difference processing techniques for medical evaluation in time constrained critical illness or injury contexts and deep fake video detection. To that end, the PreDICT System can process video inputs to detect a variety of parameters including changes in color, motion, and physiological parameters, such as pulse rate and breathing rate. Many of these parameters can be used in the camouflage defeat and testing system of the present invention.

In the following description, the camouflage defeat and testing system is first described, including examples of camouflage defeat scenarios. Thereafter, the PreDICT System is described in detailed. The description of the PreDICT System includes description of additional sensors, processing techniques, parameters, and other technology that can be incorporated into the camouflage defeat and testing system of the present invention in appropriate contexts.

### What the Present Invention is and how it Works:

The present invention is a system and method to enable current and future sensors to defeat multispectral camouflage. The goal of camouflage, both associated technologies and practices, alone and in combination, is to manage the signature of a human subject, equipment, infrastructure, or other entity, such that it is difficult to perceive or is effectively invisible to one or multiple sensing modalities. The present invention is a system and method to overcome the signature management capabilities of camouflage, cover, and/or concealment and render camouflaged, covered, and/or concealed entities more easily perceivable. This capability also provides a system and method for testing and improving multispectral camouflage technologies and employment. The enabling software component of the present invention, and optionality for deployment of the present invention, anticipates rapid evolution in camouflage technologies and is highly adaptable to counter this evolution.

The system is comprised of: 1) A sensor or multiple sensors, 2) A computing platform or multiple computing platforms, 3) A software capability, and 4) An output, which may be in the form of a screen for human users or may be only in the form of digital signals as for functioning in autonomous or semi-autonomous systems. The system functions to identify human subjects, equipment, infrastructure, and other targets of interest including when any or all of these entities are purposefully or circumstantially concealed or obscured, such as by any number of camouflage techniques or technologies, including multispectral camouflage. The purpose of identification may be, but is not limited to, intelligence, surveillance, reconnaissance, or targeting for military, law enforcement, or intelligence purposes. A specific example of a law enforcement application is Customs and Border Patrol employing the present invention to detect drug smuggling or human trafficking operations where perpetrators and/or malicious actors are employing multispectral camouflage technologies to cross over the border into the United States while avoiding detection from existing sensors.

The components may act together in each functional instance or may act in dynamic combinations. For example, the system may be integrated with an aerial drone conducting surveillance for a single enemy tank using a traditional thermal sensor and a polarized thermal sensor. The output of the system is real time grayscale video on a computer screen being viewed by a human user. The computer also serves as the computing platform hosting the system software and the human user can elect to run the software automatically on all ingested sensor information or elect to only activate it in specific circumstances. In this instance, the human user is not running the software automatically. The enemy tank is employing multispectral camouflage that significantly attenuates its traditional thermal signature making the enemy tank difficult for the human user to identify. However, the polarized thermal sensor is able to sufficiently detect the enemy tank and its characteristics, despite the camouflage, for the human user to positively identify it. In this case, a sensor and the output platform were the primary components utilized by the human user to obtain the necessary information. In a second example, that is the same as the first except software processing is employed on the computing platform, an object detection feature rapidly aids the human user in identifying the enemy tank. In this case, all components are utilized to aid the human user's detection of the enemy tank. In a third example, the aerial drone only has a traditional thermal sensor and the human end user is unable to discern the enemy tank on the video as it is concealed by multispectral camouflage. Enabling the software component of the invention, the software processes the video in real time on the processing platform to rapidly detect the enemy tank. In this case, multiple components are utilized to detect the enemy tank and all components are utilized to enable the human user to detect the tank. Lastly, all components of the system, including both the traditional thermal sensor and the polarized thermal sensor, can function together to provide multiple confirmatory information streams to identify the enemy tank. The tank is detected directly by the polarized thermal sensor and by the traditional thermal sensor stream through software processing.

The components of the system can also be replicated and networked across multiple platforms or feed information into a single computing node and/or output location. For example, multiple aerial drones, each equipped with multiple IR/thermal sensors, could be conducting surveillance on a target from multiple different angles. Each different field of view would provide different information, especially if, from some angles, the target was behind cover or concealment. The information from each of the aerial drones would then be processed and aggregated to provide a single and more complete output of the target characteristics than could be provided from any single point of view.

The system is compatible with existing and future battlefield sensors and computing platforms and deployable with and on these devices at “the edge” without requiring cloud or server connectivity. In this way, the system can function directly on edge devices without adding additional electromagnetic signature to sensor platforms or operators of the sensor platforms and without competing with other systems for communications bandwidth. The system may function with a cloud or server connectivity if tactically and operationally feasible, but it is not required for functionality of the system. The system may also connect to a cloud or a server at user determined intervals to allow the exchange of information and updates to the system software. This connection may occur wirelessly or through a direct cable connection. This is relevant to the artificial intelligence/machine learning (AI/ML) functionality of the software, which may exist on the cloud or a server. Individual iterations of the system are collecting data that may be utilized by the AI/ML algorithms enabling the software to improve the software. The software is improved as additional data is shared with the AI/ML algorithm. Improvements to the software are then transmitted as “updates” to individual iterations of the system.

### System Components and Integration:

SENSORS: The present invention may employ a range of individual sensor types, either individually or in a multimodal fashion to leverage different sensor inputs simultaneously. Part of the utility of the invention is that it can function with multiple sensor types, and given the dynamic nature of the battlefield, this provides optionality to end users; in a given instance, a particular sensor type may be optimal for making a particular determination, but it is not the sensor type available at that place and time. Sensors employed as part of the system may be on aerial, ground-based, or maritime remotely operated, semi-autonomous, or autonomous systems (drones); hand carried; mounted on weapons, such as optics, vehicles, or aircraft; may be positioned at static locations; part of low-earth-orbit (LEO) or other satellite systems; or employed with any number of platforms or configurations.

ACTIVE SENSORS: These include radio detection and ranging (RADAR), laser imaging detection and ranging (LiDAR), and microwave sensor technologies. Active sensor technologies provide potential advantages in multispectral camouflage defeat, especially with respect to the employment of environmental cover and concealment by adversaries to optimize the camouflage effectiveness. For example, hiding behind vegetation or buildings. These sensors may have the ability to detect human subjects, equipment, infrastructure, and other targets of interest concealed by certain multispectral camouflage technologies with minimal additional image processing by the system software. Each of these technologies has abilities to detect structural and/or motion features through obstacles and/or obscurants, such as fog or smoke. In other cases, such as with LiDAR, they can provide significant structural details of an environment that may help reveal camouflaged targets primarily by detecting even targets concealed by multispectral camouflage as structural anomalies in the environment. Other considerations, as with RADAR sensor technologies, are the ability to detect human physiology, such as heart rate and respiratory rate, and movement and to do so through obstacles such as walls. This technical capability provides advantages in defeating multispectral camouflage with minimal additional image processing by the system software. As with the LiDAR example, even if RADAR sensors cannot detect a target through the multispectral camouflage, its technical properties aid in characterizing a camouflaged target in such a way that it can be revealed as a human subject, equipment, infrastructure, or other target of interest.

Active sensing technologies also have notable drawbacks, particularly with respect to the likely characteristics of contemporary and future military conflict or intelligence operations in which they will be employed to defeat multispectral camouflage. The importance of signature management was previously discussed. In a highly contested electronic warfare environment, such as contemporary and future battlefields, active sensor technologies emit signals that enable detection by the adversary and potentially compromise signature management. Thus, active sensor technologies include risks ranging from enabling adversary intelligence gathering to enabling enemy kinetic targeting of friendly sensors, personnel, equipment, and/or infrastructure. Furthermore, active sensor technologies are relatively expensive and have associated size, weight, power, and cost (SWaP-C) considerations that may limit their wide deployablity on, for example, drones, especially in large scale combat operations (LSCO) that may entail millions of drones with high attrition rates. A consideration for RADAR sensors, and particularly small millimeter-wave RADAR devices that can detect small motions associated with equipment or human subjects, including physiological signals, and can see through obstacles and obscurants, is that they have a relatively small range, out to a maximum of several tens of meters for existing technologies. This limits the physical area that can be covered by these sensors and practically constrains their employment to situations where potential targets of interest have already been localized to a relatively small area or where the intent is to inspect a relatively small area to ensure that it is clear of potential threats that may otherwise be obscured by multispectral camouflage and/or cover and or concealment and/or obscurants such as smoke.

SPECIALIZED SENSORS: For the purposes of the present invention, the following types of contemporary sensor technologies include, but are not limited to, Polarized Thermal sensors, Cooled Thermal sensors, and Hyperspectral imaging sensors.

Polarized and cooled thermal sensors provide greater spatial resolution and detail than traditional or uncooled thermal sensors. This provides advantages in camouflaged object detection and multispectral camouflage defeat. As with active sensors, the level of detail provided by polarized and cooled thermal sensors may enable detection of camouflaged targets and targets employing multispectral camouflage with minimal processing by system software.

Polarized thermal sensors exploit the light polarization signature of targets of interest to provide enhanced contrast from the surrounding background and, in turn, greater spatial resolution of certain target types. Cooled thermal sensors employ technology, such as cryocoolers, to lower the temperature of the sensor to cryogenic temperatures. This reduces thermally-induced noise to a level below that of the signal from the environment being imaged. The result is increased spatial resolution as compared with uncooled thermal sensors.

Hyperspectral sensors cover a large number of spectral bands and provide high spectral resolution; they are able to distinguish light wavelengths very precisely. A significant advantage of hyperspectral imaging is the ability to identify and quantify materials. Because manufactured multispectral camouflage employs materials that are generally anomalous, at least in certain concentrations and combinations, in most natural and manmade environments, hyperspectral imaging can be employed to detect targets employing multispectral camouflage.

Disadvantages of these specialized sensors are primarily related to relatively high SWaP-C considerations, which also means that, at present, these sensors are not as widely employed as many other sensor types. Polarized thermal sensors are available in a small form-factor with sufficiently low weight, cubic dimensions, and power requirements that they are currently employable on aerial drone platforms. However, they are more expensive than many traditional thermal sensors and, prior to the advent of multispectral camouflage, do not have a clear advantage, relative to their limitations, over traditional thermal sensors for many battlefield applications. The cryocoolers employed by cooled thermal cameras add cost, weight, power and maintenance requirements. Hyperspectral imaging sensors have high computational processing requirements. The amount of data collected currently requires complex and resource intensive processing that, in addition to computational and power requirements, may increase the time to target detection. This presents a liability in the combat environment where dominance requires rapid observe-orient-decide-act (OODA) loop processing. Hyperspectral imaging is also sensitive to atmospheric conditions, which is a potential drawback for consistent employment, especially for employment from satellite systems.

TRADITIONAL SENSORS: Traditional imaging sensors refer to individual or multispectral sensors that function in and across the ultraviolet (UV), visible (VIS), and infrared (IR) spectrum. These types of sensors are widely used in civilian, law enforcement, military, and intelligence applications and include, but are not limited to, grayscale and red-green-blue (RGB) visible sensors; electro-optical image intensifier sensors, such as “night vision” sensors, that enhance visible light and convert near infrared (NIR) into visible light; Out of band (OOB) night vision devices that intensify any ambient light, UV, and short wave infrared (SWIR) light; thermal imaging sensors that typically function in the long wave infrared (LWIR) and or medium/mid wave infrared (MWIR) spectrum; and fusion capabilities that combine multiple types of imaging, such as image intensification and thermal imaging, together. These types of sensors and optics are widely distributed across military personnel and platforms and manifest in many different form factors to include: hand held; helmet, head, or personnel mounted; weapons mounted; static mounted or emplaced; land, maritime, aerial, or orbital space platform mounted, to include manned and unmanned systems, such as drones.

Because of the ubiquity of these sensor types, a primary goal of camouflage generally, to include multispectral camouflage technologies and associated techniques, tactics, and procedures (TTPs), is to decrease detection by these sensor types or, stated differently, to enhance signature management relative to these sensor types and, in turn, nullify the capabilities and associated advantages of these sensor types. A specific goal of the present invention is to restore and maintain the capabilities and associated advantages of these sensor types by applying software processing to the sensor imaging to detect camouflaged human subjects, equipment, infrastructure and other targets of interest, even if they are otherwise rendered difficult to detect or effectively invisible by multispectral camouflage technologies.

OTHER SENSORS: The present invention may also ingest, process, and/or utilize sensor information from multiple other sensor types for the purpose of detecting subjects, equipment, infrastructure, or other entities and/or defeating camouflage, including multispectral camouflage. These sensors include, but are not limited to, acoustic sensors, chemical detection sensors, radio-frequency sensors, sensors employed for remote photoplethysmography (rPPG), and other sensors that may be available to the system in the specific environment where it is employed. The present invention may also ingest and process other sensor inputs, such as, but not limited to, accelerometer and gyroscopic data, for the purpose of data normalization or other processing and optimization functions.

COMPUTING PLATFORMS AND OUTPUT DISPLAYS AND MODES: The present invention is edge deployable on the battlefield and in other austere and dynamic environments, which contributes to the invention's utility. The low compute requirements of the system software enable processing on a wide array of common military and civilian computing devices without requiring cloud or server connectivity for functionality. Computing platforms and output display devices may be integrated, such as with smartphones, tablets, or laptop computers. Alternatively, computing and display functions may occur on separate devices. For example, computing may occur directly on an autonomous aerial drone. The drone computer is employing the output of the system internally to locate a target employing multispectral camouflage (the drone does not require a visual display of the output) and simultaneously the processed video imaging is being transmitted to multiple video monitors for human end users to follow and view what the drone is targeting. This example also demonstrates different output modes. For human end users, the system will visually augment familiar sensor output displays. For non-human end users, such as computer and autonomous systems, outputs do not necessarily require visual display.

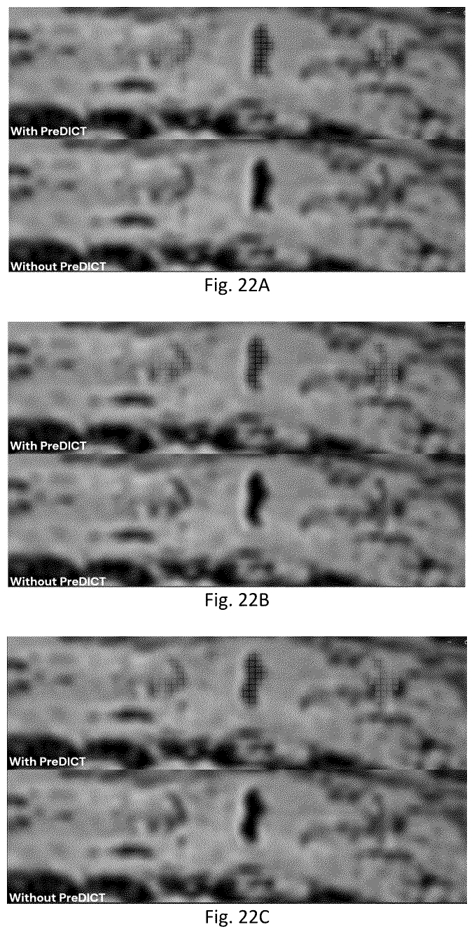

Computing platforms and/or output displays include, but are not limited to, smartphones; tablets; laptops; sensors; platforms hosting sensors; field programmable gate arrays (FPGAs) or other programmable computing hardware, such as Raspberry Pi™; heads-up displays; weapons mounted and handheld optics; computer monitors; drone control consoles; and similar devices with computational capacity and/or image and video display capability. FIGS. 22A-C provides screenshots of the software processing video in real time to detect three human subjects and the corresponding output. One subject (middle) is not wearing multispectral camouflage. Two subjects are wearing multispectral camouflage. See descriptions of figures for details.

SOFTWARE: The present invention describes a system and method for combining existing sensor, computing, and output devices and enabling their functionality with innovative, proprietary software to create a novel capability to defeat multispectral camouflage. This approach is consistent with a general trend in sensor innovation where the sensor hardware technology is relatively static and innovation is achieved through novel combinations of sensors and the processing of sensor information.

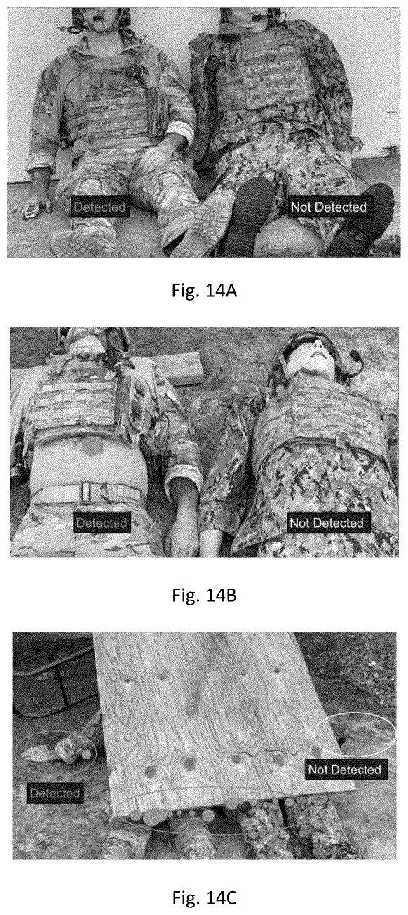

Hunamis, LLC has been developing the software enabling the present invention since early 2023 under the name PreDICT™ (Predictive Diagnostic Information/Intelligence Capability-Technology). Note: this may not be the final commercial name for the present invention. The present invention and software evolved from development work on the invention described in U.S. Pat. No. 11,978,558. The following description of the software covers the conceptual approach to development, successful proof of concept work that has been completed (FIGS. 14-22), and the current development approach to fully develop and operationalize the software.

CONCEPTUAL APPROACH: The objective of the present invention is to identify camouflaged, or otherwise concealed and obscured, human subjects, equipment, infrastructure, and other targets of interest, including those employing multispectral camouflage, in static and video imagery obtained from sensor systems. It is important to note that the exact type of camouflage and/or sensor is conceptually, and, for most practical purposes, functionally immaterial. The present invention exploits signature information in imagery, video or static, to detect targets of interest that are invisible and/or difficult to otherwise perceive and detect. So long as a target of interest has a signature that can be differentiated from noise, artifact, and or background information in the imagery, the present invention can aid in detection of that target of interest. The practical output of the present invention is the identification of the target(s) of interest at a spatial location or across spatial locations in the imagery. The focus in this section is on the conceptual approach to video imagery, which is more complex than static imagery, and it is noted that the analysis of static imagery by the present invention is effectively equivalent to the spatial, 2-dimensional analysis of individual video frames.

Video is a cube of data with a 2-dimensional spatial domain and a 3rd dimension in the time or temporal domain. Analysis is applied to both the spatial and time domain of video to detect signals of interest (SOI) in each domain. The time domain analysis is performed on segmented, discreet spatial regions, such that the time domain SOI can be correlated to the spatial domain. As each domain is analyzed and SOI are detected, the SOI in both the spatial and time domains are localized to spatial regions of interest (ROI) across the imagery.

The analysis of the spatial and time domains detects both positive and negative SOI for each domain. Positive SOI are specific characteristics or relative characteristics associated with specific targets of interest relative to different sensor types. Negative SOI are specific characteristics or relative characteristics not known to be associated with specific targets of interest or known to be associated with entities other than targets of interest, relative to different sensor types. Negative SOI are “subtracted” from the imagery, effectively performing what is known as background subtraction, and the positive SOI remain. The spatial locations where positive SOI in both the spatial and temporal domains overlap are the primary ROI corresponding to the highest probability of target of interest detection.

The following example is provided: An aerial drone with a video camera sensor capable of visual and IR spectrum imaging is being used to search a field, which consists of uniform tall grass, for a human subject who is thought to be hiding there. The subject is wearing multispectral camouflage that matches the vegetation (visual camouflage) and conceals the subject from electro-optical and thermal sensors (IR spectrum camouflage). The drone operator is viewing the sensor feed on a tablet in both the visual and IR spectra. He/she is unable to discern the presence of a human tsubject in the field. The human subject, employing the multispectral camouflage, is effectively managing his signature relative to the environment and the sensor. Now, the drone operator activates the software on the tablet, as part of the system described as the present invention, to analyze the drone sensor feed in real time. The human subject is rapidly revealed to be lying prone in the middle of the field.

For the purpose of this example and to illustrate a straightforward case, the frame rate of the sensor is 60 frames per second (FPS) and the length of the video captured by the sensor to accurately identify the subject and his location was one (1) second. The drone was hovering and effectively static in the X, Y, and Z axes during that 1 second of video. The software performed spatial domain analysis on each of the 60 frames, essentially static images, and determined that there is a small area, 1/100^{th} of the sensor field of view, with a unique spatial signature that is consistent across each frame. The software recognizes this signature as consistent with the spatial features of a human subject concealed by multispectral camouflage. This is a positive SOI, which now correlates to a positive ROI. The other 99/100^{th} of the sensor field of view has a uniform spatial signature and that this signature is consistent with vegetation. This is a negative SOI, which now correlates to a negative ROI.

The software is also performing a temporal domain analysis in parallel with the spatial domain analysis (though, alternatively, spatial and temporal analysis may be performed in serial). The temporal analysis is correlated to specific spatial regions of the sensor field of view. In this example, the field of view is divided into 100 spatially equal grid squares, each representing 1/100^{th} of the field of view. The software analyzes the changes in each grid square, between each video frame, over the one second video interval. It determines that there is one grid square, corresponding to 1/100^{th} of the sensor field of view, with a unique temporal signature and recognizes that this signature is consistent with human physiology and subtle movements. This is a positive SOI, which now correlates to a positive ROI. The other 99 grid squares, 99/100^{th} of the sensor field of view, have a uniform temporal signature and the system determines that this signature is consistent with vegetation blowing in a light wind. This is a negative SOI, which now correlates to a negative ROI.

The software subtracts the negative ROI from the analysis of each the spatial and temporal domains and correlates the positive ROI from the analysis of each the spatial and temporal domains. The positive ROIs from each domain are identical, consistent with a high probability detection for the target of interest. The area of the detection, corresponding to the spatial signature of the target of interest, is highlighted in, for example, green to make the target of interest apparent to the drone operator and to indicate the high probability of detection. The software displays this detection in, from the operator's perspective, real time along with the video. If the target of interest moves, or was moving in the example above, the operator would be observing the highlighted target of interest moving on his or her display screen.

SOFTWARE DEVELOPMENT: The edge deployable software is primarily, though not exclusively, developed using a supervised artificial intelligence (AI) approach that leverages machine learning (ML) image classification and convolutional neural network (CNN) algorithms and deep learning approaches. The software may also leverage other AI approaches, such as, but not limited to, unsupervised learning, and methodologies and algorithms, such as transfer learning, and vision transformers (ViT). Because multispectral camouflage defeat is a highly dynamic and evolving challenge—it presents a large number of scenarios across a range of environments and the multispectral camouflage will itself evolve to avoid detection by the present invention and underlying software—the software meets this challenge through self-learning attributes, such as machine learning and deep learning, and developer directed adaptations and improvements, such as implementation of additional algorithms, as the challenge evolves.

DATA: The software leverages multiple data sources for training, validation, and testing. The gold-standard data is imagery, both static and video, of real-world employment of multispectral camouflage on the battlefield or similarly dynamic environments. Other high-quality data includes, but is not limited to, imagery of multispectral camouflage employment in operational training scenarios and/or imagery of multispectral camouflage employment for the purpose of capabilities demonstration and testing and/or imagery of multispectral camouflage employment specifically for the purpose of database generation. Other data sources include, but are not limited to, synthetic data, including augmentation of existing data to increase data diversity, and relevant data sets such as those including imagery of human subjects and/or objects and/or locations or physical phenomena obtained with relevant sensors, those including imagery of camouflaged subjects and/or objects and/or locations or physical phenomena, and those that include, or can be analyzed for, certain temporal signatures related to human physiology and kinesis and/or vibration and movement related to equipment, vehicles, and/or infrastructure.

DEVELOPMENT OF DEPLOYABLE SOFTWARE MODEL FROM DATA: This process is consistent with general and accepted approaches to developing AI learning models. The following is representative of the approach: 1) Data normalization, cleaning, segmentation, and labeling. 2) Exploratory Data analysis for target feature extraction, signals of interest (SOI), and regions of interest (ROI). 3) Data preprocessing. 4) Split dataset into training, validation, and test sets. 5) Model training. 6) Model performance evaluation. 7) Model and hyperparameter tuning. 8) Model testing and evaluation. 9) Model deployment. 10) Model feedback.

The following are key challenges and solutions Hunamis, LLC employed in the successful proof-of-concept development and testing process of the software enabling the present invention. These solutions generally fall under steps 1 and/or 3 above.
Image Stabilization: Video obtained from dynamic sensors and/or of dynamic targets of interest contains noise and artifact, particularly in the temporal domain. Specifically, noise refers to sensor and/or system related non-SOI signals and artifact refers to environmental related non-SOI signals (Note: there is potential overlap between non-SOI signals and negative SOI. Distinguishing them is a function of data labeling and model training). Image stabilization facilitates SOI detection, particularly in the temporal domain, by decreasing noise and/or artifact signals relative to SOI and, in turn, improves the sensitivity and specificity of detection characteristics. Image stabilization is achieved in two general ways: at the software level and/or at the sensor and/or system level. At the software level, we employed image stabilization tools. At the sensor level, we utilized accelerometer and gyroscopic data that is an output of many sensors and/or systems, such as aerial drones. Used together, these approaches decreased noise and/or artifact in the temporal domain and facilitated detection of temporal SOI.
Spatial Scaling: The present invention functions across a broad range of scenarios and environments to detect a range of targets of interest. Detection of targets of interest, particularly in the spatial domain, is facilitated by normalizing the scale of imagery to constrain the spatial parameters where targets of interest are likely to be detected. For example, within a given field of view, detection characteristics of human subjects, equipment, and/or infrastructure are improved when the relative size and number of pixels that may represent a human subject, piece of equipment, or key infrastructure site is bounded. Spatial scaling is achieved in two general ways: at the software level and/or at the sensor and/or system level. At the software level, we employed computer vision (CV) object, edge, and blob detection tools to identify spatial features and scale the imagery relative to those spatial features. Additional CV techniques may be employed such as multi-scale analysis, feature fusion, and attention mechanisms. For example, identifying one or all of the following features in an image allows the imagery to be scaled relative to known size parameters of those features: roads, vehicles, buildings, trees, humans, livestock. More intensive analysis can yield further scale information from these spatial features, such as by correlating shadows with the angle of light sources to include artificial light sources or the sun, moon, or starlight. At the sensor and/or system level we employed laser range finder data (laser range finder are a common feature of many military sensors) and altitude data from aerial sensors to determine the distance from potential targets of interest and to scale imagery relative to the known distance.
Additional Data Streams: Additional data streams utilized by the present invention for the purposes of data normalization and/or exploitation for SOI and identification of targets of interest include, but are not limited to: Temperature, Ambient light, Acoustic, and/or Radio Frequency data.
Temporal Processing: There are multiple approaches to temporal domain analysis and one or several of these may be implemented in the context of the present invention. An approach to temporal processing employed by the present invention, a motion average differencing technique for amplifying invisible and low perceptibility signals in video imagery, was identified and developed by Hunamis, LLC. It is described in U.S. Pat. No. 11,978,558, held by Hunamis, LLC, and its continuation filings. Amplification of invisible and low-perceptibility changes in the time domain of video imagery to make these changes apparent and/or otherwise exploitable as signals is referred to as motion amplification, motion microscopy, video magnification, and similar terms. There are several approaches to video motion and color change signal amplification, such as but not limited to, Lagrangian and Eulerian video magnification. The present invention uses a motion average differencing technique to amplify invisible and low perceptibility changes in the temporal domain of video. Compared to other techniques, it has the advantage of low computational requirements that enable deployment on a wide range of computing platforms, without cloud or server connectivity, and the output of rapid results. This motion average differencing approach analyzes the luminescence changes of pixels over identified spatial areas versus time. The luminescence changes result from a wide range of factors including but not limited to: motion or color change resulting from human subjects or machinery, environmental artifact such as pulsing artificial lighting, and/or camera noise. Spatial areas for analysis may be identified in several different ways, which include but are not limited to: 1) Segmenting the video imagery field of view into a uniform grid and performing motion average differencing on each grid square and/or 2) Employing computer vision (CV) and/or other techniques to identify specific regions, objects, subjects, and/or targets of interest for analysis with moving average differencing. The relative size and location of the spatial areas analyzed, and the relative distribution of the signals being averaged over time, all contribute to the characteristics of the raw temporal output signal. Thus, for example, changing the size of the spatial area under analysis, such as, for example, using smaller grid squares, may change the raw temporal output signal.

The raw temporal output signals from moving average differencing analysis contain information for any phenomenon in the video imagery that contributes to pixel luminescence changes in the area of spatial analysis during the temporal interval. This may include positive SOI, negative SOI, and non-SOI. There are several approaches to exploiting these raw signals to identify SOI, non-SOI, and/or targets of interest. These include but are not limited to: 1) Using a temporal bandpass filter with or without power spectral density analysis and/or other signal processing techniques to isolate and separate SOI for identification of targets of interest and/or 2) Using AI approaches, such as machine learning and deep learning, to correlate raw signal patterns in the imagery data to SOI and targets of interest. These approaches can be used in isolation or in combination.

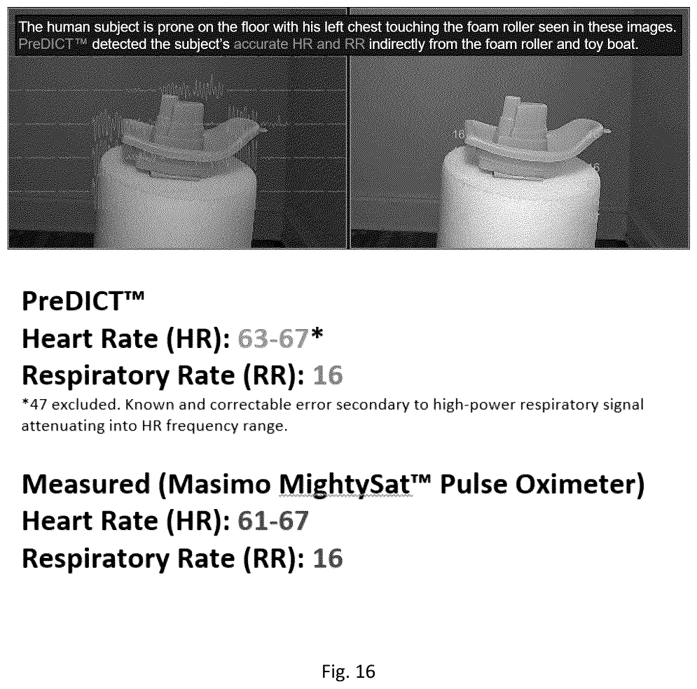

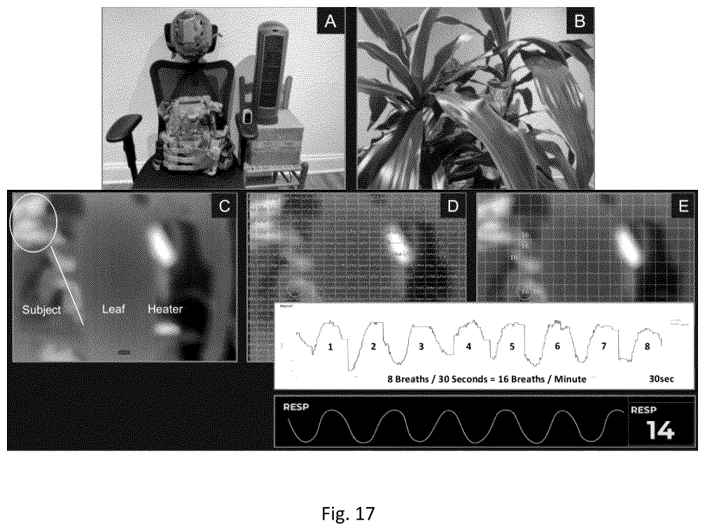

In the development and testing of the present invention, both of these approaches to moving average differencing raw signal exploitation have been successfully exploited to identify a target of interest and/or statistically correlate a specific spatial area to a target of interest. The first approach, using a temporal bandpass filter with or without power spectral density analysis and/or other signal processing techniques to isolate and separate SOI for targets of interest, can be implemented as a preprocessing technique for AI model development and deployment and/or as a standalone software processing technique in the context of the present invention. FIG. 17 demonstrates this approach being implemented as a standalone processing technique to differentiate the thermal signature of a concealed human subject from the thermal signature of a concealed space heater based on detection, characterization, and quantification of a human respiratory signature. A characteristic respiratory signature and accurate respiratory rate are extracted from the raw temporal motion average differencing signal from an area of the imagery corresponding to the human targets left chest and elbow. FIG. 16 demonstrates the same technique to detect a human subject out of the field of view of the video. The human subject is in contact with the apparatus (foam roller and toy boat). The human subject is detected through the amplification of low-perceptibility and invisible physiologic movement signatures transferred to and detected in the apparatus by the software. An accurate heart rate and respiratory rate for the subject (relative to a ground truth pulse oximetry device worn by the subject) is then extracted from the signatures by the software. This approach, applied to human subjects, can detect both signs of life and status of life.

The second approach was also successfully implemented in the testing and development of the present invention. Segmented and labeled video imagery data was preprocessed with the moving average differencing software to generate raw temporal signals. A machine learning image classifier was then successfully trained to statistically correlate the raw signals to SOI, ROI, and targets of interest in the video imagery.

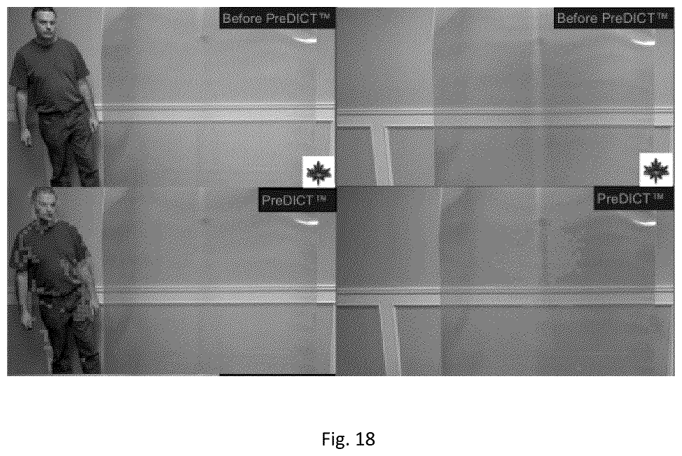

While the referenced figures for this section demonstrate the application of the current invention to detecting human subjects, identical techniques can be used to detect and characterize movement, color change, and other time variant characteristics captured in video, even if they are invisible or barely perceptible. These include, but are not limited to, vibrations generated by vehicles and equipment, exhaust from vehicles or equipment, gross or subtle movements of any kind, including human fidgeting. Limitations related to Nyquist frequency considerations can be overcome with higher frame rate sensors.
Spatial Processing: There are multiple approaches to spatial domain analysis and one or several of these may be implemented in the context of the present invention. Approaches to developing the present invention include computer vision (CV) techniques including, but not limited to, object detection, edge detection, and blob detection, as well as multi-scale analysis, feature fusion, and attention mechanisms primarily, but not always, implemented with AI training, validation, testing, and deployment to detect SOI in the spatial domain of imagery. Computer vision tools and AI models have been trained and customized using open source and proprietary Hunamis, LLC owned data sets. These are used to develop the software component of the system for rapidly analyzing imagery across multiple spectral bands in the spatial domain to detect SOI and ROI corresponding to targets of interest concealed by vegetation, structure, visible camouflage, multispectral camouflage, and otherwise concealed from view.
Integration-Spatial and Temporal Domains: As previously described, positive SOI from the spatial and temporal domains are correlated to isolate a positive ROI and a target of interest. Various processing approaches and thresholds are applied to spatial and temporal results, independently and in combination, to output qualitative and quantitative results. Detection parameters can be set by end users or, in the case of autonomous systems, can be set relative to certain environments and tasks performed by the system. Qualitative results may look similar to FIGS. 18-23, which demonstrates prior development work on the present invention and depicts detected human subjects in real time with a green overlay. Quantitative results may take multiple forms and apply different statistical approaches. In many applications, the software will progress through multiple levels of processing moving from high sensitivity to high specificity to optimize the probability of a) not missing a target of interest (sensitive) and b) not identifying a non-target of interest as a target of interest (specific). For example, on the initial processing pass of a segment of video, the software will have false positive SOI and, in turn, false positive ROI and targets of interest. Subsequent analytic passes will focus on these SOI, ROI, and targets of interest with different thresholds until a level of statistical certainty is achieved (or determined to be unachievable), and the target(s) of interest is identified. Examples where different levels of statistical certainty are desired by end users are described below.

A small military reconnaissance team is aware that there is a camouflaged enemy sniper on ridgeline in low vegetation surrounded by livestock and likely wild animals. They must safely neutralize the sniper to move past the ridgeline to their objective. They have one small quadcopter type drone with a single munition payload. Their intent is to use the present invention to identify the sniper and neutralize him with the munition. It is possible that livestock, that were wallowing in mud and are now bedded down under bushes, could appear similar to the human sniper concealed by multispectral camouflage. The reconnaissance team requires the present invention to accurately identify (true positive detection) the sniper with a high degree of certainty before they expend their single munition. If they identify livestock as the target of interest (false positive detection) and expend their munition on the wrong target they risk mission failure.

A large fleet of autonomous fixed wing drones is attacking enemy forces on a linear battlefield, which means that there is a distinct forward line of troops (FLOT) and any human subjects, equipment, or infrastructure across the FLOT are enemy. The airspace is permissive and the drones are well supplied with munitions from a forward logistics hub. In this example, the required statistical certainty threshold is much lower. The goal of the drones is to effectively neutralize all enemy and enemy resources on the enemy side of the FLOT. The end user is not resource constrained and thus may be willing to tolerate false detections and collateral damage, such as livestock, so long as the enemy is broadly neutralized.
Integration-Multiple Sensor Feeds-Multimodal and/or Multi-view processing: The software can process multiple types of sensor feeds in parallel or in series to enable multimodal analysis for targets of interest. It can also process multiple sensor feeds in parallel or in series to enable analysis from different points of view relative to potential targets of interest. Multi-view processing exploits the fact that camouflaged targets of interest may have vulnerabilities when viewed by the same sensor type from different vantage points and/or may have different vulnerabilities relative to different sensor types from different vantage points. Multiview processing is also leveraged to analyze an area of interest with a high sensitivity to high specificity strategy, such as described above for software analysis. For example, a swarm of one-hundred (100) aerial drones is searching a one-hundred-thousand (100,000) square meter (m\hat{ }2) area for camouflaged targets of interest. Each drone initially analyzes a separate one-thousand (1000) square meter parcel. There are positive detections in some parcels and not in others. Drones that do not achieve detections in their initial parcels automatically join drones that do achieve detections to provide alternate simultaneous points of view and/or additional sensor types on potential targets of interest. Through a process of elimination, relative to determined statistical detection parameters, the drone swarm will provide multiple views and/or sensor inputs to optimize detection of the target(s) of interest. In this example let's assume that there is a single well camouflaged counter-battery radar installation covered with state-of-the-art multispectral camouflage netting and natural vegetation in the 100,000 m\hat{ }2 area under analysis. Ultimately, defeat of the camouflage and detection of the target of interest is enhanced by the swarm of 100 aerial drones providing multiple different types of sensor information from multiple different viewpoints.

### Software Deployment:

As previously described, the software enabling the present invention is deployable on multiple edge devices. A specific example of how the software may be deployed on edge devices is as an ATAK application plugin. ATAK, which stands for Android Team Awareness Kit, is a widely used Android smartphone application in the military, law enforcement, disaster response, and other similar communities for viewing and exploiting sensor information, navigating, targeting, mapping, geo-tagging, and other functions. It allows multiple users to maintain situational awareness through a common operating picture.

### Multispectral Camouflage Testing Use Case:

Examples have focused on defeating adversary multispectral camouflage. The present invention can also be employed to test and optimize multispectral camouflage technologies and operational employment before deployment on the battlefield. For example, existing or new camouflage technologies, or combinations thereof, can be tested using various sensors and combinations of sensors (including multisensor, multimodal, and multi-view processing) using the system as described herein to determine whether the camouflage technologies are effective under various conditions. Those tests may be used to validate the camouflage technologies for deployment, depending on the deployment conditions, to modify the camouflage technologies, and/or to train or provide instructions to personnel for optimal use.

### The Camouflage Defeat and Testing System

The camouflage defeat and testing system involves logic that combines with video and image sensor derived outputs to rapidly analyze images and video streams to detect humans and/or equipment or other resources otherwise concealed by camouflage and, particularly, multispectral camouflage. The system can be used to detect resources through camouflage or to test existing camouflage technologies or technologies under development. The logic component is low-compute and compatible with ubiquitous battlefield sensors and computing devices and capable of functioning with or without cloud and/or server connectivity. It is edge-deployable and can be run directly on electro-optical and/or IR/thermal sensors and/or on smartphone devices and laptop computers to process feeds from those sensors. Sensor types include, but are not limited to: satellite based sensors, drone-based sensors, weapons mounted sensors (e.g., optics), standalone hand-held sensors, and other current and future sensor types. Processing platforms may include the sensor, smartphones, laptops, or other devices and capabilities. When operationally and tactically feasible, the system may utilize the cloud or a server for processing and system updates, notably for incorporating updates to the deployable software derived from machine learning based improvements across all deployed systems. Outputs may be displayed on a screen, such as from a laptop, smartphone, or heads-up display, may be displayed directly within the optic, such as in the case of a weapons mounted or hand-held optic, or may not require display as in the case of an autonomous weapons system.

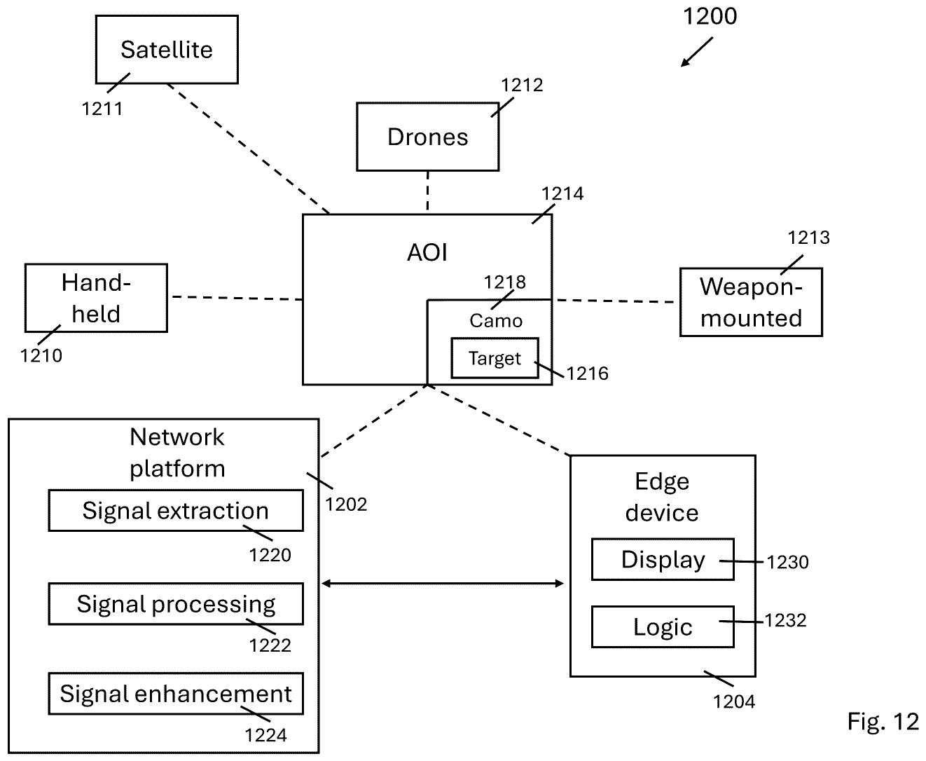

A schematic diagram of the camouflage defeat and testing system 1200 is shown in FIG. 12. As described above, the system 1200 may be embodied in a network platform and or an edge device such as a user device/equipment system. In certain contexts, it will be desired to execute camouflage defeat in environments where the edge device does not require connection to a network platform. In other contexts, such a network connection may not be problematic, and it may be desired to operate the edge device to access a network platform. In such cases, the camouflage defeat functionality may be executed at the network platform, at the edge device, or distributed between the network platform and the edge device. In the illustrated embodiment, the system 1200 includes a network platform 1202 and one or more edge devices 1204. Although one edge device is illustrated 1204 it will be appreciated that the network platform 1202 or sensor devices 1210-1213 may support many edge devices 1204. For example, a drone 1212 or satellite 1211 may provide images (still or video) or processed image information to multiple devices 1204. Moreover, while the edge device is described as being separate from the sensor devices 1210-1213, it will be appreciated that the processing and output functions (e.g., a digital signal output for directing action by the sensor device 1210-1213) may be integrated into a sensor device 1210-1213.

The platform 1202 and/or the edge device 1204 receive inputs from one or more sensor devices 1210-1213 monitoring an area of interest (AOI) 1214. For example, the area of interest 1214 may be a battlefield or staging area of an adversary. In this case, the area of interest 1214 includes a target 1216 utilizing a camouflage technology 1218. For example, the target may be a person, equipment, or other resources of an adversary. The camouflage technology 1218 may be camouflage gear, disruptive coloration, tarps, nets, other camouflage technologies, or combinations thereof. For example, the camouflage technology may involve a multispectral camouflage technology.

Sensor inputs may be obtained from a variety of sensors deployed on a variety of platforms. Multiple sensors may be deployed on a single platform. In the illustrated embodiment, these sensors include handheld sensors 1210, satellite sensors 1211, drone sensors 1212, and weapon mounted sensors 1213. The sensors may include various technologies and modalities including active sensors, specialized sensors, and traditional sensors as described above. It will be appreciated that the illustrated sensors, sensor platforms, and means of sensor employment are provided for purposes of illustration and that many other sensor types and platforms may be utilized including, for example, sensors employed on a range of terrestrial, maritime, and aerial vehicles and platforms. They may be remotely operated, manned, autonomous or semi-autonomous systems. The sensors 1210-1213 provide sensor information to the network platform 1202 and/or the edge device 1204 for processing. For real-time applications, such sensor information may be transmitted wirelessly to the platform 1202 or device 1204. In other cases, the sensor information may be stored for later uploading to the platform 1202 or device 1204.

The illustrated platform 1202 includes logic for signal extraction 1220, signal processing 1222 and image enhancement 1224. Signal extraction 1220 may encompass a variety of functions including extracting fields of information from sensor information messages, normalizing the information, collecting batches or time frames of data for analysis, data segmenting, data cleaning, labeling, image stabilization, feature extraction, SOI identification, ROI identification, and other preprocessing steps. Signal processing 1222 may involve obtaining signature information from the preprocessed signal information and processing the signature information to identify characteristics indicative of the target 1216. Image enhancement 1224 involves enhancing an image (or view) of the area of interest 1214 to include information for identifying the target 1216. For example, coloration or text information may be overlaid or otherwise associated with the image/view to assist a user in identifying the target 1216.

It will be appreciated that the platform 1202 may perform a number of other functions, either in a set-up/training environment or in operation in the field. These may include, for example, model training, model performance evaluation, model and hyperparameter tuning, and processing of model feedback.

The edge device 1204 includes a display 1230 and processing logic 1232. In cases where the edge device operates autonomously or semi-autonomously, the logic 1232 may include functionality similar to that described in connection with the platform 1202. In other cases, the logic 1232 may be operative for processing messages from the platform 1202 or sensor devices 1210-1213 to generate images or detection information for presentation on the display 1230 or a view of a user. The display 1230 may display enhanced images as described above including information to assist in identifying the target 1216.

The system 1200 may implement a variety of processing depending on the sensor information available, the environment in which the system is deployed, and other operational considerations. In some cases, one or more available sensors may provide adequate detection. In such cases, information from one or more sensors may be provided without any further processing or enhancement. In other cases, signature analysis processing may be employed. This may include temporal processing, spatial processing, and integrated spatial/temporal processing. A signature may include multiple values over the spatial extent (or selected portion thereof) of an image or images, or a series of values obtained over a timeframe from video inputs. In the latter case, these values may relate to a full video image, areas of the image, grid elements of the image, targets detected in the image, or areas of the targets, among other things. For example, an initial computer vision process may be implemented to identify objects, edges, or blobs, and a subsequent segmentation of video frames may be based on the initial computer vision process. The values may relate to intensity, color, motion, or other parameters. These values may be processed in a variety of ways depending on the analysis being implemented. For example, information from multiple sensors or types of sensors may be combined to identify a signature consistent with a target of interest. That may involve static or motion-related characteristics and may be, for example, determined by an AI/ML model based on training data. Alternatively, a motion amplification technique may be employed to detect movement consistent with a target of interest or physiological parameters such as heart rate, breathing rate, or the like. Such parameters may indicate whether a candidate target is likely a human target. Alternatively, motion amplification inputs may be provided to an AI/ML engine to distinguish signatures likely associated with a target from other signatures. Such systems may progressively learn to identify targets based on training data as well as data accumulated in operation. In some cases, the AI/ML logic may reside on a network platform where it has access to data from multiple sources for training/learning, and associated logic may be downloaded/updated on autonomous or semi-autonomous edge devices.

Although the platform 1202 is illustrated as a single element, it will be appreciated that the platform 1202 may be executed on one or more machines (e.g., computers or servers) at a single site or geographically distributed. Each such site may execute the full functionality of the illustrated platform 1202 or the functionality may be distributed across sites. Moreover, the functionality may be distributed in various ways between the platform 1202, the edge devices 1204, the sensors 1210-1213, and any other platforms, e.g., some preprocessing of sensor information may be executed at the user sensors 1210-1213 or other platforms, for example, to facilitate rapid response or reduce use of processing resources of the platform 1202 or communication bandwidth requirements. The platform 1202 may be hosted by a system provider or may be implemented separately (e.g., cloud-based) and connected to the system provider via an interface such as an application programming interface (API).

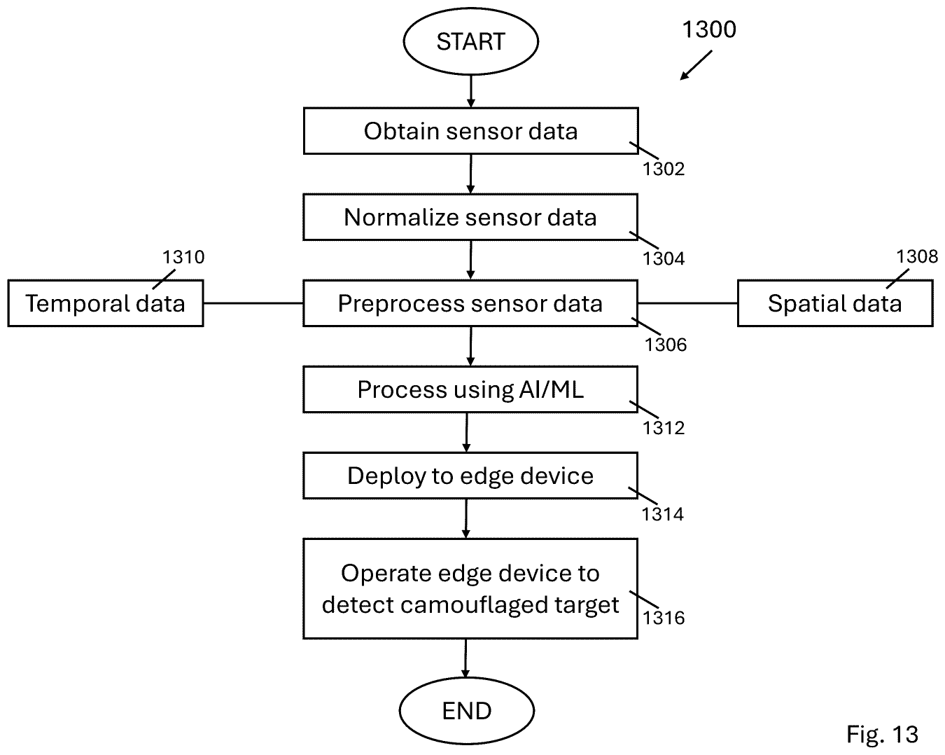

The system leverages multiple data extraction techniques, including artificial intelligence/machine learning and deep learning image classification, to produce the deployable software capability that enables system functionality for analyzing images and video from sensor inputs and for outputting information to autonomous systems and/or human end-users. A broad conceptual overview of a process 1300 implemented by the system is shown in FIG. 13:
1) Live or recorded sensor data, such as stillframe or video image data, from a sensor of an area, event, subject, and/or object of interest is obtained (1302). Although FIG. 13 focuses on temporal data such as from videos, it will be appreciated that the system may use spatial data inputs, e.g., stillframe video or other spatial sensor data. In addition, as described above, certain implementations may involve integration of spatial and temporal data. Accordingly, the system may receive spatial and/or temporal data.
2) Video is preprocessed (1304). For example, preprocessing includes, but is not limited to, video stabilization using software techniques +/− accelerometer and gyroscopic input from sensor platform; Orientation; Intensity; Color scale; Size scale; and other.
3) Video is preprocessed 1306: Video is approached as a “data cube” with 2-dimensional spatial data (1308) arrayed across individual frames and 3-dimensional temporal data (1310) arrayed across frames over some time duration of video. Preprocessing of the spatial and temporal domains may occur in series or in parallel. If it occurs in series, then either domain may be analyzed first or second.
   a. Spatial domain: The goal of spatial domain preprocessing is to identify potential regions of interest (ROI) based on potential signals of interest (SOI). Video frames are analyzed to identify positive SOI consistent with concealed human subjects, objects, equipment, or other targets of interest using BLOB Detection, Object Detection, Edge Detection and/or other computer vision (CV) detection tools. Additional CV techniques may be employed such as multi-scale analysis, feature fusion, and attention mechanisms. Positive SOI may be directly attributable to human targets, objects, or equipment or they may be anomalies in the spatial domain created by the presence of human subjects, objects, equipment, or other targets of interest. Specific sensor types may undergo different spatial preprocessing. For example, polarized visible or thermal sensors may enable enhanced perception of the concealed subject, object, or equipment and/or of the material concealing them. This in turn may allow enhanced use of Object and/or Edge detection techniques versus BLOB detection techniques. Video frames are also analyzed for negative SOI. For example, if much of the video contains the sky, ocean, or some other environment or location that is less likely to be a site of concealment, this would effectively constitute a negative ROI. Other important negative SOI may be human subjects, objects, or equipment or similar entities that are obviously detected with the sensor type being employed. For example, if you are using a thermal sensor to detect human subjects and livestock is obviously detected by the thermal sensor, then the livestock does not necessarily need to be analyzed by the present invention as a SOI or ROI employing multispectral camouflage to evade thermal sensor detection.
   b. Temporal Domain: The goal of temporal domain preprocessing is also to identify potential ROI based on potential SOI. The spatial domain is divided into spatial regions by spatial processing to identify potential ROI for temporal analysis and/or by techniques such as a grid overlay of the imagery field of view where each grid square is a spatial region for temporal analysis. The grid squares may be as large as many pixels or as small as a single pixel. This grid is consistent across each video frame over the time duration of the video being analyzed. Preprocessing may cycle through different grid sizes over the entire spatial domain or it may cycle grid sizes in specific regions to better characterize potential SOI and ROI. Temporal SOI are extracted through motion amplification techniques, some of which are previously described in the Hunamis Applications. One of these techniques, which has the advantage of low computational requirements, is a moving average differencing approach that analyzes pixel luminescence changes versus time in discrete spatial regions, such as individual grid squares, overlying the spatial domain. Hunamis, LLC has successfully employed this technique to detect luminescence changes caused by invisible and low perceptibility color changes and motion arising from human physiology and successfully extracted human vital signs, such as heart rate and respiratory rate, from these signals. Thus, temporal analysis can be used to spatially localize positive SOI arising from human physiology, human movement, machine and equipment generated luminescence changes, unique luminescence signatures arising from light interactions with camouflage materials, and other sources to corresponding grid squares overlying the spatial domain. As with spatial analysis, temporal analysis is also performed for negative SOI. Negative SOI in the temporal domain arise from sources including, but not limited to, sensor camera noise; light artifact; movement from windblown vegetation, smoke, fire, clouds, vehicles; other living entities such as livestock; or other sources. Negative SOI are important for at least two reasons. First, to calibrate temporal signature thresholds for SOI in specific ROI. Second, to recognize and account for noise and artifact. The overarching goal of temporal analysis is to identify SOI, which may either be signals known to correspond to human subjects, objects, or equipment or may be signals that are anomalous relative to prevailing or predominant signals otherwise found in the temporal domain of the video. The spatial approach to executing temporal analysis enables temporal SOI to assist with ROI localization of human subjects, objects, and equipment, or other entities of interest, in the video stream. It is important to note that Hunamis, LLC has successfully applied temporal analysis as a standalone approach to detect both static and dynamic human subjects concealed by multispectral camouflage including multispectral camouflage purchased by the U.S. military (Ametrine™ and FibroTex™) and multispectral camouflage manufactured by Russia and deployed on the battlefield in Ukraine (HiderX).
4) Artificial Intelligence/Machine Learning (AI/ML) Image Classifier (1312): (Note: This is a conceptual overview of how the ML image classifier functions. Given the nature of machine learning, the classifier continuously improves analysis and outputs as it analyzes more data.) Spatial and Temporal preprocessing for positive and negative SOI, localized to specific ROI, enables a background subtraction process to take place that leaves the video “data cube” with spatial positive SOI on individual video frames and temporal positive SOI between and across frames that are also spatially localized to ROI. The regions of the “data cube” that have the most intersection between spatial and temporal positive SOI are the ROI where human subjects, objects, equipment, or other camouflaged entities of interest are most likely to be found. A key function of the AI/ML image classifier is to determine what spatial and temporal signals are SOI, which are positive versus negative SOI, and what is the statistical significance of how these signals intersect, or not, within the video “data cube.” The AI/ML image classifier has a training phase that utilizes multiple data types (generalized, problem specific, real, synthetic, etc.), a testing phase, and a validation phase.
5) Deployable Software (1314): The function of the AI/ML image classifier is to enable deployable logic that can be used on edge computing devices (1316) as described above without requiring cloud or server connectivity. Importantly, this enables employment of the logic capability as part of a system without increasing the electromagnetic signature of the sensor or operator, which is a critical consideration on the modern battlefield where all electromagnetic signature creates risk of directional finding and targeting by the adversary.

FIGS. 14-23 illustrate various scenarios addressed by the camouflage defeat and testing system. The system can distinguish between live human subjects and non-live subjects, for example, based on analyzing and processing video information in the temporal domain to detect signatures and frequencies consistent with human bio-physiological parameters. Temporal signatures related to invisible and low-perceptibility human movements and/or color changes and/or regional and relative anatomic volume changes, such as, but not limited to, from the pulsatile function of the human heartbeat, respiratory function, postural movements, and/or muscle fasciculations, are detected, amplified, and extracted by the system to identify live human subjects. These signatures can also be processed to extract quantitative rates such as heart rate, respiratory rate, blink rate, or other rate information. Temporal signatures related to gross human movements, such as gait, are also detected, amplified, and extracted by the system to identify live human subjects. These signatures can also be processed to extract specific quantitative information, such as step rate. The software enabling the system is capable of detecting these signatures even in cases where the human subject(s) is concealed or not obviously visible. These same techniques are applied by the system to analyze the temporal domain of imagery to detect, amplify, and characterize signatures arising from other potential targets, such as vehicles and equipment, and/or to detect negative SOI in the temporal domain. Several of the figures are labeled with the name “PreDICT™” (Predictive Diagnostic Information/Intelligence Capability-Technology), which is the current name under which the system is being developed by Hunamis, LLC.

This is illustrated in FIGS. 14A-14C. As shown, the system can distinguish between a live human subject and, in this case, a trauma training mannequin using a Red-Green-Blue smartphone video. In FIG. 14A the system is detecting signatures and frequencies consistent with human heart rate. In FIGS. 14B and 14C the system is detecting signatures and frequencies consistent with human respiratory rate. The green circles indicate a positive detection within specified parameters and the size of the circle corresponds to the magnitude of detection above a specified threshold. In FIG. 14A the live human is clearly distinguished from the trauma training mannequin by the number and magnitude of detections. Note that there are several small detections over the mannequin, primarily on the side touching the live human subject. As demonstrated in FIG. 16, these are actually signatures from the live human transferred to and measured in the mannequin. In FIG. 14B the live human is clearly distinguished from the trauma training mannequin based on the number and magnitude of detections. FIG. 14C is intended to simulate a live human and non-live human trapped under rubble, in this case a piece of plywood which is resting on body armor of the live human subject. The system detects signatures on the live human subject's hand and strong signatures over the edge of the plywood as it moves with the live human subject's respiration as well as small signatures over the mannequin's legs from respiratory movement transmitted via the plywood.

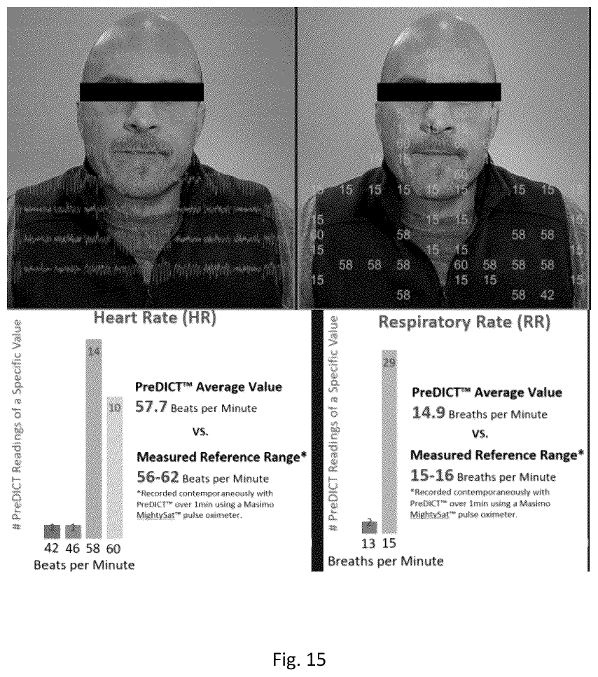

This is further illustrated in FIG. 15. The top left panel shows amplified raw temporal signals for equal and discrete spatial areas of the video field of view. These raw signals hold a range of signature information related to the live human subject in the video as well as other temporal information, such as the high-frequency, low amplitude oscillation of the artificial lighting that is generally invisible to humans. The top right panel shows the results after the raw signal is processed to extract the subject's heart rate (orange) and respiratory rate (blue). As shown in the bottom panels, the heart rate and respiratory rate values determined by the system closely correlate to ground truth values obtained using a pulse oximeter device.

FIG. 16 illustrates the sensitivity of the system and its ability to detect, amplify, and extract live human physiologic signatures through an intermediate subject or medium in contact with the subject and process those signatures to extract accurate quantitative information. In this example, a conventional integrated laptop computer camera is filming a toy boat affixed atop a foam roller (an approximately 6 in×36 in foam cylinder) while a live human subject is laying prone on the floor with his left chest touching the foam roller. The top left panel shows amplified raw temporal signals for equal and discrete spatial areas of the video field of view. These raw signals hold a range of signature information related to the live human subject in contact with the foam roller. The top right panel shows the results after the raw signal is processed to extract the subject's heart rate (orange) and respiratory rate (blue). As shown in the bottom panel, the heart rate and respiratory rate values determined by the system closely correlate to ground truth values obtained using a pulse oximeter device.

FIG. 17 illustrates use of the system to distinguish between a concealed live human thermal signature versus a concealed non-live thermal signature based on respiratory signatures. Panel A illustrates the test setup indicating a position for a live human subject and a position for a non-live heat source. As shown in panel B, both the subject and the heat source were then concealed by foliage. Panel C shows a thermal image obtained by an inexpensive thermal camera. Panel D shows amplified raw temporal signals for equal and discrete spatial areas (grid squares) of the video field of view. Physiological information, or the lack thereof, can then be determined for each grid element through processing by the system software. As shown in panel E, accurate respiratory rate information was identified for the live human subject whereas no respiratory rate information was detected for the heat source. In this manner, the live human subject is readily distinguished from the non-live heat source. Further, the respiratory rate determined by the system accurately matched the subjects's ground truth respiratory rate determined contemporaneously by conventional medical equipment. This information was obtained in less than 45 seconds including obtaining the 30 second video, processing the video, and outputting the information. Moreover, as shown, the system yielded a high-quality respiratory waveform without sensor-subject contact extracted from the video in the region of the subject's left elbow. The blue waveform on the white background is the respiratory waveform captured by the system. The boxy shape of the waveform is due to the low frame rate (“less than 9” frames per second (FPS)) of the thermal camera used for the test. The yellow waveform on the black background is an example of a respiratory waveform captured by a conventional vital signs monitor as would be found in a hospital intensive care unit (ICU), for example. NOTE: it is not the respiratory waveform of the test subject.

FIG. 18 illustrates a test confirming that the system can defeat Quantum Stealth™ multispectral camouflage. Quantum Stealth™ is a pliable material manufactured by HyperStealth Biotechnology Corporation that, from an observer's perspective, bends light around a target concealed behind the material and scatters the light emitted by or reflected off the target as to distort or render invisible the target behind the material. The light is bent and scattered by the material in such a way that the background around and behind the target is still visible. Quantum Stealth™ provides effective multispectral camouflage across the ultraviolet (UV), visible (VIS), and infrared (IR) spectra, including thermal. The top panel shows how the subject disappears when he steps behind the material. The bottom panel shows that the subject is readily identified by the camouflage defeat and testing system both when the subject is in the open and when he is behind the material.

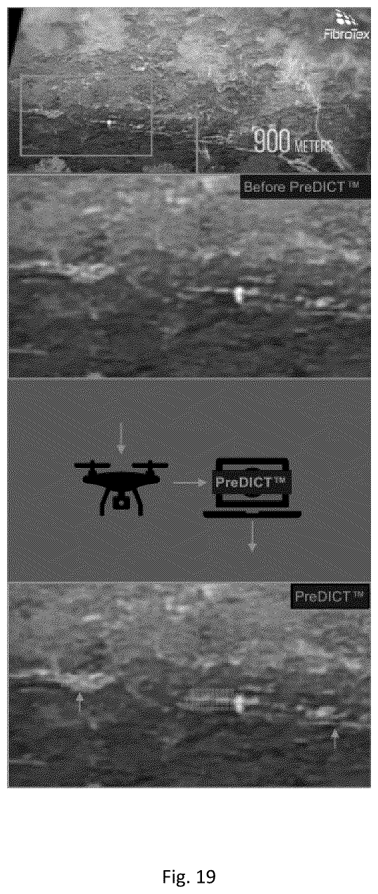

FIG. 19 illustrates a test verifying that the system detects live human signatures concealed by FibroTex NIGHTWALKER™ multispectral camouflage at a significant standoff distance. In this case, a dynamic aerial drone equipped with a thermal sensor acquired 2 seconds of “white hot” video from a distance of 810-900 m of 3 human subjects moving across terrain. One subject, easily visible in the panel labeled “Before PreDICT™” as a small white figure, is not wearing NIGHTWALKER™. The other 2 subjects are wearing NIGHTWALKER™ and are not obviously visible in the “Before PreDICT™” panel. FibroTex NIGHTWALKER™ “will make you invisible” and “provides full thermal protection” according to FibroTex™, which has a $480 million dollar contract to supply multispectral camouflage to the U.S. military. The video was processed by the camouflage defeat and testing system using a conventional, off-the-shelf laptop in seconds to detect all three human signatures over the two-second video, as shown by the system output in the bottom panel, labeled “PreDICT™”.

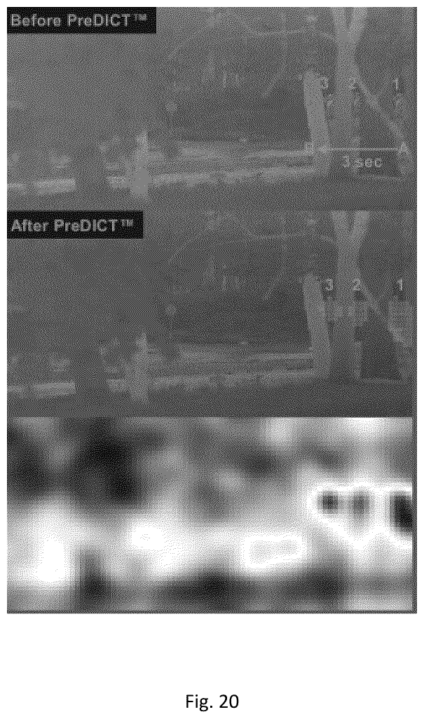

FIG. 20 illustrates a test verifying that the system detects live human signatures concealed by Ametrine™ multispectral camouflage at 100 meters. Ametrine™ produces multispectral camouflage products and capabilities that are conceptually and technically similar to FibroTex™ products. Ametrine™ has over $50 million dollars in contracts with the U.S. military to supply multispectral camouflage. The top panel shows a static image from a Pixels-On-Target VooDoo-M™ thermal optic, set on “white hot”, filming 3 seconds of video at 100 meters. In the video, the subject is wearing Ametrine™ multispectral camouflage and moving behind trees from point A to point B. Video still shots were combined in the top panel to show the subject in positions 1, 2, and 3 as the subject passes between the trees. The original video was processed by the camouflage defeat and testing system on a conventional, off-the-shelf laptop in seconds to detect the subject wearing the camouflage moving between the trees, as shown in the middle panel. The bottom panel shows the relative signal detection strength by the system across the entire video field of view over the 3 second duration of the video. It confirms that the system not only detected the subject wearing Ametrine™ multispectral camouflage but also that the system significantly distinguished the subject from noise and artifact in the video.

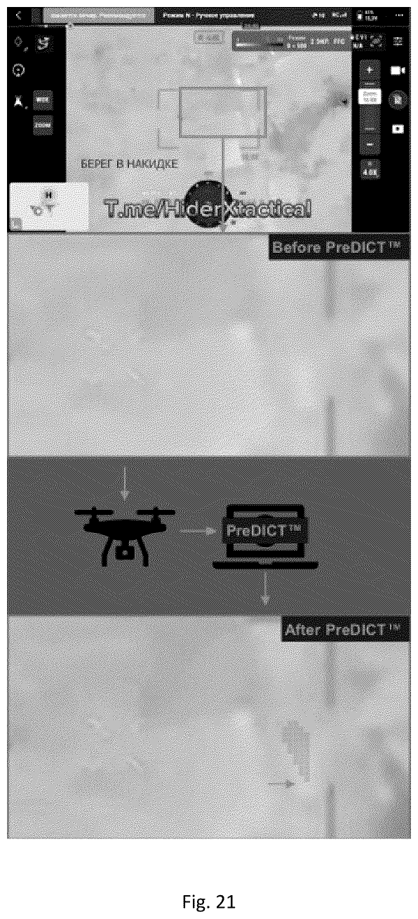

FIG. 21 illustrates a test verifying that the system detects live human signatures concealed by Russian, HiderX multispectral camouflage. The top panel shows a still shot from 0.9 seconds of video captured by a dynamic aerial drone equipped with a thermal sensor set to “black hot.” A subject in the video is concealed by HiderX multispectral camouflage, which is currently employed by Russian forces on the battlefield in Ukraine. The distance from the sensor to the subject is unknown. The video was processed by the camo defeat and testing system on a conventional, off-the-shelf laptop in seconds to detect human signatures over the 0.9 second video interval. As shown in the bottom panel, the subject wearing the camouflage was identified moving from top to bottom of the screen.

FIG. 22 Illustrates visual augmentation of thermal video in real time by the system to detect 3 human subjects, including two subjects wearing FibroTex NIGHTWALKER™ multispectral camouflage. FIGS. 22A-22C are video still shots taken from 1.6 seconds of video showing the video visually augmented by the system to identify the subjects juxtaposed with the same video unprocessed by the system software and, accordingly, without visual augmentation. The portions of the still shots labeled “With PreDICT” is the video being processed by the system in real time. The portions labeled “Without PreDICT” is the unprocessed video. The video is “open-source” acquired from an internet site where it was posted to demonstrate the capabilities of FibroTex NIGHTWALKER™.

The test scenario illustrated in FIG. 22 shows three human subjects moving across rough terrain from right to left. The middle subject is not wearing multispectral camouflage. The other two subjects are wearing FibroTex NIGHTWALKER™ multispectral camouflage. The subjects are being filmed by a dynamic aerial drone equipped with a thermal sensor set to “black hot.” During the video interval the drone is flying away from the subjects starting at a distance of approximately 1175 m and ending at approximately 1190 m. The drone is simultaneously moving laterally as it moves away from the subjects.

FIGS. 22A-22C highlight challenges in detecting camouflaged targets and the utility of the combined spatial and temporal processing approaches. From the perspective of the system, the middle subject, not wearing multispectral camouflage, is easily identifiable in both the spatial and temporal domains. The left most subject, wearing multispectral camouflage, is relatively easy to identify in the temporal domain and relatively challenging to identify in the spatial domain. The right most subject, wearing multispectral camouflage, is relatively easy to identify in the spatial domain and relatively challenging to identify in the temporal domain.

In the temporal domain of the video there is signal related to the subjects along with a significant amount of noise, and artifact and the signal is not uniform across the three human subjects, which creates threshold detection challenges relative to the noise and artifact. The noise arises from the sensor system, largely in the form of static, which is likely a function of the gain setting, resolution, and distance (over 1 kilometer) from the subjects. The artifact arises from the motion of the drone, in at least two axes, relative to the environment and background. Because the drone is moving, it appears as if the background is moving. Ideally, gyroscopic and accelerometer data from the aerial drone would be available for normalization and processing of the video to eliminate or attenuate this motion artifact. However, because this was open-source video acquired from the internet, accelerometer and gyroscopic data from the drone were not available and all temporal normalization and processing were performed at the software level. At the most basic level, temporal artifact and noise identification and elimination was achieved using motion stabilization tools and by identifying and subtracting all temporal negative SOI, the temporal signal in the imagery that was inconsistent with or below a detection threshold for the human subject signals in the imagery.

The origin of temporal signals arising from human subjects has previously been described. The system detects, amplifies, and processes these signals to identify characteristic human temporal signatures, which are used accordingly to classify these signals as positive temporal SOI and the spatial locations where they are identified as positive temporal ROI. In this example, the strongest relative signals arise from the gross movement of the subjects walking across the terrain and, consequently, the characteristic human signatures in the signal relate to human kinesis, such as gait characteristics. The left most and the middle subjects are moving briskly across the terrain during the video interval and, consequently, produce high amplitude temporal signals and distinct signatures. They are easily detected and identifiable through temporal signals and signatures relative to temporal noise and artifacts. In contrast, the right most subject is relatively static during the video interval and consequently has a low amplitude signal and less distinct signature relative to noise and artifacts, making the detection of this subject more challenging in the temporal domain relative to the other two subjects.

In the spatial domain, the middle subject, without multispectral camouflage, is clearly visible against the background with the thermal sensor. The left and right most subjects, both wearing multispectral camouflage, are much more difficult to detect upon visual inspection. This is consistent with the purpose of the multispectral camouflage and demonstrates the effectiveness of the camouflage. Comparing the left and right most subjects, the right most subject is easier to detect in the spatial domain. First, the scale of the right most subject is similar to the scale of the readily apparent middle subject. In this example, the middle subject was used to normalize the scale for computer vision detection tools. The system is thus looking for subjects similar in size and/or anatomical parts (head, torso, arms, and legs) of expected size for the determined scale. Another spatial normalization method that could have been employed in this case, but was not for this developmental iteration of the software, was using the known distance information for the sensor (˜1175-1190 m). Second, the right most subject looks humanoid in shape and appearance. Even though the thermal signature of the subject is significantly attenuated, the basic outline of the head, torso, and legs is detectable both visually and, from the standpoint of the system software, with trained computer vision tools. In contrast, the left most subject is more difficult to distinguish spatially from the background based on scale and other spatial characteristics such as shape. In this case, computer vision tools, such as blob detection tools, are capable of distinguishing characteristics of the subject from the background to help successfully detect the subject. The system uses computer vision tools and, as with temporal processing and detection, threshold detection parameters and AI software development approaches to identify and distinguish positive versus negative SOI and ROI for detection of spatial targets of interest, including challenging targets of interest such as the subject on the left.

Once the temporal and spatial processing are complete and ROI have been identified in both domains, the ROI from each domain can be correlated to determine where they intersect throughout the video imagery. This processing can be conducted, from a user's perspective, in real time with the video. Regions of maximum intersection correspond to the highest certainty of detection. For example, the middle subject has very high detection scores in both domains. The left most subject has a relatively high detection in the temporal domain and a relatively low detection in the spatial domain. The right most subject has a relatively low detection in the temporal domain and a relatively high detection in the spatial domain. The areas in the image highlighted in green indicate the regions in the image where positive SOI, and corresponding ROI, intersect in space and time. In the developmental version of the system software shown in FIG. 22, the size of the green area associated with each subject is used as a qualitative indication of the strength of the overall detection for that subject.

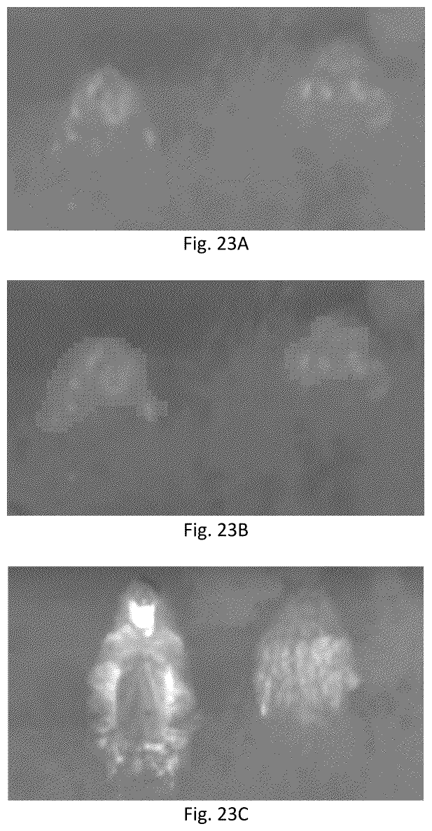

FIG. 23 illustrates the system detecting 2 static human subjects concealed by multispectral camouflage and vegetation at approximately 600 meters. FIG. 23A is a still shot from 5 seconds of thermal video of the subjects prior to processing with, and detection by, the system software. In FIG. 23A, the subject on the left is crouching down and facing the camera and is wearing the following multispectral camouflage technologies: an Ametrine Tech™ top, a Beez Combat Systems Cobra Lite™ Ghillie Hood, and a Spectraflage™ Blanket over his head. In FIG. 23A, the subject on the right is crouching down and facing away from the camera and is wearing the following multispectral camouflage technologies: a Beez Combat Systems Cobra Lite™ Ghillie Hood and a First Spear Light Weight Assault Ghillie™. The subjects were filmed by a static FLIR SEE SPOT III™ thermal scope on a “white hot” setting at 2.5× magnification at a distance of approximately 600 meters. The 5 seconds of video obtained, depicted by the still shot in FIG. 23A, was processed on a conventional off-the-shelf laptop in seconds and successfully detected the 2 human subjects, as depicted in FIG. 23B. FIG. 23C shows a still shot from video captured after the test scenario depicted in FIG. 23A was completed. In FIG. 23C the subjects are standing above the vegetation and have removed layers of their multispectral camouflage clothing. FIG. 23C is in the same location and filmed at the same distance as the test video depicted in the still shot in FIG. 23A. Contrasting FIGS. 23A and 23C demonstrates the effectiveness of the multispectral camouflage. Contrasting FIGS. 23A and 23B demonstrates the effectiveness of the system at detecting and highlighting the subjects despite the use of multispectral camouflage.

The present invention evolved from a logic-video enabled mass casualty (MASCAL) triage capability of the PreDICT system described in U.S. Pat. No. 11,978,558 and under development by Hunamis, LLC that detects live human signatures in video, including respiratory rate (RR) and heart rate (HR), in live or recorded video from red-green-blue, IR/Thermal sensors, and other video sensors. The foundational functionality underlying this capability is a motion amplification technique to amplify and process invisible and low-perceptibility signals in the video arising from human motion and physiology to identify live human signatures and vital signs. In the simplest terms, this software can be conceived as a capability to detect live humans in video. Hunamis, LLC applied this capability to videos of human subjects concealed by both traditional visual camouflage and multispectral camouflage technologies and determined that the capability could detect human signature information even if the human subjects were not easily visible or were not visible in the video. Based on this, Hunamis, LLC began to purpose develop the software as a camouflage, and particularly a multispectral camouflage, testing and defeat capability. The PreDICT system is described in more detail below.

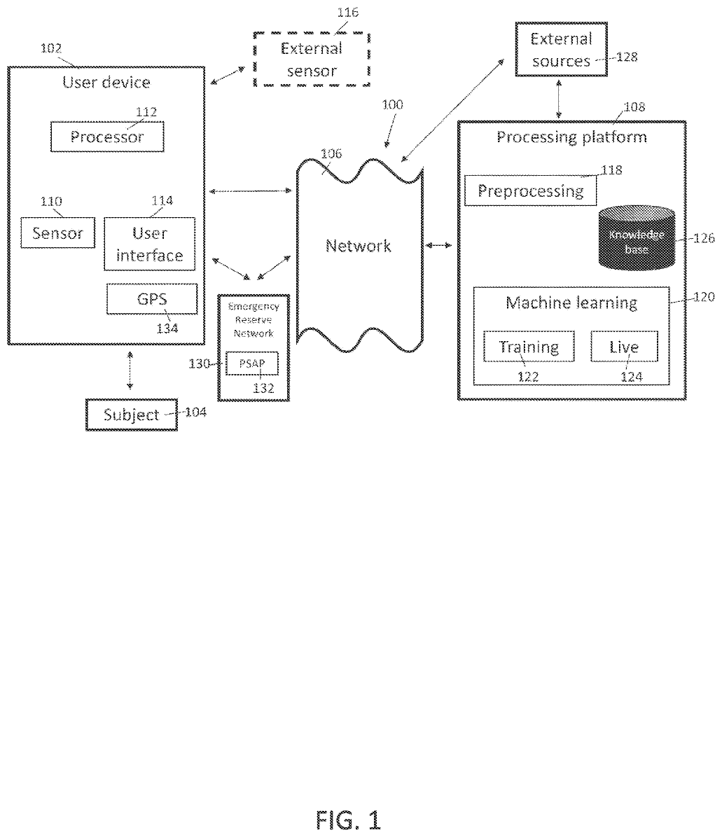

FIG. 1 is a schematic diagram of a Predictive Diagnostic Information Capability-Technology (PreDICT™) system 100 in accordance with the present invention. More specifically, FIG. 1 illustrates the system 100 in connection with a first use case relating to use of the system in a medical context and in the field, i.e., outside of a medical facility. Such use may be by a nonexpert users such as a layperson, by a first responder, or others. Moreover, data for the system 100 may be collected by medical providers, laypersons, users, subjects, or a third party not expressly for the purposes of the system. Data may be ingested and utilized for diagnosing and treating novel patients or it may be captured and compared against previously ingested data for a specific patient or group of patients. Previously ingested data may have been for the purposes of establishing a baseline or for the purposes of providing diagnosis and treatment or for another purpose altogether. However, for purposes of illustration, the illustrated system 100 generally includes a user device 102 for use by a user assisting a subject 104, a processing platform 108, and a network 106 for connecting the user device 102 to the processing platform 108. The system 100 may also involve an emergency response network 130 that includes public-safety answering points (PSAPs) 132 or similar network infrastructure in secure and unsecure, classified and unclassified military, maritime, disaster or other communication networks.

The illustrated user device 102 may include, for example, a smart phone, tablet computer or similar device. The user device 102 includes one or more sensors 110, a processor 112, and a user interface 114. As will be understood from the description below, a variety of types of sensors may be utilized including, for example, the device's video camera, the device's touchscreen, a microphone, or the like. Optionally, external sensors 116 such as an infrared camera, a pulse oximetry sensor, a digital thermometer or the like may be used in conjunction with the user device. For example, such sensors may be incorporated into a wearable in communication with the user device. Information from other types of sensors, such as impact monitors implemented in helmets for sports or military use, may also be employed.

In alternate use cases, such as battlefield environments or applications that ingest information from drones, available security cameras, or other sources, different workflows may be involved, for example, not involving an interactive interface for data acquisition. In the illustrated use case, the user interface 114 can be used to access the processing platform, to input information about the subject or the condition at issue, to provide information about the location or environment or other information that may be useful by the processing platform 108. The user interface may be implemented via voice activation, a touchscreen, a keyboard, graphical user interface elements and the like. The functionality of the sensor 110 and user interface 114 may be executed on the processor 112. The processor 112 is also operative for executing a variety of input and output functions, for example, related to interfacing with the processing platform 108.

The system 100 may also use information regarding the location of the user device 102. Where the user device 102 includes a GPS module 134 or other location information provisioned by satellite constellations, such information may be reported to the processing platform or used to route first responders to the user device 102. In other cases, location information may be provisioned by a cellular network technology such as angle of arrival, time delay of arrival, cell ID, cell sector, microcell, or other location technologies. Such location information may be provided to the processing platform 108 and emergency response network 130 via the user device 102 or via a separate pathway, e.g., from a network location information gateway. Location data may also be derived from recognition by the technology of environmental signatures including, but not limited to, image and acoustic signatures at a specific location that serve to localize, at some level of specificity, where the technology is being applied.

The system 100 may be implemented via a variety of architectures. For example, the functionality described in more detail below may be cloud-based such that little or no logic is required on the user device 10 to the implement the functionality. Alternatively, an application may reside on the user device 102 to support all or certain functionality of the system 100. For example, certain preprocessing may be executed locally to support the machine learning functionality of the processing platform 108. As a still further alternative, some of the logic may be implemented within the emergency response network 130, for example, at a PSAP 132. Thus, for example, a layperson assisting a subject 104 in an emergency environment may dial an emergency phone number (e.g., 911 in the United States) via a telephony or data network (e.g., VOIP). In such cases, the emergency call may be routed to an appropriate PSAP 132 via conventional network processes. Emerging technologies allow files to be uploaded from the user device 102 to the PSAP 132, including video and audio files. Accordingly, sensor information and other information from the user device 102 can be routed to the PSAP 132 which may in turn interface with the processing platform 108 to implement the functionality described herein. As will be understood from the description below, in many important use cases, such as battlefield environments or in the aftermath of a natural disaster, networks may not be available or may be limited. In such cases, the system may be implemented to function using local resources, satellite communications or emergency networks and the functionality may adapt to such environments.

The processing platform 108 processes the sensor information and other information from the user device 102, determines risk stratification information as well as medical diagnosis and treatment option information based on machine learning technology, and provides output information to the user device to assist the user in treating the subject 104. The illustrated processing platform 108 includes a preprocessing module 118, a machine learning module 120 and a knowledge base 126. The preprocessing module 118 performs a number of functions to prepare the input data from the user device 102 for use by the machine learning module 120. In this regard, the input data may need to be processed to obtain various subject parameters. For example, video data from the user device 102 may be processed to obtain information regarding temperature, perfusion, respiratory action or various motor functions, as described in more detail below. Audio information may be processed to determine certain vocal biomarkers such as speech patterns, tone or rate. In addition, the input data may be annotated and classified, regions of interest or signals of interest may be selected, the data may be normalized, and features may be extracted. Thus, a variety of metadata may be associated with the input data to support the machine learning functionality.

The machine learning module 120 includes a training mode 122 and a live mode 124. In the training mode, training information is provided for use in developing models that can be used to generate risk stratification and medical diagnosis information. In the live mode 124, live data from a user device 102 is processed using the developed models to generate output information to provide to the user device 102. Various supervised and unsupervised machine learning technologies may be employed as described in more detail below.

The knowledge base 126 stores information used by and generated by the pre-processing module 118 and the machine learning module 120. This may include training data, model information, statistical data, demographic data, medical record information, and any other information that is useful in developing and executing the machine learning models. One advantage of implementing the system 100 using a centralized processing platform 108 is that, over time, a rich knowledge base accumulated over many experiences concerning different kinds of conditions for different subjects will be available to improve the accuracy of evaluations. It will be appreciated that, although the processing platform 108 is shown as a single element for purposes of illustration, the functionality of the processing platform 108 may be distributed over many machines and may be geographically distributed to improve response. For implementations of this technology where processing is either desired or required on a localized and/or individual device or platform, the technology application is updated from the centralized processing platform.

The processing platform 108 may also access certain external sources 128. Such external sources 128 may be used to gather information to assist in developing and executing the models of the machine learning module 120. This may include medical record information from medical facilities and government sources, medical records for specific subjects 104 being evaluated, demographic information, e.g., from private and government sources, modeling tools, and other information. Such information may be provided directly to the processing platform 108 or may be accessed by a user device 102 or emergency response network 130. In connection with the user device 102, emergency response network 130, processing platform 108 and external sources 128, data may be filtered or otherwise processed (e.g., anonymized, aggregated, or generalized and through use of methods such as Federated Learning) to address privacy concerns. For example, the use of particular items of information may be controlled by the user or subject 104, by policies implemented in connection with the system 100, medical facilities, or other entities, or in accordance with applicable regulations.

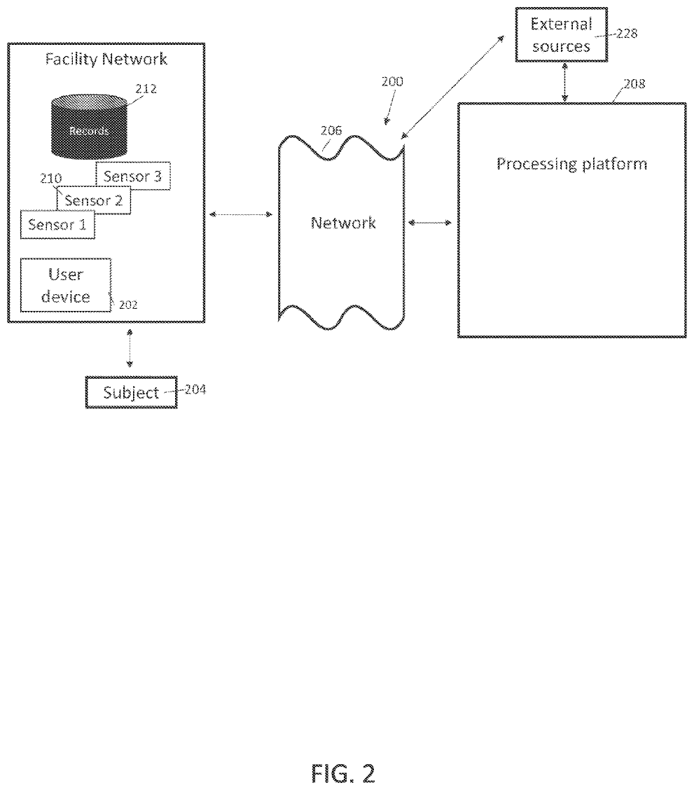

FIG. 2 shows another use case of a PreDICT system 200 in accordance with the present invention. The illustrated system 200 includes a user device 202 for use by a user in treating a subject 204, a processing platform 208, external sources 228 and a network 206 for interconnecting these various elements. The network 206, processing platform 208, and external sources 228 are generally similar to the corresponding elements described in connection with FIG. 1 and such description will not be repeated.

In this case, however, the user device 202 is implemented in connection with a facility network 214. For example, the facility network 214 may be a local area network or other network associated with a hospital, clinic, or other medical facility. The user device 202 may connect to the facility network 214 to access patient records 212, upload sensor data from the user device 202 and/or other sensors 210, and access various other network-based resources. For example, the user device may comprise a tablet computer or intelligent medical device. In this regard, information from a variety of sensors 210 may be available for transmission to the processing platform 208. Thus, a patient and medical facility may have a variety of vital sign and other information that is continuously or periodically monitored by the sensors 210. An application executed at the user device 202 and/or processing platform 208 may harvest sets of data from the sensors 210 on a defined schedule or on demand. It will thus be appreciated that, in the illustrated use case, the processing platform 208 may have access to a rich data set for processing and may provide correspondingly accurate and detailed reports to the user device 202 for use by skilled and expert users.

Much of the immediately preceding discussion has focused on contexts where a user is actively involved in initiating actions or inputting information. In many emergency contexts that form an important application of the present invention, the user's ability to activate sensors and input information may be limited or the user's attention may be required for other purposes. Thus, it will be appreciated that the invention may operate differently in other contexts or use cases.

To understand the functionality of the PreDICT system and the manner in which users will interface with the device, it is important to understand one of the key use cases and certain attributes of this use case, which are applicable to multiple other use cases.

USE CASE: Employment by a battlefield medic during a kinetic engagement taking care of a close and personal friend who has been badly wounded. There are multiple considerations in this scenario as to how users optimally interact with the capability: 1) Physical considerations—the user's hands and/or gloves may be covered in blood, dirt and fluid. The medic may be copiously sweating, thus impairing or precluding interaction with the PreDICT device/interface. This may occur at night and the tactical situation may prohibit a bright touchscreen. Night vision compatible screens still encounter the problems with blood, dirt, sweat, etc. These factors make it very difficult to interact with a touchscreen or keyboard, 2) The user may be in a high emotional state and his cognitive and technical bandwidth may be consumed by taking care of the casualty, his friend. Every requirement to actively interface with the capability, other than to get exactly the information the medic needs, unnecessarily draws on his already limited bandwidth and requires more time in a time-constrained problem-set. As long as the sensors are active and appropriately oriented, the PreDICT system is acquiring, processing, analyzing, and outputting information with minimal requirements for user interface. The PreDICT system can communicate this information to him through multiple means such as a screen display and/or audio information through the medic's radio headset (such as a Peltor headset). If the PreDICT system detects that the user is not optimally caring for the patient and assesses that an intervention is not necessary or that another intervention or course of action is preferable, it can “escalate its communication” with the user through various auditory and/or visual and/or tactile prompts.

If the PreDICT system requires more information to determine the desired outputs, the capability can prompt the user to enter or acquire more information. The user can then do this by adding or adjusting a sensor capability or by providing voice, touchscreen, or keyboard inputs.

Employment of multiple technical capabilities in medical and other scenarios have encountered the two key issues described above: 1) Physical considerations make it difficult to interact with the device, and 2) The device places high demands on the bandwidth of the user that is otherwise required to resolve the problem at hand, which effectively makes the technical capability part of the problem. The PreDICT system will avoid these limitations and liabilities.

The bottom line is that, during the period of employment, the PreDICT system will require minimal effort or input from the user.

The PreDICT system, as a sensor and/or device and/or system and/or network, can be activated (“turned on”) actively, passively, directly, or remotely to include the ability of the PreDICT system to self-activate in response to certain signals or signal patterns. For example, it detects gunshots, 9-1-1 is dialed, or it detects a deceleration pattern indicative of a car crash. It can also go into specific modes based on these signals.

Once activated, the PreDICT system will extract, process, and analyze data from the subject and the environment to determine what mode it needs to be in and will function accordingly. It may have one or several default settings that it will activate in response to specific signals to place it in a specific mode. Or, it may prompt the user to place it in a specific mode if it cannot extract the necessary or sufficient information or if it does not have the computational bandwidth to extract, process, and analyze the information and determine the appropriate mode.

PreDICT system users will have the ability to select certain modes and/or menus via voice, touchscreen, keyboard, or other sensor inputs. Typically, a user would select these modes outside of or in anticipation of a specific scenario or rapidly via voice or other prompts as the scenario presents. These menus will range from broad to specific. For example, broad menus cover different use case domains such as “medical” and “intentionality.” Within the “medical” heading there are multiple different chief complaints, body systems, anatomic regions, and/or subsets of pathology, etc. Within the “intentionality” heading there are multiple options such as “threat,” “truthfulness,” etc. If the user knows that they will encounter, or have a high probability of encountering, a trauma patient they may elect to place the capability in a “trauma mode.” In another scenario, and for a different domain use case, the user may place the device in “threat mode” to determine if an individual in their environment represents a threat. The purpose for preselecting modes be to preserve computational bandwidth on a PreDICT device and/or network where the capability would otherwise need to extract, process, and analyze sensor data to determine that it was in a trauma or threat scenario.

In summary, the interface functionality of the PreDICT system ranges from a default with minimal to no user interface requirements during PreDICT application to, if desired and feasible, intensive interface between user and capability. The PreDICT user interface can also be a hybrid along a spectrum between minimal interface (system is only outputting information to user) to intensive manual interface by the user into the capability. The tradeoffs between these ends of the spectrum entail a balance between the bandwidth and physical capability of the user to interface with the capability and the computational bandwidth of the PreDICT capability.

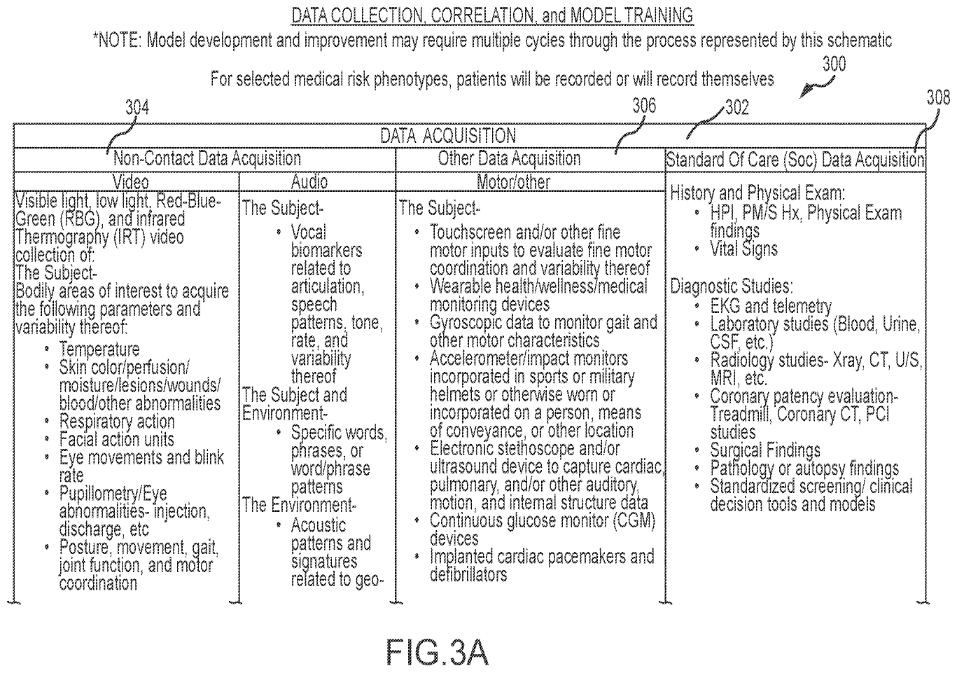

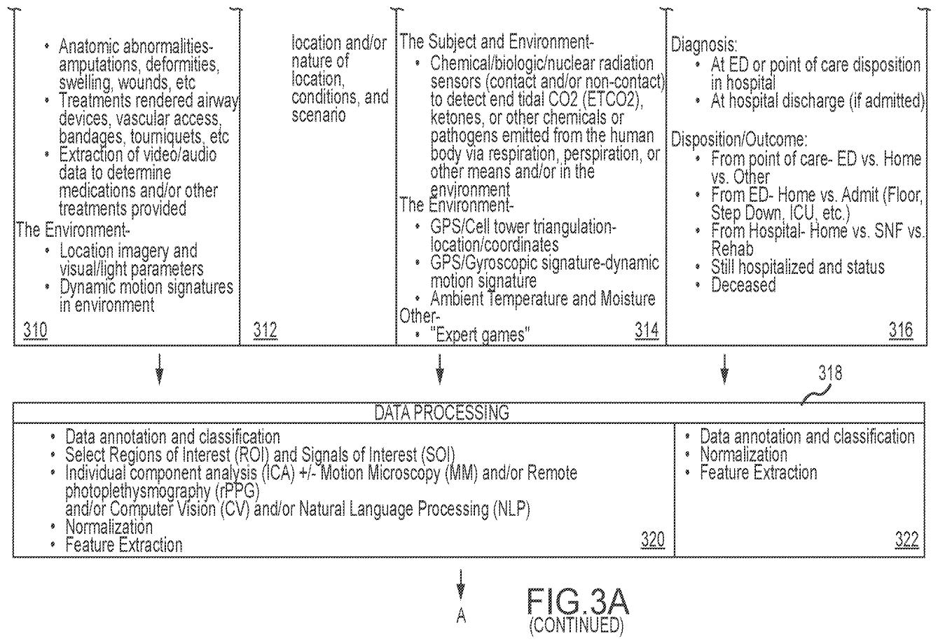

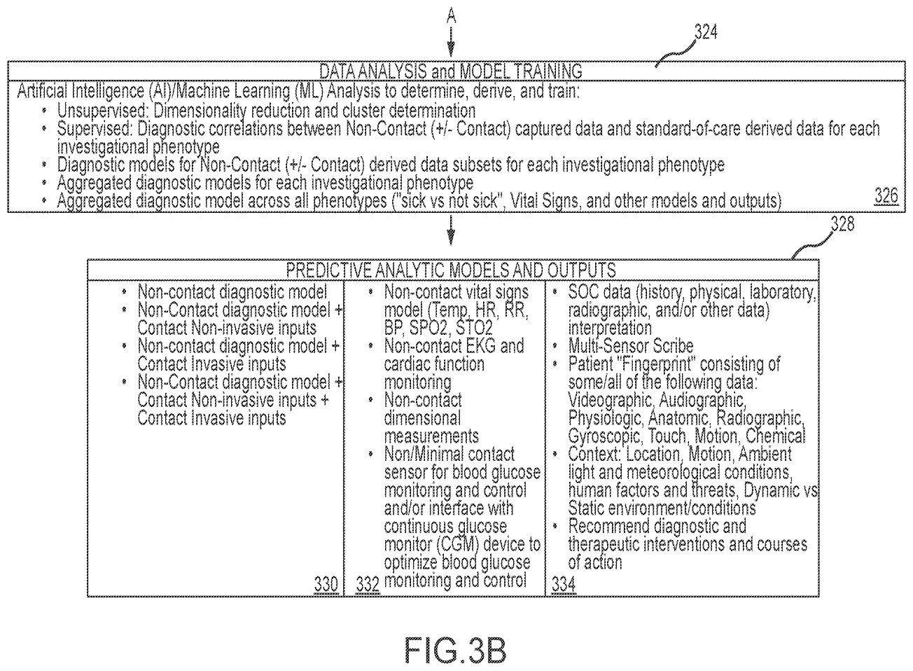

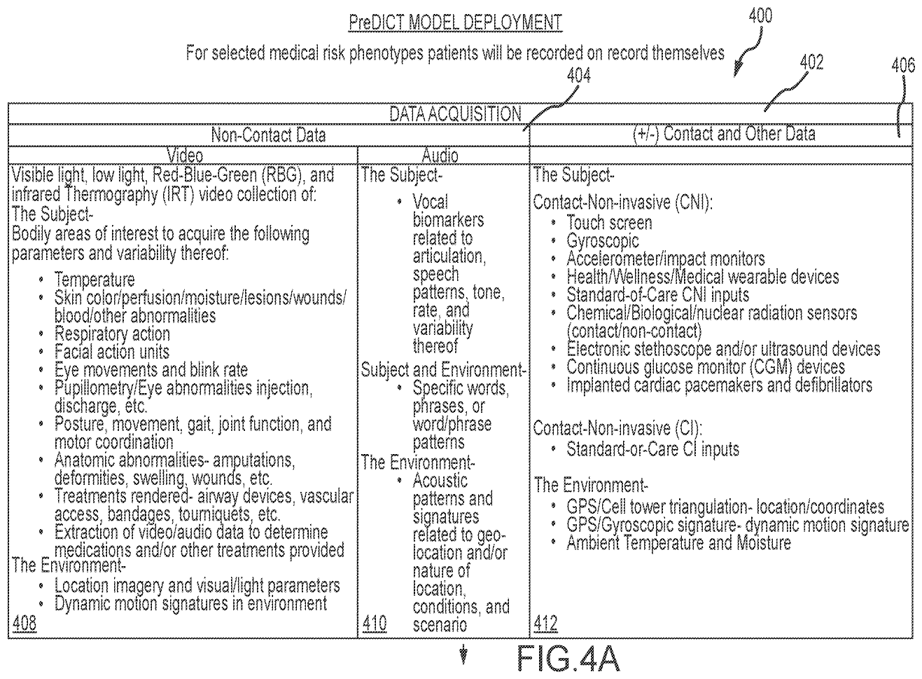

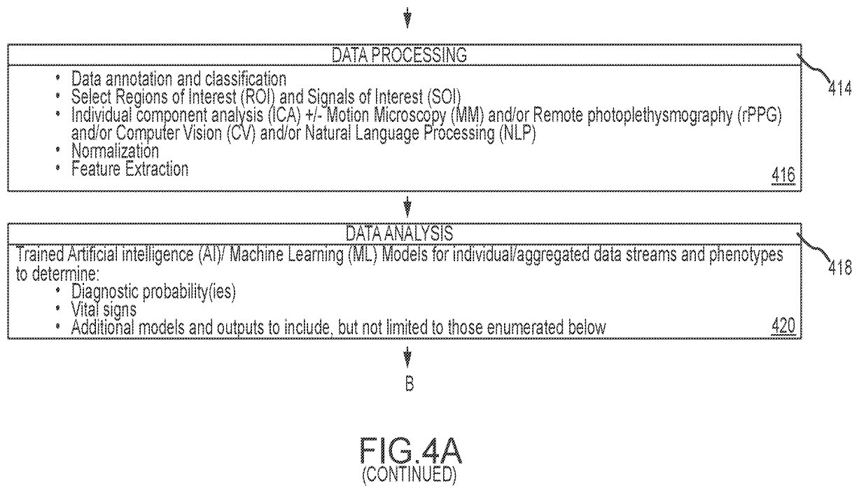

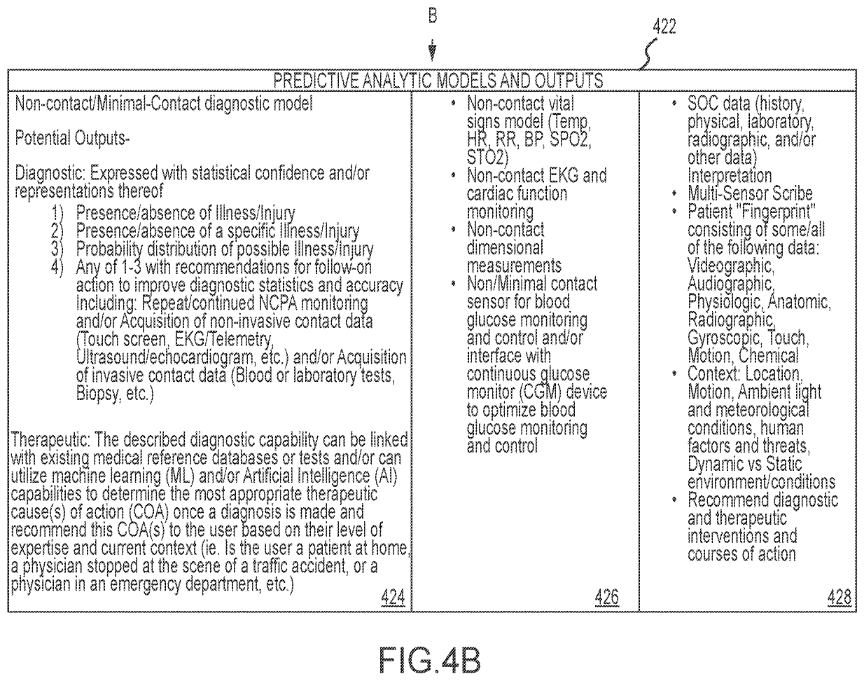

As noted above, the machine learning processes implemented in connection with a training mode and a live data mode. This may alternatively be denoted as model training and model deployment. These processes are illustrated in FIGS. 3-4.

Referring first to FIG. 3, the model training process 300 generally includes data acquisition (302), data processing (318) or preprocessing, data analysis and model training (324), and development (328) of noncontact predictive analytic models. In the illustrated process 300, data acquisition (302) involves non-contact data acquisition (304), other data acquisition (306), and standard of care data acquisition (308). The non-contact data acquisition (304) and contact data acquisition (306) processes may be implemented by users in connection with live medical evaluations or by users entering training data. In the case of users involved in live medical evaluations, the data may be entered in response to prompts of a user interface or in response to questions from a PSAP operator or other person. For example, when a user accesses a processing platform of the PreDICT system, the user may be prompted to enter information regarding a current condition being evaluated, e.g., by selecting “chest pain” from a drop-down menu or otherwise describing a medical condition via a structured or free-form data entry. In response to such an input, the processing platform may execute branching logic and present additional user interface screens depending on the information entered by the user on previous screens. Such screens may prompt the user to obtain sensor information and upload the sensor information to the processing platform. For example, the user may be prompted to obtain a video clip of the subject's face and neck region and upload the video file together with an audio recording of the patient to the processing platform.

As shown, the noncontact data (304) may include video data (310) and audio data (312). The video data may be obtained using any type of camera device including but not limited to a standard webcam, a smart phone camera, Google Glass or other glasses-camera devices, GoPro® type cameras, body mounted cameras; static cameras such as security and surveillance type cameras; cameras mounted on mobile platforms such as aerial, ground based, or aquatic/maritime vehicles or autonomous or remotely operated vehicles; another red-blue-green camera; low light; and/or an infrared thermography video camera. Video data utilized by this technology may be obtained/extracted from video not expressly recorded for the purposes of applying this technology. Such cameras may be used to obtain a video recording of the head and neck region or other body areas of interests of the subject to acquire information indicative of any of the following or combinations, variability or other derivatives thereof: temperature; skin color, perfusion, or moisture; lesions, wounds, blood or other abnormalities; respiratory action; facial action unit; eye movements and blink rate; pupillometry, eye abnormalities-injection, discharge, etc.; posture, movement, gait, joint function, and motor coordination; anatomic abnormalities-amputations, deformities, swelling, wounds, etc.; treatments rendered-airway devices, vascular access, bandages, tourniquets, etc.; and extraction of audio/video to determine medications and/or other treatments provided. Such cameras may also be used to obtain information on the environment where a subject is located (or with the environment as the subject) such as location imagery; visual and light parameters; and dynamic motion signatures in the environment. The audio data, which may be obtained as an audio track accompanying a video recording and/or may be obtained separately through any capable recording device and/or derived through data processing techniques such as motion microscopy (MM), may include information indicative of vocal biomarkers for the subject and/or others in the environment related to articulation, speech patterns, tone, rate, and variability thereof. Audio data may also include specific words, phrases, and/or word phase patterns related to the subject and/or others in the environment. Audio data may also include acoustic patterns and/or signatures related to geolocation and/or the nature of the location, conditions, and scenario.

The other data (306) involves data that may be obtained via contact between the subject and a sensor and may include data on motor function or other parameters of the subject and/or environment (314). For example, the subject may be prompted to interact with materials or graphical objects presented on a touchscreen and/or to interact with other equipment to evaluate fine motor coordination and variability thereof over time. Additionally or alternatively, sensors such as gyroscope based instruments may be applied to the subject or embedded in devices carried by or on the subject for other purposes such as smart phones or wearable fitness devices to obtain gyroscopic data for monitoring gait and other motor characteristics.

Accelerometer/impact monitors may be incorporated in sports or military helmets or otherwise incorporated on a person, means of conveyance, or other location and used to obtain impact data. As a still further alternative, wearable health/wellness/medical monitoring devices may be employed to obtain various kinds of sensor information such as pulse oximetry data, heart rate and heart rate variability data, respiration rate, and parameters related to the autonomic nervous system. Such data acquisition may further involve chemical and/or biologic and/or nuclear radiation sensors (contact and/or non-contact) to detect end tidal CO2 (ETCO2), ketones, acetone, alcohol metabolites, or other chemicals/toxins, biologic material or organisms, or radiation emitted from the human body via respiration, perspiration or other means and/or to detect chemicals/toxins, biologic materials or organisms, or radiation in the environment. Electronic stethoscope, doppler, and ultrasound data may be obtained to capture cardiac, pulmonary, and/or other auditory, motion, and internal structure data related to the subject. Further data on the subject may be captured using continuous glucose monitoring (CGM) devices and/or from implanted cardiac defibrillators and pacemakers. Data may also be obtained on the environment, location, and the nature of the location and environment to include ambient temperature and moisture data; global positioning system (GPS) and or cell phone tower triangulation data; and dynamic motion signatures from GPS and gyroscopic devices to determine motion parameters in multiple dimensions for scenarios such as, but not limited to, travel on ground, maritime, or aerial platforms. Lastly, data acquisition may include “expert games.” Expert games are a mechanism to build or augment data sets for training machine learning and/or artificial intelligence systems and for those systems to build models. Expert games use real or hypothetical case studies of problems in domains of interest to build “games” for relevant experts. Through the “playing” of these games, key information about expert decision making and the problem-sets posed by the “games” can be extracted to create data sets for machine learning and/or artificial intelligence analysis, learning, and modeling. The PreDICT system will use expert games to augment training and functionality for application to multiple domain scenarios. Expert games will particularly apply when training and modeling high-consequence, low frequency events.

Sensor platforms may include fixed camera and/or audio recording or other devices for the purpose of obtaining input data related to the diagnostic and/or predictive capabilities of this capability or fixed sensors not explicitly for the purposes of this capability, such as surveillance cameras. Sensor platforms may also include human or vehicle (to include ground, air, and maritime platforms both manned, unmanned, and autonomous) mounted or transported sensors. Remotely piloted and/or autonomous ground, air, and maritime vehicles will provide important platforms for PreDICT as sensor platforms and/or as network nodes for PreDICT capability and/or by using PreDICT capability as the decision-making application to guide the functionality of the platform as in the case of autonomous systems.

The standard of care (SOC) data (308) may be obtained from the subject, the user, patient records of the subject, patient records from a medical facility, peer-reviewed literature, government databases, other third-party databases, and other sources. Examples (316) of such data include records of the subject's medical history and physical exam data such as history of present illness/injury (HPI) data, past medical and surgical (PM/S Hx) to include allergies and medications, physical exam findings and vital signs, possibly including electronic stethoscope data. In addition, the data may be obtained from diagnostic studies such as electrocardiogram (EKG) and telemetry, laboratory studies (blood, urine, cerebral spinal fluid (CSF), etc.), Radiology studies (e.g., x-ray, computed tomography (CT), ultrasound (U/S), and magnetic resonance imaging (MRI)), coronary patency evaluation (e.g., treadmill stress test, coronary CT, and percutaneous coronary intervention (PCI) studies), cardiac catheterization, surgical findings, pathology and autopsy findings, electroencephalogram (EEG), and standardized screening and clinical decision tools and models. The standard of care data (308) may further include diagnoses such as those made at emergency department (ED), clinic or point-of-care disposition, in-hospital diagnoses and diagnoses made at hospital discharge (if admitted). Finally, the data (308) may include disposition/outcome data from the point-of-care (ED vs. home vs. other), from the ED (home vs. admit-floor, step down, ICU, etc.), and/or from the hospital (home vs. SNF vs. rehab). The disposition/outcome information may also include status information such as whether the subject is still hospitalized and their current status or whether the subject is deceased. Standard of care data and other medical data may also be acquired from other treatment environments and paradigms (e.g. non-clinic, non-emergency department, non-hospital based under some standard conditions) such as deployed military medical treatment facilities, humanitarian medical programs, medical disaster response scenarios, austere medical events or programs, and/or emergency medical services

The data processing (318) involves pre-processing of input data so that it is suitable for use in a machine learning process. As noted above, this may involve processing raw inputs to obtain the desired parameters. For example, infrared camera data may be processed to obtain temperature information and variations thereof or video files may be analyzed to obtain information regarding facial or eye movements. Such input information or parameter information may be further supplemented to assist in processing by the machine learning module. For example, noncontact data (304) and/or contact data (306) may be processed (320) to annotate and classify the data, to select regions of interest and signals of interest for further processing, to perform individual component analysis for example with or without motion microscopy and/or remote photoplethysmography and/or computer vision, and/or natural language processing, to normalize the data to facilitate comparisons, and to perform feature extraction. The standard of care data (308) may be processed to annotate and classify the data, to normalize the data, and to perform feature extraction among other things.

The data analysis and model training (324) involves processing the training data to develop models for use in analyzing live data. In the illustrated process 300 this involves using artificial intelligence/machine learning analysis to determine, derive, and train (326) the models. Artificial intelligence techniques may include, but are not limited to, neural network techniques. A variety of machine learning processes may be used in this regard including unsupervised machine learning for dimensionality reduction and cluster determination; supervised machine learning to develop diagnostic correlations between noncontact and/or contact capture data and standard of care derived data for each investigational phenotype; developing diagnostic models for noncontact and/or contact derived data subsets for each investigational phenotype; developing aggregated diagnostic models for each investigational phenotype; and developing aggregated diagnostic models across all phenotypes (sick vs. non-sick and vital signs) among other processes.

The results of the data analysis and model training (324) is the development of noncontact predictive analytic models (328). These include diagnostic models (330), noncontact models (332), and other outputs (334). The diagnostic models (330) may further include standalone non-contact diagnostic models, non-contact diagnostic models plus contact non-invasive inputs, non-contact diagnostic models plus contact invasive inputs, non-contact diagnostic models plus contact noninvasive inputs plus contact invasive inputs. The noncontact models (332) may include non-contact vital signs models, including temperature, heart rate (HR), respiratory rate (RR), blood pressure (BP), pulse oximetry (SPO2), tissue oxygen saturation (STO2); non-contact electrocardiogram (EKG) (or functional EKG equivalent) and cardiac function monitoring; non-contact dimensional measurements (e.g., video and/or sonographically derived measurements to determine the size and volume of anatomic, pathologic, or other human and non-human/non-living structures or entities); and a non/minimal contact sensor for blood glucose monitoring and control and/or interface with a continuous glucose monitoring (CGM) device to optimize blood glucose monitoring and control. The other outputs (334) may include standard of care (SOC) data (history, physical, laboratory, radiographic, and/or other data) interpretation; a “Multi-Sensor Scribe” that converts data streams into written, graphic, or other documentation formats for direct integration into existing electronic medical records (EMR) systems or other purposes; a “fingerprint” of a subject or environment including some or all of video, audio, pathologic, physiologic, anatomic, radiographic, gyroscopic, touch, motion, and chemical data; contextual models of the environment to guide decision making that include location, motion, ambient light and meteorological conditions, human factors and threats, and assessment of whether the context is static versus dynamic; and recommendations on diagnostic and therapeutic courses of action.

FIG. 4 illustrates a PreDICT model deployment process 400. In particular, the process 400 is illustrated with respect to four diagnostic models and additional models developed by the machine learning training process. The illustrated process 400 is initiated by data acquisition (402). In this case, the data acquisition (402) generally corresponds to the noncontact data acquisition (404) and contact data acquisition (406) described above in connection with FIG. 3. Indeed, it is anticipated that live data will also be processed through the model training process to further develop the models. Thus, the noncontact data (404) may include video data (408) and audio data (410), and the contact data (406) may include motor inputs and standard of care contact-non-invasive (CNI) and contact-invasive (CI) inputs (412) as described above. In addition, the illustrated data processing (414) may include various preprocessing functions (416) as described above in connection with FIG. 3.

However, in this case, the data analysis (418) involves deploying the trained machine learning models (420) with respect to individual or aggregated data streams and phenotypes to determine diagnostic probabilities, vital signs, and other outputs. Specifically, in the case of deploying the non-contact/minimal-contact predictive analytic models (422) with respect to live data involves deploying a non-contact/minimal-contact diagnostic model (424), deploying another non-contact model (426), and/or providing other outputs (428). The potential outputs of the diagnostic model (424) may include diagnostic and therapeutic outputs. The diagnostic output may be expressed with statistical confidence and/or representations thereof with respect to: 1) the presence or absence of illness or injury; 2) the presence or absence of a specific illness or injury; 3) a probability distribution for particular diagnoses; and any of items 1-3 with recommendations for follow-on action to improve diagnostic statistics and accuracy. Such follow-on actions may include repeat or continued non-contact predictive analytic (NCPA) monitoring and/or acquisition of noninvasive contact data (touchscreen, EKG/telemetry, ultrasound/echocardiogram, etc.) and/or acquisition of invasive contact data (laboratory tests, biopsy, etc.).

For the therapeutic output, the described diagnostic capability can be linked with existing medical reference databases or texts and/or can utilize machine learning and/or artificial intelligence, such as neural network capabilities, to determine the most appropriate therapeutic courses of action once a diagnosis is made and recommend this course of action to the user based on their level of expertise and current context. In this regard, the therapeutic output may take into account whether the user is a patient at home, a physician stopped at the scene of a traffic accident, a physician in an emergency department, etc.

The other models and outputs (426) may include a non-contact vital signs model (temp, HR, RR, BP, SPO2, STO2), a non-contact EKG and cardiac function monitoring model, a non-contact dimensional measurements model, and a non/minimal contact sensor for blood glucose monitoring and control and/or interface with a continuous glucose monitoring (CGM) device to optimize blood glucose monitoring and control. The other outputs (428) May include standard of care (SOC) data (history, physical, laboratory, radiographic, and/or other data) interpretation; a multi-sensor scribe that converts data streams into written, graphic, or other documentation formats for direct integration into existing electronic medical records (EMR) systems or other purposes; a “fingerprint” of a subject or environment including some or all of video, audio, pathologic, physiologic, anatomic, radiographic, gyroscopic, touch, motion, and chemical data; a contextual model of the environment that includes location, motion, ambient light and meteorological conditions, human factors, threats, and a measure of static versus dynamic conditions, and other parameters to guide contextual decision making on treatments and courses of action; and recommendations on diagnostic and therapeutic courses of action

The present invention is this applicable with respect to a variety of conditions and in a variety of contexts as set forth below.

Examples of Medical Conditions and Contextual Circumstances where technology provides utility: (Note: “Utility” refers to any of “ruling in”, “ruling out”, decreasing time to diagnosis, decreasing required interventions to arrive at diagnosis, decreasing cost, monitoring for deterioration/improvement, etc.)

Conditions: Including but not limited to:
Neurologic:
   Stroke (Cerebrovascular Accident (CVA)) and/or Transient Ischemic Attack (TIA)
   Traumatic Brain Injury (TBI)
   Spinal cord injury, compression, ischemia, infection
   Altered mental status
   Dementia vs. Delirium
Psychiatric/Mental Health/Developmental Conditions:
   Suicidality or risk for self-harm
   Homicidality or risk of harm to others
   Depression
   Mania
   Delirium
   Post Traumatic Stress Disorder (PTSD)
   Autism
Cardiopulmonary/Chest Pain:
   Heart Attack (Acute coronary syndromes (ACS))
   Dys-/arrhythmia
   Aortic Dissection
   Pulmonary Embolism (PE)
   Pneumothorax (PTX)
   Esophageal Rupture
   Pneumonia
   Asthma/COPD
   Congestive Heart Failure (CHF)
Cardiovascular:
   Blood pressure monitoring
   Hypertensive urgency/emergency
Pre-/Shock States:
   Distributive
   Hypovolemic
   Cardiogenic
   Obstructive
   Dissociative
   Resuscitation monitoring
Infectious Disease:
   Systemic infectious processes (i.e. Sepsis, COVID-19, etc.)
Localized infectious processes (i.e. Necrotizing fasciitis, cellulitis, pyelonephritis, etc.)
Intraabdominal and OB/GYN Processes:
   Appendicitis, Cholecystitis, Diverticulitis, Abdominal aortic aneurysm (AAA), etc.
   Ectopic pregnancy
   Ovarian torsion or cyst rupture
Ischemic Processes (not already mentioned):
   Embolic processes resulting in ischemic limb or other organ/region
   Testicular torsion
Musculoskeletal:
   Joint injury such as sprain, dislocation, or meniscus or labral tear
   Bone fracture
Trauma:
   Blunt
   Penetrating
   Burn
Toxicology:
   Toxidromes
   Intoxication
Metabolic and Endocrine disorders (e.g. Diabetes, glucose monitoring)
Malignancies/Cancer

### Contextual Circumstances:

Conventional medical settings: Doctor's office, Emergency Department, In hospital
Mass casualty events/incidents (aka. MASCAL, MCI)-Triage, risk-stratification, diagnosis
Austere and/or resource constrained environments
Pre-hospital (EMS)
Out of hospital (laypersons)
Telemedicine
Disease surveillance
Time challenged diagnoses (e.g., TBI)
Out of hospital monitoring
Military applications and combat settings

### Outputs:

The PreDICT system not only recommends what intervention a patient requires but also the logistics and sequencing of that intervention by processing not only information about the patient but also information about the risk-context surrounding the patient and their illness/injury. Several examples are below.
Example 1—The PreDICT system determines that a trauma patient requires endotracheal intubation because of an increasing inability to protect his airway. However, the PreDICT system also determines that the patient is hypotensive and has a probable pneumothorax. The PreDICT system determines that positive pressure ventilation from endotracheal intubation will cause immediate decompensation by: 1) increasing intrathoracic pressure in the setting of hypotension, which will decrease blood return to the heart via the vena cava, decrease cardiac preload, and decrease cardiac output and 2) it will convert the pneumothorax to a tension pneumothorax from the positive pressure ventilation, further increasing intrathoracic pressure and accelerating decompensation. Following this analysis PreDICT recommends an intervention sequence of: Step 1) Simultaneous chest tube placement and rapid infusion of 1 unit of whole blood, Step 2) Endotracheal intubation once Step 1 complete and blood pressure achieves a minimum of XYZ/xyz.
Example 2—The PreDICT system determines that a patient at Hospital A with chest pain is experiencing an ST elevation myocardial infarction (STEMI) and requires a cardiac catheterization to relieve the coronary artery obstruction. Hospital A does not have this capability but Hospital B does. This is a time-constrained medical problem-set (“time is myocardium”) and the patient's probability of survival and optimal future cardiac function is inversely related to the time to the procedure. The patient can be transported by helicopter or ground ambulance. The ambulance can have the patient loaded and depart in 10 minutes. It will take 5 minutes to get the patient to the cardiac catheterization lab at Hospital B once the patient arrives. The helicopter can have the patient loaded and depart in 30 minutes. It will take 10 minutes to get the patient to the cardiac catheterization lab at Hospital B once the patient arrives. The PreDICT system can evaluate historical transport data and real-time air and ground traffic data to determine that transport by helicopter will place the patient in the cardiac catheterization lab at Hospital B twelve minutes faster than transport by ground ambulance at this time of day due to heavy traffic volumes. Alternatively, the PreDICT system may recommend that the patient should be administered thrombolytic treatment for the STEMI at Hospital A because the transport time to Hospital B by either mode is prohibitively long given the patient's STEMI and the time since onset. (Thrombolytics are a “second line” treatment for STEMI if the patient cannot undergo cardiac catheterization within a recommended time window.)

### Use Cases, Dual/Alternative Use Cases and Potential Applications:

NOTE: These dual uses are not necessarily endorsed by the inventor.
Example of PreDICT employment towards a medical problem-set on a military special operations direct action raid.
   Consider the problem-set of a seriously wounded Soldier in the middle of a firefight during a raid to capture an enemy combatant who is barricaded in a building that is defended by a capable opposing military force. The successful resolution of this problem-set requires averting the determinative risk associated with the casualty's injuries. For this to happen, the casualty must receive immediate mitigating treatment for his injuries by the assault force medic (AF) medic and a casualty evacuation (CASEVAC) helicopter must get the patient to a surgical team to avert the determinative risk associated with the injuries. This sequence of events requires multiple decisions by multiple decision makers. For optimal medical care to occur in the risk-context, the ground force commander (GFC) must make decisions about the ongoing operation-continue the tactical initiative and complete the objective then focus on the casualty or break contact now and focus on the casualty? The GFC's decision will be affected by the status of the casualty in relation to multiple other risks, including the risks of failing to accomplish the objective, in the risk-context. The GFC's decision will, in turn, affect the CASEVAC pilots' decision making-should they launch to the objective now and loiter in the air near the objective awaiting a call to land and pick up the casualty or should they stay on the ground at their current location until a decision is made by the GFC? If they launch now it will shorten the time it takes the patient to get to surgery but may constrain them if they don't have enough fuel to air loiter for a sufficient period and ultimately extend the time to surgery. Decisions by each/any of the medic, GFC, and pilots will all affect the others' decision making. These individual and collective decisions will, in turn, affect the decision making of the receiving surgical team. An optimal outcome to this problem-set requires a shared mental model of the problem-set by each of the decision makers and the ability for each decision maker to have the information they require to make their respective decisions. The PreDICT system provides the capability for each decision maker in this (and analogous) problem-sets to understand the problem-set in real time to gain a shared mental model and the capability to selectively feed each decision maker with the information and recommendations most critical to their respective decision making sphere. This capability also saves time and cognitive and technical bandwidth by automatically communicating information that otherwise or traditionally needs to be shared via deliberate action, such as through a radio call or typing into a device. Users can determine what decision makers will have access to the capability and, in turn, shared mental model and/or information and recommendations. Furthermore, in this or similar medical examples (or in other examples where documentation is critical), the PreDICT system can generate a medical record of injuries, vital signs, treatments, etc. extracted from video, voice, and other sensor inputs that can be viewed in multiple formats, printed to hardcopy, sent electronically, and/or uploaded to a medical records system to follow the patient through their course of care all the way back to the United States. In the scenario above, the PreDICT system could be employed on/by/through multiple platforms, or combinations of platforms, such as personnel carried smartphone type devices and/or on overhead manned or unmanned aerial platforms with relevant sensors.
Population Health Surveillance:
   COVID-19 has revealed the challenges of conducting widespread population health surveillance to include accurately identifying those at risk for the disease and those at risk for decompensation who have the disease.
   For COVID-19 and similar current or future health problem-sets, the PreDICT system provides a capability for widespread, non-/minimal contact population health surveillance to identify at risk or infected patients, to include capabilities for contact tracing, and a capability to predict patient outcomes and/or assist with determining the prognosis of patients who have the disease of interest.
   The non-/minimal contact capability also provides a significant measure of safety to medical and non-medical personnel who would otherwise be required to come into close contact with patients/persons at risk of spreading the pathogen.
   In addition to decreasing medical risk and direct associated medical costs, it also provides cost benefit in multiple other ways. For example, the non-/minimal contact vital signs capability decreases contact between medical personnel and infected or potentially patients which, in turn, decreases personal protective equipment (PPE) requirements and associated costs. Because the PreDICT system can rapidly assess multiple patients to perform triage and/or diagnosis, it can decrease “bottlenecks” at triage and enhance the efficiency of emergency departments. This allows the patients with the highest medical needs, including those who do not have COVID-19 (or a similar pathogen), to receive needed care in a timelier manner. By creating these efficiencies in triage, the PreDICT system can also free up healthcare personnel otherwise dedicated to perform triage to perform other critical medical tasks.
   Benefits to managing a pandemic: “Social distancing”, “Lockdowns” and other “restrictions” have been implemented as means to control the spread, and subsequent related morbidity and mortality, of COVID-19. These measures each have social, economic, political, and other tradeoffs. The PreDICT system provides a mechanism to rapidly determine an individual's risk of having the infection through physiologic screening, location data, and other data inputs and/or the ability to specifically diagnosis infection through additional sensor inputs. Furthermore, this mechanism could be widely distributed and employed through platforms such as smartphones, existing video surveillance networks, sensor equipped kiosks, and/or other data collection platforms. This empowers individuals, schools, businesses, etc. to conduct screening at the individual, family, acquaintance, pupil, patron, employee, etc. level and, in turn, use privacy controls to aggregate data for (near) real-time population disease surveillance. A higher level of “diagnostic certainty” regarding the state of COVID-19, or similar pathogen, allows decision makers to apply more targeted use of control measures such as “lockdowns” and, consequently, lowers the economic, social, political, and other risks associated with these measures.
   Furthermore, the PreDICT system can utilize other data sources and inputs to determine the risks and tradeoffs of infection control measures (such as “lockdowns”) relative to the risk of COVID-19 death and disability and make recommendations to decision makers regarding the risk-benefit of these infection control measures, to include secondary effects such as the probability of increased death and disability due to depression and suicide, child abuse, etc.
Medical Intelligence:
   Determine health status of individual(s) based on (any) video/audio data:
      Casualties or potential casualties at an incident site (such as from drone footage)
      Adversaries, enemies, competitors, etc.
      Hostages, POWs, etc.
Human Intentionality: By measuring physiologic parameters, voice, motion, etc., this invention could determine or elucidate human intentionality or truthfulness in multiple circumstances
   Negotiations or gambling
   Interrogation: This capability could be used to support “tactical questioning” in military operations and/or could be used to augment or replace existing polygraph techniques.
   Determine “suspicious” activity or intent, either through real-time monitoring (such as through an airport or sensitive site video surveillance system) or at a later time by applying the PreDICT capability to previously captured video, audio, or other data.
   (Potentially) Hostile confrontations such as those encountered by law enforcement or military (i.e. Does this person have hostile intent? Is this person a combatant? Is this person about to shoot me?) to de-escalate, escalate, and/or improve target discrimination
   By extension, this capability could be used in autonomous or semi-autonomous weapons systems
   An example to illustrate some of the capability described above would be the use of PreDICT technology in a weapon optic that assisted the user of the weapon to rapidly and accurately discriminate hostile from non-hostile and legitimate from non-legitimate targets. Consider the case of a SWAT Team or military element clearing a complex structure, such as a multi-story, multi-room building, containing multiple combatants and non-combatants. The rules of engagement (ROE) may stipulate that lethal force is authorized against any military age male (MAM) demonstrating hostile intent. Hostile intent may be obvious such as if an individual is pointing a weapon at you. However, it may also include certain actions and postures (termed “presentations”) that are generally understood to mean that an individual is reaching for a weapon, about to initiate an explosive device such as a suicide vest, or about to undertake some other high-threat defensive or offensive action. The individuals clearing the building must make decisions about the use of lethal force in a decision space that is often less than a second. First, they must determine if an individual is a MAM. Secondly, they must determine if the MAM demonstrates hostile intent. The consequences of misjudging a potential target could mean that either a non-legitimate target is engaged and killed or that a member of the SWAT/military element is engaged and killed because they did not accurately identify the target and/or their decision-action cycle was outpaced by the enemy's decision-action cycle. It is also important to understand that clearing a structure (Close Quarters Battle (CQB)) is highly stressful and, consequently, higher order decision making functions are suboptimal, which further challenges target discrimination. Factors such as low light, high noise levels, lack of familiarity with local norms of male and female dress may make it difficult to distinguish between men, women, and children. Once a MAM is identified, it will take some period of time to determine if that individual is demonstrating hostile intent. An adversary's hostile presentation must be fairly far along for a human being to perceive it. By the time the hostile intent is recognized it may be too late to react before the adversary can initiate their own hostile action. PreDICT capability could be embedded as part of a weapon's optic system to rapidly identify legitimate and hostile targets and either alert the individual employing the weapon or, under certain parameters, automatically discharge the weapons against the threat. Alternatively, the PreDICT system could be employed apart from the weapons system but with the same practical functionality. PreDICT could also be employed as a decision-making capability for autonomous or semi-autonomous weapons systems. The fundamental concept is that by identifying patterns and indicators that are below or outside of human sensory and/or cognitive capabilities, PreDICT can markedly improve both the speed and accuracy of the decision-action cycle leading to enhanced target discrimination and, if warranted, neutralization.
Human and Environment Identification/Discrimination: The PreDICT capability could be used to identify individuals or discriminate between individuals based on movement/motion characteristics (video and/or gyroscopic), and/or Audio characteristics, and/or physiologic profile characteristics and/or other data inputs to derive a unique “fingerprint” for individuals or sub-groups of individuals, such as to identify those with risk characteristics for certain disease states, as a security mechanism for accessing computer systems, etc. These data streams could also be applied to environments and/or scenarios to derive environmental and/or scenario specific “fingerprints” and signatures.
Medical Monitoring: The PreDICT system can be used for the longitudinal monitoring of chronic medical conditions to 1) improve treatment and maintenance of the condition, 2) individualize treatment and maintenance of the condition, and 3) anticipate and/or diagnose when a chronic medical condition transitions to a TCCI. Representative examples include cardiac monitoring and glucose monitoring for diabetics.
   Cardiac Monitoring: Non/Minimal contact continuous or periodic monitoring to ascertain cardiac rate, rhythm, and/or cardiac output to identify potential or actual cardiac emergencies and/or recommend individually targeted medication, dietary, activity, and lifestyle modifications to optimize cardiac function.
   Glucose Monitoring: Non/Minimal contact continuous or periodic monitoring to ascertain blood glucose levels for diabetes and other conditions. This capability may be integrated with existing continuous glucose monitoring (CGM) systems such as utilizing existing CGM sensors, transmitters, and receivers or it may function through a different mechanism using data streams and processing techniques otherwise described for the PreDICT system. This capability can identify potential or actual hypoglycemic or hyperglycemic emergencies and/or recommend individually targeted medication, dietary, activity, and lifestyle modifications to optimize blood glucose levels.
Medical/Situational Monitoring: Used as a safety and/or early warning feature in multiple settings such as—
   Baby monitors or other patient monitors to look for indicators of distress
   Lock-out device for vehicles if driver is intoxicated, sleep deprived, or otherwise impaired
   Automatically slow and break a vehicle or switch an aircraft to autopilot if the operator becomes impaired or incapacitated
   Autopilot takeover when mental bandwidth is overloaded relative to the task or the environment. For example, when a pilot is performing the dangerous task of landing a jet aircraft on an aircraft carrier at night, their mental bandwidth is dedicated to the task at the possible expense of missing other threats in their environment, including the possible threat that they will not safely perform the landing. The PreDICT system can utilize sensors to monitor both physiologic parameters of the pilot (reflective of cognitive state) and threats in the environment (to include high-risk failure of the intended task) and initiate autopilot or other safety controls. This scenario is used as just one illustration. There are multiple domains where this type of safety control could be employed.
Human Performance Evaluation, Discrimination, and Training: ThePreDICT capability could be used to evaluate human performance across different domains, discriminate actual performance or performance potential between individuals or groups of individuals, and as a tool to improve to performance of individuals or groups of individuals through training feedback. For example, the National Football League (NFL) runs the annual NFL scouting combine (“the combine”) to determine potential NFL prospects. During this event, participants undergo mental and physical tests to determine their potential for success in the NFL. The PreDICT capability could collect and use data from NFL prospects attending the combine (including their performance in the combine and other metrics apart from the combine) and performance data on prospects who make it to the NFL to derive predictive models to determine both success in the combine and success in the NFL. The PreDICT capability could then be applied to prospects prior to or apart from the combine to determine the potential for success in the NFL. This capability would have broad application across domains assessing human performance potential and suitability to include, but not limited to, sports, military, law enforcement, intelligence, aviation, music, etc. Furthermore, it would provide an additional mechanism for discriminating between candidates when multiple candidates are assessing for limited positions. By extension, the PreDICT capability could be used to identify physical, behavioral, or other performance characteristics requiring improvement towards a specific goal. Thus, the capability can be used as a training adjunct for performance improvement. By extension, this capability could also be used to evaluate, discriminate between, and improve the performance of teams or groups of individuals across different domains.
DRONE USE CASES:
   As described elsewhere in this document, a key conceptual underpinning of the PreDICT system is to optimize the response to time constrained problem-sets by 1) increasing the speed and/or accuracy of diagnosis and/or 2) the efficiency of the intervention to resolve the problem-set, by mitigating or averting the underlying risk and/or 3) minimizing the risk associated with diagnostic and/or therapeutic interventions. This concept applies to both medical and non-medical problem-sets.
   Drones, which may include autonomous and/or remotely piloted aerial, ground, or maritime vehicles or devices, enable each of the factors enumerated above.
   The PreDICT system will be integrated with drones for multiple use cases where the drone will serve as a sensor platform and/or intervention platform and where PreDICT will serve as a capability to augment human or autonomous applications of the drone or will serve as the primary decision-making architecture for the drone.
Augmented Human Critical Decision Making Across Multiple Domains:
   Critical decision making, time-constrained expected value optimal stopping problems, and risk-context have been described as part of understanding PreDICT capability. These concepts and models are inherent to both the concept and functional capability of the PreDICT system as the system collects, processes, and analyzes manifestations of these concepts and models in the real world.
   Multiple domains in the human-physical world manifest and require critical decision making in a model similar to that described as time-constrained expected value optimal stopping problems nested in a risk-context to present a problem-set.
   We have primarily focused on decisions in the domain of medicine and human physiology and/or physical states. However, other examples include (but are not limited to): financial, political, social, military, and other domains as well as decisions bridging many domains. The PreDICT system can be applied to problem-sets in any of these domains.
   Below is a use case of the PreDICT system being applied in a non-medical, non-human physiologic domain.
   Consider the case of a hurricane in the mid-Atlantic Ocean heading towards the east coast of the United States from the perspective of the mayor of Charleston, South Carolina as a decision maker. Somewhere in the possibility-set is the scenario where that hurricane makes landfall directly at Charleston as a category 5 storm. In the event that this contingency materializes the mayor wants to ensure that the city has been completely evacuated and appropriately secured prior to the hurricane's arrival. But, also in the possibility-set is the scenario where the hurricane has no effect on Charleston at all. Evacuating the city is a costly decision but not evacuating is also a (potentially more) costly decision. Here, cost can be measured in multiple ways-human health and safety, economic, political, social, etc. All of these costs are risk-variables in the decision and help shape the risk-context and, in turn, the problem-set facing the mayor.
   Another consideration is that evacuating and securing the city will take time. If the mayor desires (or requires) a high level of diagnostic certainty regarding where the hurricane will make landfall and its strength when it makes landfall then, by that point, it may be too late to evacuate the city. It is likely that the mayor will have to accept an intermediate or low degree of diagnostic certainty to make a decision.
   Furthermore, the lens through which the mayor considers and processes objective information is influenced by emotion and biases. For example, the mayor will likely view the decision differently a month after Hurricane Katrina than 20 years after hurricane Katrina (assuming that similarly cataclysmic hurricane events don't occur in the interim).
   The PreDICT capability provides an augmented intelligence capability to assist decision makers with this type of decision, which fits the model of a time-constrained, expected value, optimal stopping problem with a determinative risk (the hurricane) in a risk-context resulting in a problem-set.
   In this and similar problem-sets, the PreDICT system can employ sensors to understand and advise the decision maker on their own physiologic state and, in turn, their emotional state and decision-making capacity.
   It can also ingest and employ multiple data sets, such as contemporaneous hurricane models, historical data on hurricanes and hurricane responses, traffic data and transportation data relevant to evacuating the city, and data derived from “expert games,” etc. to model contingencies and make recommendations to decision makers.

Much of the discussion above has focused on particular applications of the invention in relation to certain emergency environments. However, as previously noted, the invention has broader applicability. This section describes and elaborates on fundamental aspects of the PreDICT system which, in turn, demonstrate how it might be applied across multiple and diverse use cases.

### Key Points

This section presents a model of Time-Constrained, Expected Value, Optimal Stopping Problems. This model demonstrates a type of problem for which the PreDICT system has utility as an augmented intelligence capability. It also demonstrates a conceptual model of PreDICT functionality and one mechanism by which the PreDICT system “thinks” about these problems as a machine learning and artificial intelligence application.
The PreDICT system enhances the resolution of both time-constrained and non-time-constrained problem-sets in essentially the same manner, by using multiple sensor and data inputs to determine diagnostic patterns and indicators that are below or outside human sensory and cognitive thresholds. It then evaluates the underlying risk and the risk-context to recommend optimal interventions and the logistics and sequencing of those intervention. The fact that it does all of this at machine speeds, markedly faster than humans are capable of, is where it provides benefit for time-constrained problem-sets. It provides decision makers with a more accurate picture of the problem-set more quickly and recommends (or implements) the most time and risk efficient solutions.
The discussion elaborates on and defines the idea of “time-constraint.”
The discussion examines different functional relationships regarding the PreDICT system as a device embedded capability versus a network/cloud enabled capability versus a hybrid.

### Critical Decision Making (CDM)

Among its attributes and capabilities, the PreDICT system is a constellation of processes, methodologies, devices, systems and technologies to improve and/or augment and/or replace human critical decision making (CDM). Critical decision making is defined as having some or all of the following characteristics: 1) It is consequential by some objective or subjective definition, 2) It is time constrained by some absolute or relative criteria, 3) The decision(s) are made with some degree of uncertainty as to specifics of the underlying and enveloping problem-set (the determinative risk and/or risk-context) and as to the outcome of the problem-set with or without interventions to change the course of the problem-set (mitigate or avert the underlying determinative risk), and 4) The decision is made according to a framework that can be articulated, refuted, defended, and that is capable of reaching different conclusions as underlying risk-variables (and risk-context) change. Such a framework can also be viewed as the framework that defines the problem-set under consideration. Critical decision making is generally applied to time-constrained problem-sets. Risk, for the purposes of this discussion, is defined as the probability of an undesirable outcome-“consequential.” Risk can manifest in multiple forms-harm, loss, uncertainty, etc.

This section examines a conceptual graphical and quantitative model of time-constrained problem-sets, examines how PreDICT capability can enhance outcomes for such problem-sets, examines the concept of “risk-context” and how the PreDICT system can enhance contextual CDM, and examines the concept of “time-constrained” as it applies to time constrained problem-sets.

Time-Constrained Problem-Sets as “Time-Constrained, Expected Value, Optimal Stopping Problems”

### The Basic Construct of Time-Constrained Problem-Sets: Equations 1 and 2

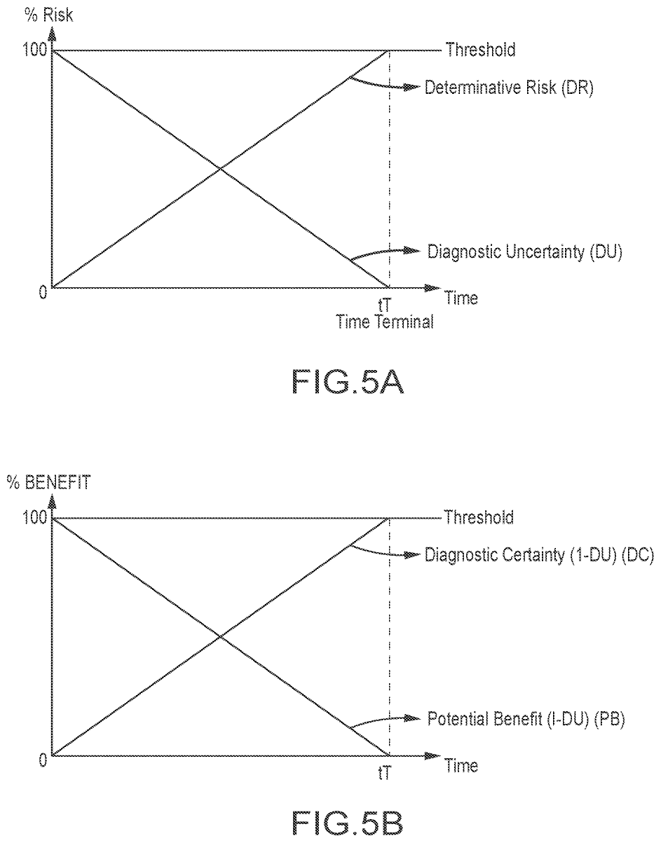

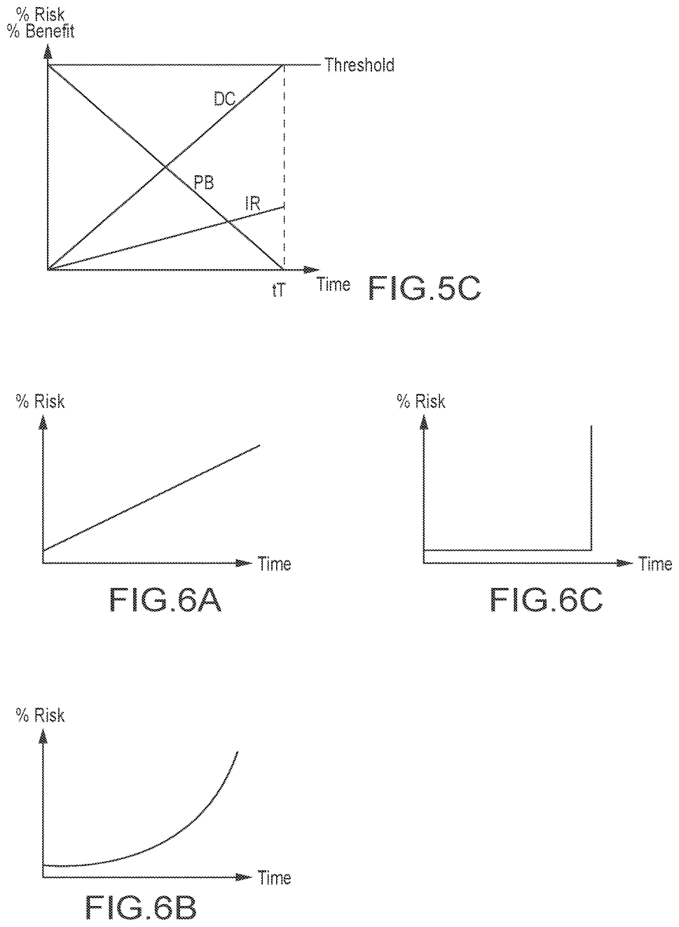

CDM and time-constrained problem-sets have a fundamental underlying characteristic: the underlying risk (the “determinative risk” (DR)) increases with time while the level of diagnostic uncertainty about the existence, nature, scope, specifics, etc. of the underlying risk decrease with time (see FIG. 5A) Thus, the underlying risk increases with time while the risk of diagnostic uncertainty decreases with time. We can also take the mathematical complement (1-risk) of the determinative risk and the risk of diagnostic uncertainty and say that potential benefit, or the ability to realize benefit in light of the underlying problem, decreases with time while the benefit of diagnostic certainty regarding the underlying problem increases with time (see FIG. 5B). The complement of DR (1-DR) is potential benefit (PB). The complement of DU (1-DU) is diagnostic certainty (DC).

The determinative risk (DR) is the underlying risk that effectively precipitates or defines a problem-set. It is typically non-self-limiting, meaning that it will not resolve in a favorable outcome without intervention to mitigate or avert it. Of note, it may not be the risk or the outcome that a decision maker is primarily concerned with within a problem-set but, nonetheless, it is the risk that significantly defines and/or circumscribes the problem-set. Most commonly, the DR does this by setting a time-constraint and, thereby, creates a problem-set where one may not have otherwise existed or places a new or additional constraint on an existing problem-set. Another way DR creates or contributes to a problem-set is by creating uncertainty or adding to uncertainty. Furthermore, a DR can define a problem-set without actually existing or being present. In order to affect or define a problem-set, the DR, from the perspective or assessment of a decision maker, must exist in a possibility-set and rise to some level of probability. So, even if another, and less consequential risk, is actually present the DR will define the problem-set until such time as the decision maker reaches a threshold of diagnostic certainty and determines the DR does not reach a sufficient level of probability for continued consideration. For understanding the conceptual model below, we will primarily consider the case where the DR does exist and a decision maker is focused on the DR.

In the case of DR establishing a time-constraint, the DR will increase with time or at some point in time until the DR exceeds some threshold within the problem-set and a (usually negative) outcome is realized. The time that this occurs is the time terminal (tT). The time terminal sets the time-constraint for the problem-set and, once it is reached, there is no possibility of realizing a beneficial or different outcome in the problem-set. Importantly, while DR may circumscribe a time constraint it is not always apparent to critical decision makers precisely what the time constraint is or that it exists at all. Time terminal (tT) is also the only point in the problem-set at which diagnostic uncertainty (DU) can be zero or, stated as a complement, diagnostic certainty (1-DU) can be 100%. (see FIGS. 5A and 5B).

Critical decision-making is fundamentally about finding the optimal, ideally maximum, benefit value within the problem-set depicted in FIG. 5B. The mathematical relationship between increasing diagnostic certainty (DC) and decreasing potential benefit (PB) is defined by the function:

$$RB ( t ) = D C ( t ) \times PB ( t ) \qquad Equation 1$$

Where RB is relative benefit. “Benefit” because in CDM we generally seek at least a beneficial solution (though we prefer optimal) and “relative” because benefit is not absolute and what constitutes benefit is in part relative to the alternative outcomes and the interventional risk applied and/or taken to achieve that benefit. Optimizing equation 1 will yield the highest possible RB for this representative problem-set.

There is, however, another key risk-variable in determining RB; interventional risk (IR). To realize RB in a problem-set will require interventions to either increase certainty (diagnostic interventions) and/or to mitigate or avert the determinative risk (therapeutic interventions). These interventions will carry some degree of risk in some form. In the case of a time-constrained medical problem-set both diagnostic and therapeutic intervention will frequently carry risk in the form of direct risk of morbidity or mortality, either in the present or future. In addition, interventions, particularly diagnostic interventions, will carry risk in the form of time. It takes time to perform diagnostic intervention and it takes time to gain results from a diagnostic intervention. This elapsed time comes at the cost of increasing determinative risk (DR) or, stated differently, decreasing potential benefit (PB), while the diagnostic intervention is performed and resulted. A final consideration is that interventional risk often increases with time. Two reasons for this are: 1) because, as the determinative risk increases with time, a greater degree of intervention or a higher risk intervention is required to mitigate or avert the underlying risk and achieve relative benefit (see FIG. 5C), and 2) as time elapses in problem-set without the determinative risk being mitigated or averted, the “risk-density” of the problem-set increases—there is less time to achieve diagnostic certainty and/or optimally intervene. This increases the likelihood of applying an in extremis intervention—an intervention that is suboptimal (higher inherent risk and/or less likely to successfully mitigate or avert the determinative risk).

Accounting for IR, the problem-set is now defined by the function:

$$RB ( t ) = [ D C ( t ) \times PB ( t ) ] - I R ( t ) \qquad Equation 2$$

Note, this is essentially an expected value equation as a function of time. Solving a time-constrained problem-set (a time-constrained, expected value, optimal stopping problem) can thus be viewed as trying to optimize expected value by determining the specific point in time with the optimal balance of potential benefit, diagnostic certainty, and interventional risk required to mitigate or avert the determinative risk within a bounded period of time. The requirement for a decision maker to find “the specific point in time,” and the inability to go back in time, create an optimal stopping problem. Furthermore, as the prevailing risk-context changes, it may alter the specific point in time at which the PB, DC, and IR risk-variables are optimally balanced to maximize RB. A function of the PreDICT system is solving problem-sets of the general model presented above. The PreDICT system accomplishes this by acquiring, processing, and analyzing more and different data than human beings are capable of, at machine speeds, in order to find diagnostic indicators and patterns that are below or outside the threshold of human sensory and cognitive capabilities. The PreDICT system uses this information to determine the most risk and time efficient intervention for the DR in the prevailing risk-context. Additionally, the PreDICT system will be able to derive a higher level of diagnostic certainty through non- and minimally-invasive techniques, which will serve to decrease the diagnostic interventional risk (IR) required at a given point in time to attain a given level of diagnostic certainty.

### Determinative Risk (Potential Benefit) Curves

The initial challenge of CDM is recognizing that there is a critical situation and thus critical decision to be made. The model presented above demonstrates one, of perhaps many, pathways in a possibility and probability-set (problem-sets within a possibility and probability-set). For example, just because a patient has a penetrating chest wound does not mean they have a time-constrained critical injury. They may only have a superficial wound. However, the presence of the chest wound constrains the possibility-set; it places the presence of a life-threatening or other serious injury well within the realm of possibility. Other factors, indicators, and interventions will elucidate the actual probability. This constraining of the possibility set then presents the patient and, in turn, the critical decision makers charged with his or her care, with a set of determinative risk (DR) curves, each one representing the probabilities of various terminal outcomes (loss of life, chronic disability, etc.) as a function of time. Critical decision makers may (consciously or unconsciously) choose to focus on one or multiple of the DR curves, either in parallel or in serial. Levels of diagnostic certainty regarding any one DR curve may inform the level of diagnostic certainty regarding other DR curves in the problem-set. Furthermore, DR curves may take different forms all for different possibilities within the same problem-set. FIGS. 6A-6C demonstrate several representative DR curves, though these figures are by no means representative of all possible DR curves. Each type of curve has different challenges and complexities from the standpoint of solving a time-constrained, expected value, optimal stopping problem. This is important because it illustrates the complexity of the types of problems the PreDICT system has utility in solving and optimizing. For any possibility-set, there are multiple branches with different levels of probability that are often in dynamic interplay. The Hick-Hyman Law (also known as Hick's Law) describes an increase in the time required for a human to make a decision as the number of options in a decision set increase, essentially as the degrees of freedom and, in turn, the complexity of the decision increase. The PreDICT system will utilize more and different data than human beings and perform powerful processing and analytics at machine speeds which will potentiate better optimization of such complex problem-sets as measured by both the accuracy of solutions and the timeliness of the solutions.

A characteristic shared by each of the DR curves is that risk and/or risk-density increases with time. Essentially, for the problem-sets we are discussing, risk equals time and vice versa. Another way to state this is that, in each case, the probability of realizing the terminal outcome is generally more likely to occur at some time (t+x) than it is at time t, where (t+x)>t and t and x are positive numbers. The concept of risk increasing with time is relatively straightforward. The concept of risk-density is more involved. We will consider two examples to examine these concepts and reference the corresponding figures.

In example 1, consider a gunshot wound (GSW) to the abdomen that results in internal hemorrhage that over time progresses to hemorrhagic shock, increasing physiologic dysfunction, and, ultimately, death (the terminal risk in this example). The DR curve in this example generally corresponds to FIG. 6B. The underlying risk is progressing with time and the probability of realizing the terminal outcome (death) if appropriate intervention (to mitigate or avert the underlying risk, hemorrhage) is taken at time t is less than if appropriate intervention is taken at time (t+x), when the patient is experiencing more physiologic dysfunction. Stated differently, the patient has a higher probability of benefit (surviving) if intervention is accomplished at time t than at time (t+x).

In example 2, consider a single engine aircraft that experiences an engine malfunction at 30,000 ft above ground level (AGL). The aircraft is on a glidepath toward the earth and a fatal impact, the terminal outcome. The DR curve in this example generally corresponds to FIG. 6C. The time until impact is t30 at 30,000 ft and t5 and 5000 ft. t30>t5. The engine failure is not fundamentally worse at 5000 ft than it is at 30,000 ft. If the engine can be successfully restarted the probability of a positive outcome (avoiding a fatal impact and successfully landing the aircraft back at the airport) is the same. However, the risk-density of time is much greater at 5000 ft than at 30,000 ft. Some amount of time is required to 1) recognize that there is a problem, 2) diagnosis the problem, 3) determine what action to take, 4) successfully intervene on the problem, and 5) for that intervention to have the desired effect. Collectively, the time required for all of these to elapse/be accomplished is the “time of operational risk” (tOR). Theoretically, tOR is the same at 30,000 ft as it is at 5000 ft. However, because t30>t5 the risk density of time is greater at 5000 ft than it is at 30,000 ft; (tOR/t5)> (tOR/t30). Basically, what this means is that, for time constrained problem-sets, as time elapses there is less time to identify and diagnose the problem, determine the appropriate intervention, perform that intervention, and for the intervention to take effect. If the time remaining until the terminal outcome is less than the time of operational risk then the terminal outcome is effectively unavoidable even if it has not yet been realized. Using this example, if tOR>/=t5 then, at 5000 ft, the engine cannot be restarted in a sufficiently short period of time to avoid fatal impact. Note, this same concept of the “risk density of time” and tOR also applies to the GSW in example 1. The PredDICT system decreases the time of operational risk (tOR) and decreases the risk of interventions (IR) required to diagnose and, potentially, to solve the problem.

### Mitigating and Averting Determinative Risk

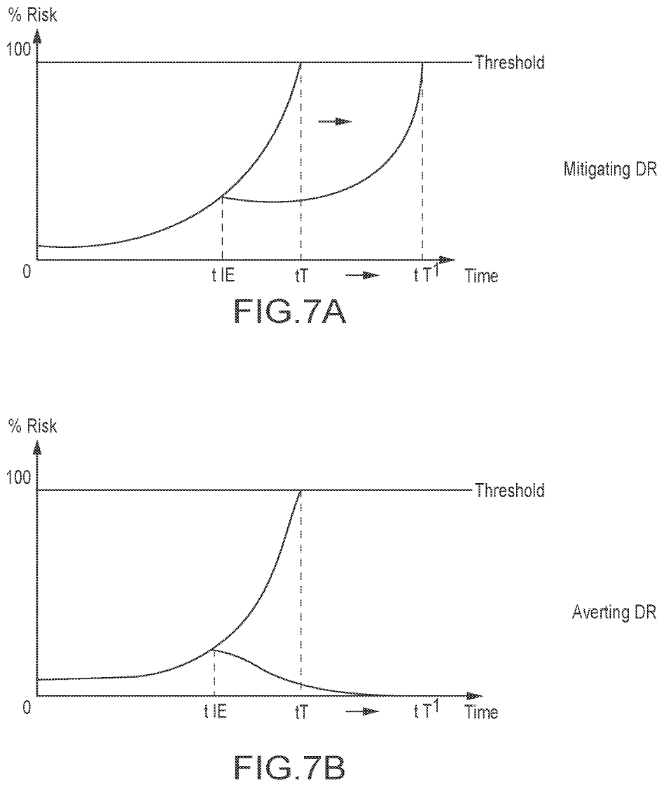

The sections above discussed “solving” time-constrained problem-sets (time-constrained, expected value, optimal stopping problems). What does it mean to solve them? What does a solution look like? Solutions to these problems entail mitigating and/or averting the determinative risk. Mitigating DR results when the DR, and resultant terminal outcome and time terminal (tT), is pushed further into the future. This establishes a new DR curve and a new time terminal (tT′) (see FIG. 7A). It can be thought of as “temporizing the problem” (or transitioning one problem into another, ideally, lower risk problem) and allowing more time for critical decision makers to maximize diagnostic certainty, determine optimal interventions, and apply those interventions and for the interventions to take effect to either further mitigate the problem-set or to avert it completely. Stated differently, it allows for a longer tOR and/or it decreases the risk-density of time. Averting DR results when, through intervention, the subject of the DR (patient, system, issue, etc.) are “offloaded” from the DR curve to a new curve that returns them to their original, or a new, baseline risk curve that is not time constrained and establishes a time of resolution (tR) (See FIG. 7B) FIGS. 7A-7B show representative examples of mitigating and averting risk using the DR curve from FIG. 6B. Time of intervention efficacy is denoted “tIE.” Frequently, time-constrained problem-sets are approached by first applying a mitigating intervention (“buying time”), such as with a tourniquet to temporize extremity hemorrhage, followed by a definitive intervention to avert the determinative risk, such as a vascular surgery procedure to repair the injured blood vessel. The definitive intervention(s) “offloads” the patient from the new DR curve that results from the mitigating intervention and returns risk to some new or original baseline.

### Operational Risk: Equations 3, 4, and 5

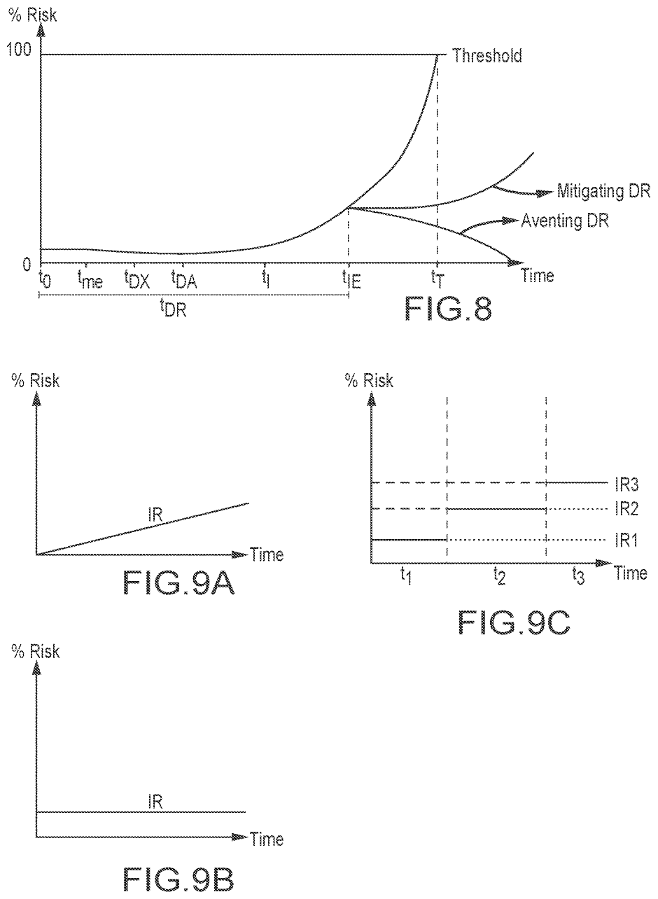

Operational risk (OR) is the time required, form the onset of a determinative risk (t0), to effectively mitigate or avert a determinative risk (DR). Operational risk (and the time of operational risk (tOR)) is comprised of multiple components and actions (see FIG. 8): 1) recognition that there is a potential or existing determinative risk (DR) and a problem-set, 2) diagnosis of the determinative risk (DR), 3) decision to act, what intervention to perform, and how to perform it, 4) performing the action/intervention, and 5) time for the intervention to reach efficacy. These components and actions are defined as follows:
1. Recognition that there is a potential or existing DR and problem-set: Time to meaningful contact (tMC). This is the point at which a critical decision maker is in contact with or engaged by a DR or problem-set to at least recognize that they exist and to form initial impressions as to the source, nature, and scope of the problem. Note, the tMC may, and frequently will, occur after some relative delay from the onset of the DR and problem-set.
2. Diagnosis of the DR: Time to diagnosis (tDx). The culmination of this period is the point at which a critical decision maker has reached a sufficient diagnostic threshold (has a sufficient understanding of the DR and/or problem-set) to consider moving forward with an action or intervention. Time to diagnosis is the period during which a critical decision maker is gaining certainty about the underlying determinative risk (DR). Note, an intervention might be a deliberate act of “doing something” (commission) or a deliberate act of “not doing something” (omission). Also, the action and/or intervention following from achieving a diagnostic certainty threshold may be intended to mitigate or avert the DR (ie. Therapeutic intervention) or to achieve a higher level of diagnostic certainty (ie. Diagnostic intervention). If it is a diagnostic intervention, the time to perform and result that intervention will extend the time of tDx.
3. Decision to act, what intervention to perform, and how to perform it: Time to decision to act (tDA). tDx is the period during which a decision maker gains certainty about the underlying determinative risk. tDA is the period during which they decide what action and/or intervention to take and the logistics and sequencing of that action/intervention for the determinative risk in the existing risk-context. Ideally, a diagnostic certainty threshold should (near) immediately precipitate a decision to act and action. However, there are multiple reasons why this might not occur, such as the baseline or contextual expertise of decision makers is such that they do not initially recognize that a diagnostic certainty threshold has been reached, a lack of knowledge or skills to take action, or personal attributes such as individual “risk tolerance.” At any rate, some period is required following attaining a threshold of diagnostic certainty and the formulation of a plan of action and the implementation of that action. It is important to stress that tDA is not simply a decision regarding what action/intervention to take. It also a decision about how to take that action/intervention-Who should perform it? When? Where? What sequencing and logistics are required to optimize the intervention and potentiate success? The answer to these questions depends on the risk-context and the ability of the decision maker to optimally answer these questions depends on their operational expertise in the risk-context. We will discuss this more later.
4. Performing the intervention: Time to intervention (tI). This is the time to complete an intervention. For example, giving a patient a unit of blood is an intervention that begins when the critical decision maker (ie. Doctor, nurse, medic, etc.) determines that giving a unit of blood is the action to initiate. It ends when the last drop of that blood flows into the patient. All of the actions and decisions involved in the process in between—type and screen, getting the blood to the patient, starting an IV, hanging the blood, etc.—are part of that intervention and the time to intervention (tI).

5. Time for the intervention to reach efficacy: Time to intervention efficacy (tIE). This is the period from the completion of the intervention until the intervention achieves the desired effect of mitigating or averting DR. For example, a unit of whole blood given to mitigate hemorrhagic shock is not immediately effective. It must restore blood volume, oxygen carrying capacity, and blood clotting components. This, in turn, restores perfusion to tissues and protects against further blood loss. This allows lactate and other toxic metabolites to be removed from the body and for pH to normalize. At this point, after whatever period of time was required for the above effects to transpire, the patient's physiologic dysfunction has been improved and the DR mitigated.

Time of operational risk (tOR) is defined by the following equation:

$$t O R = t M C + t D x + t D A + t I + t I E \qquad Equation 3$$

Identifying and understanding these components and the breakdown of tOR is critical as we develop our understanding of relative benefit (RB) as a function of time. Equations 1 and 2 do not account for the time distributed nature of decision making, action, and results, which is a reality of time-constrained problem-sets and significantly challenges decision makers. Accounting for this yields a time function of the general form:

$$R B ( t FUTURE ) = [ ( D C ( tNOW ) \times PB ( tFUTURE ) ] - IR ( tNOW ) \qquad Equation 4$$

Considering tOR and its components yields the more specific function:

$$RB ( tOR ) = [ D C ( t DA ) \times PB ( t O R ) ] - I R ( t I ) \qquad Equation 5$$

Time of operational risk (tOR) components, or some of the components, will often be in dynamic interplay. For example, there may be several loops between tDX and tDA before a clear intervention and/or pathway to performing that intervention is identified. The components of tOR can be conceived of as a more comprehensive and detailed OODA (Observe, Orient, Decide, Act) Loop process that is not complete until the “act” is resulted. Furthermore, the components may not be executed stepwise in a linear fashion. There may be overlap and all or some components and sub-components may be occurring in parallel. For example, for a time-constrained medical problem-set, such as a critically injured trauma patient, diagnostic certainty will be ascertained, at least through clinical observation and feedback, throughout the entirety of the patient-physician encounter even after tDX has been accomplished. What ultimately matters is the tOR, the time at which the DR is successfully mitigated or averted. For time-constrained problem-sets, particularly those with exponential DR curves, shortening tOR can significantly diminish the risk of an adverse outcome or, conversely, increase the probability of a positive outcome. The PreDICT system can improve tOR by improving the different components in multiple ways through, for example, increased certainty, decreased time, and decreased interventional risk through improved recommendations on actions and interventions through analysis of process and logistics within the prevailing risk-context. An additional note on equation 5; DC is a function of tDA (DC (tDA)) and not tDx (DC (tDx)) because tDA is the time at which the diagnostic certainty threshold is effectively applied in the problem-set.

### Time-Constrained Problem-Sets: Definitions of “Time-Constraint/Time-Constrained”

The time of operational risk (tOR) is also key to understanding the definition of “time constrained” problem-sets. A time constrained problem-set could be any problem-set that has some pre-defined time at which critical decisions can no longer be made or actions taken to mitigate or avert the determinative risk or, conversely, realize benefit. An example would be a financial option to buy or sell a particular investment. An individual considering purchasing an option, or the holder of an option, must weigh potential benefit (profit), probability of realizing that profit (diagnostic certainty), and the cost of the option (interventional risk) in their decision to purchase or exercise the option. At some predetermined point in time, the option will expire and the ability to purchase or exercise the option will no longer exist. Alternatively, a problem-set could be time-constrained in some absolute term that humans generally agree to be “a short period of time” and, thus represent a time constraint. For example, a problem-set that played out over a single second, minute, hour, or day could be construed as time constrained.

However, what is more important is not the absolute time but rather the amount of time afforded or circumscribed by the determinative risk relative to the time of operational risk—the time required to mitigate or avert the determinative risk (or realize the relative benefit). The greater the ratio of tOR/tT the greater the time constraint or, stated differently, the greater the “risk density” of time or of the problem-set. Importantly, if tOR>/=tT or if tOR/tT>/=1, the determinative risk cannot be mitigated or averted. There is not sufficient time. This would be an impossibly time constrained problem-set that would require a different approach and solution to decrease tOR to less than tT if there was to be any probability of mitigating or averting the determinative risk. Let's examine an example of “time-constraint” through the ratio of tOR/tT. Stage 4 pancreatic cancer has a 5-year survival rate of approximately 3%. For the purposes of illustration, assume 97% of patients diagnosed with stage 4 pancreatic cancer will die exactly 5 years form the date of their diagnosis. Thus, for these patients the time terminal (tT) is 5 years. Also assume that for these patients, their survival beyond 5 years, either by mitigating or averting the stage 4 pancreatic cancer, will require the development of drug X. This means that a significant part of the operational risk for these patients is the development of drug X. And, not only the development of drug X but also clinical trials, FDA approval and/or emergency use authorization, manufacture and distribution, a course of multiple treatments, etc. This is a lot to accomplish in 5 years. The time of operational risk (tOR) will likely be close to if not exceed tT in this case. The point is that, with respect to time-constrained problem-sets, 5 years may not initially appear to be a significant constraint but, when compared to the time required to implement a meaningful intervention and for that intervention to take effect to mitigate or avert the determinative risk, the tOR, 5 years may represent a significant time constraint.

Another important point on the issue of “time constraint,” we often know that a problem-set is time constrained or that it has the potential to be time constrained but the actual (or potential) time constraint is not always transparent to the decision maker. In some cases, decision makers may ultimately realize that there was no time constraint at all. This is an issue of diagnostic certainty involving 1) the correct identification of the problem-set from a given possibility/probability-set and 2) the correct diagnosis of the problem-set once it has been identified. A decision maker may be aware that there are multiple problems in their possibility-set. They may be aware that only one of these problems is time-constrained. However, if the decision maker decides (based on some level of diagnostic certainty and/or their subjective risk tolerance because of the potential or perceived consequence of the problem) that this single time constrained problem warrants due consideration, then the time constraint posed by this one possible (not necessarily probable) problem will constrain the entirety of their decision making. They have a time-constrained problem-set even if, in reality, no time constrained determinative risk exists.

Also important to consider is how the time-constraint imposed by an actual or potential determinative risk may be contextual rather than organic to the determinative risk and how a time-constraint posed by one DR and/or tOR may impose a time constraint on another DR and/or tOR. And, how the decision maker(s) who is/are subject to the time constraint may not be a primary component in the risk-context and problem-set. Consider the case of a U.S. service member with a headache and lightheadedness thirty minutes after being exposed to a close proximity blast from an enemy rocket fired at her base from an enemy convoy in the desert. The patient was in a bunker at the time of the blast and sustained no other injuries and did not lose consciousness. She now presents to the aid-station for evaluation by her unit's physician. After conducting an appropriate assessment, the physician is concerned, but is not certain, that she may have a mild traumatic brain injury (mTBI). This is often a challenging diagnosis to make and frequently requires hours to days of observation and reassessment to make a definitive diagnosis. The diagnosis is further complicated by multiple other stressors in the combat risk-context that can cause headache and lightheadedness-dehydration, inadequate nutrition relative to physical and mental exertion, poor sleep, mental, physical, and emotional stress, etc.

Once the risk of life-threatening intracranial pathology (such as a bleed) has been “ruled out” (reasonably removed from the medical decision maker's possibility/probability-set or differential diagnosis), this is a fairly straightforward medical problem-set characterized by a patient with headaches and lightheadedness that can be treated with low risk interventions. She may have a mTBI or she may just be, for example, dehydrated. The physician has sufficient diagnostic certainty relative to the low risk interventions to proceed with treatment and continue to monitor for mTBI over the next several days. So, the physician observes the patient for an hour while he provides IV hydration, a snack, and Tylenol and then prescribes the patient a period of “brain rest”, the treatment for mTBI. Brain rest essentially consists of lying in a darkened room without stimulation such as physical stimulation, screens, mental exertion, etc. This treatment, while seemingly anodyne, is critical to allow the brain to heal and to avoid long term sequelae of mTBI such as memory loss, personality changes, and other mental and emotional signs and symptoms. The patient is to return to the aid-station in twelve hours for re-evaluation. If, at that time, she demonstrates continued signs and symptoms of mTBI, the physician will recommend evacuation to a higher level of care for ongoing evaluation, treatment, and recovery.

So far, this does not appear to be a particularly challenging problem-set and the determinative risk does not appear to present a significant time-constraint. But, now consider the problem-set from the perspective of a different decision maker, one who is non-medical and not a primary component of the medical problem-set involving the patient. The theater task-force commander must determine the response to the rocket attack. A critical risk-variable in the commander's decision making is whether or not the service member has a mTBI. A mTBI sustained in combat and due to enemy action is recognized as a battle injury and qualifies for a Purple Heart in the same way that the patient in this example would qualify for a Purple Heart if she sustained a life-threatening injury from a piece of shrapnel in the rocket attack. Since the attack, the task force has identified a suspicious convoy in the vicinity of the base that they believe launched the rocket and the commander is considering authorizing a drone strike on the convoy. The convoy is assessed to be traveling towards a city about an hour away but, until that time, will be in “green terrain” (an open, unpopulated area with a low risk of collateral damage from the drone strike). Thus, the commander has one hour to make a decision (tDA) and execute the strike (tI+tIE). One hour from now is effectively the time terminal (tT) in the commander's time-constrained problem-set. Furthermore, the convoy is assessed to be carrying a proxy militia force for a near-peer U.S. adversary with at least two embedded intelligence officers from the intelligence service of the near-peer adversary. Striking the convoy, and particularly killing those intelligence officers, has significant strategic implications, it may precipitate major armed conflict. However, if the strike is justified in the eyes of the international community and according to relevant laws of armed conflict, this consequence is unlikely. Not striking the convoy also has significant implications. Right now, the commander has the opportunity and the tactical initiative to carry out the strike and remove this threat from the battlespace, send a deterrent message to the adversary, and, potentially, conduct a proportionate response under the standing rules of engagement. This could save lives in the future and improve the United States' strategic position in the region. Not striking could embolden the enemy. But, to justify the strike the commander must have some threshold of diagnostic certainty (preferably a definitive diagnosis from a medical professional) that the patient has a mTBI.

Even though the commander is not a primary component of the patient's medical problem-set and even thought the determinative risk in the problem-set (potential mTBI) does not directly prescribe a time-constraint (though the patient, if she has an mTBI, is at increased risk of long term sequelae if brain rest is not implemented to mitigate or avert those risks) the commander is confronted with a time-constrained problem-set that is framed (and constrained) by her mTBI problem-set. The (potential) determinative risk of the mTBI has an associated tDx that, in this risk-context, directly affects the tDx and time of operational risk for the commander's convoy determinative risk problem-set. In this risk-context, the problem-set posed by the patient and her potential mTBI shapes the time-constraint of the commander's problem-set focused on the convoy. From the commander's perspective, the time terminal (tT) is one hour from time now. The commander's time of operational risk consists of:
Time to meaningful contact (tMC): This has been accomplished. The commander understands the nature, scope, and risk-variables of the problem-set.
Time to diagnosis (tDx): The commander has reached a diagnostic certainty threshold on part of the determinative risk (the convoy) but still requires a key piece of information, does the service member have a mTBI. In other words, from the commander's vantage point, the convoy is a determinative risk. If the convoy launched a rocket that resulted in a mTBI to a US service member it is a sufficiently high risk to justify the high-risk intervention of a drone strike under the standing rules of engagement. If it did not cause a mTBI it is not a sufficiently high risk to warrant the high-risk intervention of a drone strike.
Time to decision to act (tDA): This decision has already been made. If mTBI, strike. If no mTBI, no strike.
Time to intervention (tI): This is the time required to launch the drone, for the drone to fly to and acquire the target (the convoy), for the drone to release the munition, and for the munition to impact and destroy the target. Let's assume that this has been accomplished and the convoy is being watched by an armed drone.
Time to intervention efficacy (tIE): Time from munition impact until kinetic effects are realized. This is a very short period.

The rate limiting step is the tDx for mTBI and this time will be greater than one hour. The commander is evaluating a problem-set with a tT of one hour from now. Because tDx factors into the commander's tOR for mitigating or averting the risk posed by the convoy, the tOR will be greater that one hour. Time of operational risk is greater than time terminal. The convoy will reach the city and be out of green terrain, thereby precluding the drone strike, before the commander (or physician or patient) have a sufficient diagnostic certainty threshold to diagnosis mTBI. If the commander did not require that the patient have a definitive mTBI diagnosis to justify and launch the drone strike then the tOR would have been well within the tT of one hour and the convoy would have been effectively neutralized. This hypothetical example was intended to illustrate how problem-sets can overlap and interact in a particular risk-context to impose time-constraints on decision makers that are not obviously organic to the immediate problem-set. If the patient in our example had suffered a possible mTBI playing intramural soccer at college back in the US, her (potential) determinative risk of mTBI would not have these same secondary effects on a non-primary component of her mTBI problem-set. PreDICT will markedly improve the diagnostic efficiency (accuracy and speed of diagnosis) of pathology such as mTBI. Consequently, it has the ability to enhance decision making in the primary problem-set (mTBI) in the example above as well as in the secondary problem-set (convoy drone strike).

The mTBI example above also illustrates another important point about tOR and time constraints, the time to diagnostic certainty threshold (tDx) is influenced by IR. If the IR is low, the diagnostic certainty threshold required to proceed with that intervention is generally low and has a relatively short tDx. If the IR is high, the diagnostic certainty threshold required to proceed with that intervention is generally high and has a relatively long tDx. (This, of course, also depends on where you are in the time sequence of the problem-set, the consequence of the terminal risk/outcome, and the risk-density of time. In a high-risk problem-set with a high risk-density of time, a decision maker may be willing to accept a high-risk intervention with little diagnostic certainty if only because it is the only option available given the apparent time remaining in the problem-set.) From the standpoint of the physician treating the patient, and viewing this as a purely medical problem-set, the IR for mTBI is low (brain rest) so a low level of diagnostic certainty, and correspondingly short tDx, is required to make a decision to act and implement treatment. If the patient is ultimately determined to not have a mTBI, there is no adverse medical consequence to the patient from brain rest. Conversely, if the patient does have an mTBI and does not undergo brain rest early, she is at higher risk of morbidity from the mTBI. (Note: this also serves to illustrate the tIE of brain rest.) Now, from the perspective of the commander authorizing a drone strike, he requires a higher level of diagnostic certainty regarding the same determinative risk precisely because he is weighing a higher risk intervention based on the same determinative risk. And, this higher level of diagnostic certainty requires more time to attain, it has a longer tDx. In summary, the available interventions, and their associated risks, for a given determinative risk, can impose a time constraint by increasing the required diagnostic certainty threshold which, in turn, increases tDX, which, in turn, increases tOR and increases the ratio tOR/tT.

### Interventional Risk

Interventional risk includes the risk of all interventions, for the purpose of increasing certainty (diagnostic interventions) and towards mitigating or averting the determinative risk (therapeutic interventions). As a general rule, critical decision makers do not apply benefit in time-constrained problem-sets. In other words, the interventions are not inherently beneficial unto themselves. They are beneficial by virtue of their potential to yield a relative benefit in the problem-set. Decision makers apply the risk of intervention to the determinative risk and problem-set with the goal of yielding a relative benefit (RB). For example, a computed tomography (CT) scan is not inherently beneficial, it carries risk in the form of potentially cancer-causing radiation, direct economic cost, opportunity costs, etc. However, in the setting (problem-set) of a patient with right lower quadrant abdominal pain concerning for appendicitis, it can increase diagnostic certainty and, in turn, relative benefit to the patient. The diagnostic certainty yielded by the CT scan decreases the probability that an actual appendicitis is misdiagnosed or that a presumed appendicitis (but normal appendix) undergoes an unnecessary surgical procedure (appendectomy).

Interventions generally entail risk in some form or fashion. These may be inherent risks, such as the risk of morbidity and/or mortality inherent in many medical interventions, these risks may involve the probability of the success or failure of the intervention, these risks may be in the form of opportunity cost or monetary costs, or these may be the risks of adding degrees of freedom to an already complex problem-set, such as might occur by using a military intervention to solve a non-military problem-set at the risk of creating multiple additional time-constrained problem-sets. Alternatively or additionally, these interventional risks might manifest or come to bear in any number of ways not enumerated here. Some interventional risk, such as the risk of failure of the intervention to have the desired consequence, is captured by the concept of diagnostic (un) certainty—the level of certainty a decision maker has about underlying determinative risk will affect their ability to match the most risk and efficacy appropriate intervention to the problem-set. Other interventional risk is captured directly by what is termed here as interventional risk (IR).

Interventional risk (IR) is a function of determinative risk (DR) in the sense that DR circumscribes and defines the problem-set and, in turn, generally constrains what interventions could or would be applied. For example, if the determinative risk is pancreatic cancer then options for intervention will generally fall in the realm of medicine and not routinely include the use of military force to mitigate or avert the DR. Applicable interventions based on the DR underlying the problem-set will then have associated interventional risk. However, it is important to understand that interventions and associated interventional risk seemingly unrelated to the DR may be incurred incidentally or collateral to applying an appropriate or optimal intervention. For example, a patient is at hospital A with a severe head injury requiring a neurosurgeon to urgently perform a procedure. The nearest neurosurgeon is at hospital B 100 miles away and the patient must be transported by helicopter. In this example, the interventional risk of the neurosurgical procedure includes the risk of the helicopter transport as it is, effectively, a required part of the neurosurgical procedure. (Of note: it is also part of the time of intervention (tI) and, in turn, the time of operational risk (tOR).) These types of scenarios are common for medical problem-sets in the military combat and other austere risk-contexts.

FIGS. 9A-9C show representative IR curves as functions of time, though they are by no means a compete or exhaustive representation of all possible IR curves. There are several general concepts demonstrated. The first is that the absolute interventional risk will generally not decrease with time (though, the relative risk of intervention(s) may well decrease with time as considered from different perspectives such as, “this is a high-risk intervention but we are moments away from a high consequence outcome and have no other options and little or nothing to lose . . . ” Note: in this example the “relative risk” of intervention will also be modified (decreased) by the (high) level of diagnostic certainty with which it is applied). Interventional risk curves will generally increase with time or remain flat (slope=0) as functions of time (see FIGS. 9A-9B). A patient who is bleeding from an extremity wound and progressing towards hemorrhagic shock and death is an example where the risk of intervention increases with time. In the early stages after the onset of the determinative risk (the bleeding wound) the patient may only require a tourniquet and medications such as tranexamic acid (TXA) to mitigate the DR followed by a procedure to avert it. As the DR progresses the patient will require more interventions, such as blood products, and thus more interventional risk to mitigate and avert the DR. The previous example of the aircraft engine failure might be represented by a flat IR curve (see FIG. 9B)—the engine malfunctioned, the source of that malfunction is stable, there is one possible intervention to fix the malfunction. Note, this does not account for other possible “interventions” available to the pilot and passengers trying to avoid a terminal outcome of a fatal impact, such as parachuting out of the aircraft. The second concept is that interventional risk will often be “quantized;” it will change with time in a “stairstep” fashion (see FIG. 9C) This is because each intervention has some inherent risk associated with it and, as the DR progresses and more interventions are required, the IR at different points or periods in time will be additive (not necessarily in direct proportions (i.e., 2+2 may be less than 4 or it may be greater than 4)), synergistic, and/or multiplicative. Also, just because an interventional risk is not risk-optimal at a given point or period of time in the problem-set does not mean that it cannot be applied. However, the outcome may be that the intervention is effective at mitigating or averting DR but incurs an unnecessarily high degree of interventional risk to accomplish the effective outcome. Alternatively, the interventional risk applied may not be sufficient to effectively mitigate or avert the DR while still incurring risk (without yielding any relative benefit). FIG. 9C depicts three levels of interventional risk (IR1, IR2, and IR3). Solid portions of the IR curves show where the interventional risk is “risk optimal” relative to the DR. Dashed portions of the IR curves show where the interventional risk is effective but unnecessarily high. Dotted portions of the IR curves show where the interventional risk is ineffective and IR is incurred without RB. Also important to consider, the operational risk associated with an intervention (tI, tIE) and where the DR is in its progression are critical considerations in the risk calculus of determining what IR or bundle of IR is most risk appropriate and effective. If an intervention has a relatively long tI and/or tIE, then a decision maker may be required to implement that intervention before it is apparently “risk optimal.” Considering FIG. 9C as an example, if the problem-set is current in the period of time “t2” and IR2 and IR3 each have a combined (tI+tIE)>t2 then the decision maker needs to implement IR3 even though it appears to be an overly high risk intervention for that period in the problem-set. Time constrained problem-sets where the implementation and effects of interventions are separated by significant periods of time (relatively long tI and/or tIE) present significant critical decision-making challenges. The PreDICT system has the capability to match the risk optimal interventions to the specific level of DR at a specific point in time in a given risk-context at machine speeds with a cognitive bandwidth that exceeds human capabilities. Also important to understand is that the PreDICT system not only recommends (or autonomously applies) the risk optimal intervention at the optimal point in time, it also recommends (or performs) the optimal sequencing and logistics to maximize the efficiency, relative to both time and interventional risk, of the intervention.

### Risk of Diagnostic Uncertainty (Benefit of Diagnostic Certainty) Curves

This section discusses the Risk of Diagnostic Uncertainty and the Benefit of Diagnostic Certainty (DC), which is the complement of the risk of diagnostic uncertainty (DU) (DC(t)=1-DU (t)), similar to discussing PB (t) as the complement of DR(t) in a previous section. Diagnostic certainty is the probability that the critical decision maker has identified 1) the correct DR curve (the correct risk within the possibility-set and corresponding terminal risk) and 2) has correctly identified the “shape” of the DR curve or time function describing the DR curve (the risk at the present time, the risk at any future time, and the time terminal and time constraint defined by the DR curve).

At the time of onset of the DR (t0) the corresponding diagnostic certainty (DC) is zero (DU(t0)=100%). Time terminal (tT) and beyond is the only point in the problem-set (and period following) at which DC may be 100% (or DU may be 0%) because at this point the terminal outcome has been realized and, so long as that terminal outcome is completely transparent to the critical decision maker, they then have, or could have through literal or figurative autopsy of the problem-set, 100% certainty as to the determinative risk and its nature and characteristics. Between the onset of the determinative risk (t0) and just until time terminal (tT), diagnostic certainty will be greater than or equal to zero and less than 100% (0</=DC (t0+x to tT-y)<100, where x and y are positive). There are multiple reasons why DC may be at or near zero for a prolonged period throughout a problem-set, such as an insidious DR that does not rise to the level of sensory perception or cognition or, simply, because the critical decision maker(s) are not, for whatever reason, aware of it. Whatever the case, this would manifest as a prolonged time to meaningful contact (tMC) followed by some period of time to diagnostic certainty (tDX) during which decision makers sought to attain a threshold of diagnostic certainty to initiate action.

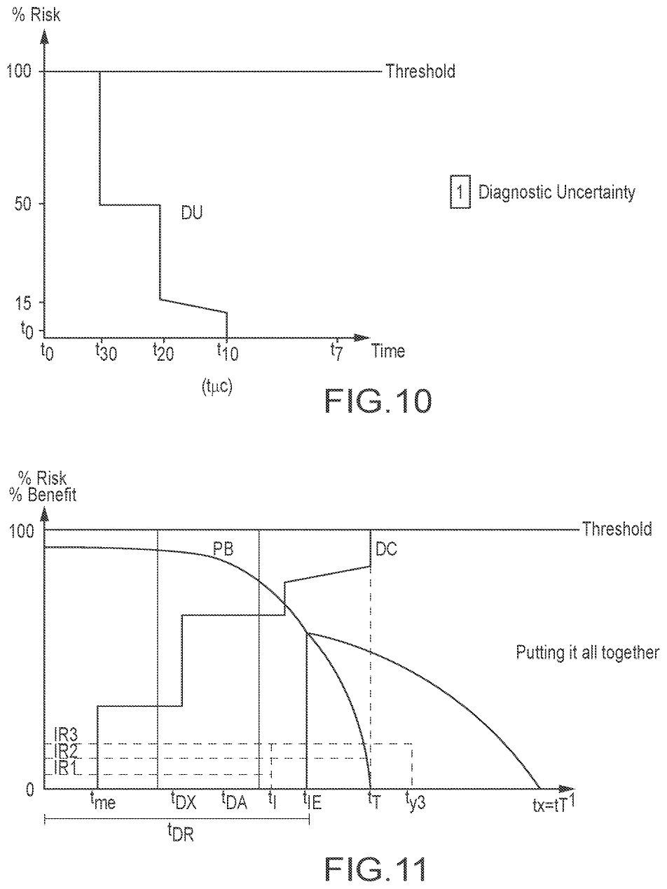

As with other curves and functions that we have discussed, diagnostic uncertainty (DU) functions/curves (and diagnostic certainty (DC) functions/curves) can take multiple forms. FIG. 10 depicts what a simplified diagnostic uncertainty (DU) curve might look like from the perspective of a trauma surgeon at a Level I Trauma Center receiving an injured patient with no notice. At to the patient falls 8 ft off a ladder and lands on his left side/back. At this point in time the trauma surgeon, who will ultimately be the critical decision maker in this problem-set, has no awareness that this even occurred and has a diagnostic certainty of zero (DC(t0)=0). At ten minutes from the time of injury (t10) the patient is brought to the emergency department by his friends and is encountered by the trauma surgeon. This is the time of meaningful contact (tMC). At this point in time the trauma surgeon rapidly ascertains, through observation and discussion, that the patient is a healthy 25 year-old male who fell 8 ft off a ladder and landed on his left back/side and “had the wind knocked out of him.” He is awake, alert, oriented and generally appears stable. The patient complains of significant pain in his left chest and flank but otherwise denies any other injuries, complaints, or loss of consciousness. The patient has no significant past medical or surgical history. At this point in time (tMC) let's assume that the trauma surgeon has 50% diagnostic certainty regarding the presence of two potential life threats that would be likely to exist in this patient's presentation; a splenic injury and/or pneumothorax.

The trauma surgeon has multiple decisions to make but the fundamental underlying critical decision is, “does this patient have a life-threatening injury(ies) (splenic injury and/or a pneumothorax) that requires intervention to mitigate and avert the threat?” In the risk-context of a Level I Trauma Center, the trauma surgeon has multiple diagnostic interventions available to answer that question relatively rapidly. The trauma team gets the patient's vital signs, performs a physical exam and an ultrasound exam (E-FAST), gets a bedside chest x-ray, and a point of care hemoglobin. Collectively, these diagnostic interventions take 10 minutes to acquire and result, with results obtained at t20, 20 minutes from the time of injury. During this 10 min interval diagnostic certainty did not appreciably change except for the information extracted through clinical assessment, which revealed the patient is largely stable and likely has left sided rib fractures. At 20 minutes from injury (t20), when the diagnostic interventions are resulted, they reveal that the chest x-ray and ultrasound are negative for evidence of pneumothorax, the ultrasound shows a small amount of free fluid in the abdomen (intraperitoneal free fluid), the point of care hemoglobin is within normal limits, and vital signs are grossly stable and not indicative of acute decompensation. Now, at t20, diagnostic uncertainty drops to, let's say, 15% regarding the diagnosis, a likely injury to the spleen or its blood supply.

The question now becomes, “has a diagnostic certainty threshold been reached to intervene?” There are several possible courses of action to intervene in order to mitigate or avert the problem-set of a splenic injury. A mitigating intervention is to administer blood to counteract the internal bleeding resulting from the injury. If the splenic injury is not severe, it may be sufficient to administer blood while the body's internal mechanisms (blood clotting) stop the bleeding (avert the risk) and then observe the patient for a period while they are most at risk of decompensation. If the injury is severe and resultant bleeding outpaces the body's compensatory mechanisms and reserves, then surgery (to remove the spleen and tie off blood vessels) is required to avert the underlying determinative risk (bleeding to death from the splenic injury). Many physicians and surgeons would agree that the patient has met the diagnostic threshold to administer blood at this point. In a stable patient, such as this one, in the risk-context of a Level I Trauma Center most physicians and surgeons would likely agree that surgery (an exploratory laparotomy) is NOT indicated at this point—that is to say that the diagnostic certainty threshold has not been met to apply the (high) risk of intervention of surgery. Thus, the decision is made to get another point of care hemoglobin, start blood, and take the patient for a computed tomography (CT) scan of the abdomen-pelvis with intravenous (IV) contrast to more fully evaluate the spleen and gain more diagnostic certainty.

At time t30, thirty minutes from the time of injury, the CT scan is complete. It demonstrates a Grade IV splenic laceration with significant intraperitoneal free fluid consistent with acute bleeding. The patient requires emergent surgery. The repeat hemoglobin has been resulted and demonstrates a two-point drop from the initial hemoglobin. Also, the patient's heart rate steadily increased and his blood pressure steadily dropped during the ten-minute interval from t20 to t30. He now appears pale and is sweating (diaphoretic). The trauma surgeon is now confronted with an unstable patient with a CT scan demonstrating an underlying splenic injury requiring surgery. Diagnostic uncertainty is now approaching zero and the diagnostic certainty threshold for intervention has been met (and likely exceeded at a level of 99+% diagnostic certainty based on information presented). Fortunately, the patient is receiving blood to mitigate the risk. However, the time of intervention efficacy (tIE) for the blood may not have yet been reached but, at least, the patient and the trauma team will not be behind the curve and the patient is on track to receive excellent care.

This scenario is a simplified example of the complexities of a trauma scenario and associated diagnostic (un) certainty and decision making. It is captured in FIG. 10. A few additional points: 1) Diagnostic uncertainty and certainty curves will frequently demonstrate some type of “stair step” pattern, which demonstrates the way in which new information leading to decreasing diagnostic uncertainty or increasing diagnostic certainty is often quantized. Critical decision makers are frequently confronted with new information that effects their level of diagnostic (un) certainty in aliquots. However, some new diagnostic information will be obtained in more of a “smoothed out” fashion, such as through clinical observation of a patient over time, that will often be a reflection of the shape of the underlying DR curve (reference FIG. 5A—the DR curve and DU curves move in opposite directions with the same shape). 2) There is almost always some time lag between the diagnostic certainty of the critical decision maker and the actual state of the underlying determinative risk. For example, if the point of care hemoglobin test (to look for evidence of bleeding) takes 5 minutes to perform and result, then, at the time it is resulted, it provides the decision maker information about the patient's hemoglobin level 5 minutes ago, not right now when it is resulted. This contributes to the quantized stair step nature of diagnostic certainty-enough diagnostic certainty is obtained to guide some future diagnostic step, then that step is taken and time elapses for it to be resulted during which little or no more diagnostic certainty is obtained, then that step is resulted and you realize another gain in diagnostic certainty (or not), and this continues until some threshold of certainty is reached.

One of the critical capabilities of the PreDICT system is to decrease the “stair step” pattern of diagnostic (un) certainty curves by markedly shortening the plateaus (or relative plateaus) in the curve by obtaining near immediate results of diagnostic interventions to include interpretations of standard-of-care diagnostic interventions, multiple other sensor devices, such as wearables, and through performing non/minimal contact artificial intelligence “clinical observation.” The result is that the PreDICT system will decrease tDX and, in turn, tOR. While the patient in our example has a high likelihood of survival, this likelihood could have been further enhanced if the diagnostic certainty threshold to take him to the operating room was reached at t20 rather than t30—the absolute risk would have been lower (he was not yet decompensating at t20) and the risk density of time would have been lower (more time to mitigate and avert the underlying risk (splenic injury)) before the terminal outcome (death due to hemorrhage) at time terminal. The result of intervention at t20 rather than t30 would have been increased relative benefit (RB).

### Putting it all Together: Equation 6

FIG. 11 depicts functions and curves that we considered above combined into one graph, including operational risk and an example of mitigating the determinative risk. This figure is effectively a graphical representation of a time-constrained problem-set. It includes the four fundamental risk-variables of a time-constrained problem-set: 1) Determinative risk (DR), 2) Risk of Diagnostic Uncertainty (DU), 3) Interventional Risk (IR), and 4) Operational Risk (OR). Because we are primarily concerned with relative benefit (RB), determinative risk is depicted as its complement, potential benefit (PB=1-DR) and diagnostic uncertainty is depicted as its complement, diagnostic certainty (DC=1-DU).

Earlier, we examined equation 5:

$$RB ( tOR ) = [ D C ( t DA ) \times PB ( t O R ) ] - I R ( t I )$$

Equation 5 gives the relative benefit at a specific point in time (tOR) within the problem-set. What we really want to know from a critical decision-making standpoint is, what is the total relative benefit, for the problem-set and into the future, yielded by decisions and actions in the present (tDA and tI)? In a medical problem-set, we may wish to calculate RB out to the expected natural life of the patient. This requires solving equation 5 while considering some of the risk-variables over time; solving them as integrals. This yields equation 6:

$$RB ( tOR ) = [ D C ( t DA ) \times {\int }_{tOR}^{tX} P B ( t ) d t ] - [ ( {\int }_{tI 1}^{tY 1} IR 1 ( t ) dt ) + … + ( {\int }_{tIn}^{tYn} IRn ( t ) d t ) ] \qquad Equation {6}^{*}$$

### Where:

tX—
Mitigating DR: tX=tT′
Averting DR: tX=tR
tY—
tY=the time at which an interventional risk (IR) “extinguishes” or a future time selected as a boundary on the problem-set, whichever comes first.

*Note: Equation 6 is only one possible quantitative interpretation of the time constrained, expected value, optimal stopping problem. For example, the equation could also be expanded to account for the determinative risk from 10 to tOR as follows:

$$RB ( tOR ) = [ D C ( t DA ) \times {\int }_{tOR}^{tX} P B ( t ) d t ] - \{ [ ( {\int }_{tI 1}^{tY 1} IR 1 ( t ) dt ) + … + ( {\int }_{tIn}^{tYn} IRn ( t ) d t ) ] + [ ( 100 \times tOR ) - ( {\int }_{t 0}^{tOR} P B ( t ) d t ) ] \}$$

This interpretation accounts for the latent DR from the DR onset until the DR is successfully mitigated or averted. Ultimately, the quantitative interpretation used to resolve any time-constrained problem-set will depend on factors specific to that problem-set. Furthermore, whatever specific quantitative interpretation is used, it will be important to normalize relative benefit (RB) results against an empiric or otherwise determined baseline or comparative example for that quantitative interpretation.

Within the time-constrained problem-sets we have been discussing there are essentially two distinct optimal stopping problems: 1) High Diagnostic Uncertainty and 2) Low Diagnostic Uncertainty. The high diagnostic uncertainty problem occurs when the critical decision maker has relatively low diagnostic certainty about the underlying DR and confronts the critical decision maker with the following questions:
Is it better to intervene earlier with more diagnostic uncertainty risk or is it better to intervene later with less diagnostic uncertainty risk at the potential cost of increasing determinative risk during the interval required to attain the additional diagnostic certainty?
How does intervening later affect the time of operational risk (tOR) relative to time terminal (tT)?
Will increasing DR and risk-density of time require higher interventional risk (IR) to mitigate or avert DR if IR is applied later?

Stated differently, is (DR(t2)-DR(t1)) greater than, less than, or equal to (DU(t1)-DU(t2))? AND/OR does a later intervention result in tOR>tT or an otherwise unacceptable risk-density of time? AND/OR will a delay in intervention require higher interventional risk (IR)? These considerations will determine the optimal point in time for the function DC(t) and, in turn, the diagnostic certainty threshold for intervention. Note, if the delta in DR and DU is equivalent for the time interval then earlier intervention is favored because it decreases the risk-density of time and protects against the risk of requiring higher IR at the future time.

The low diagnostic uncertainty problem occurs when the critical decision maker has a relatively high degree of certainty about the underlying DR, such as the terminal outcome of DR and the timeframe at which it will occur (time terminal, tT), and confronts the critical decision maker with the following questions:
Is it better to apply a higher risk intervention now or is it better to apply a lower risk intervention later at the risk of the increased DR in the interval?
Do the constraints of tOR for the lower risk intervention relative to tT even make the future, lower risk intervention a viable option or is tOR>tT or the risk-density of time unacceptably high?

The existence of this low diagnostic uncertainty decision and question seemingly contradicts an earlier statement that interventional risk (IR) generally increases with time. It does generally increase with time and the existence of this decision does not contradict that. What this decision considers is the time cost of transitioning from one (higher) risk-context to another (lower) risk-context. We will discuss risk-context in more detail below but, for now, understand that determinative risk (DR) is effectively the same, without intervention, irrespective of risk-context. Also, understand that within any given risk-context the interventional risk required to mitigate or avert the underlying DR will generally increase with time. However, whether it does or does not, the same intervention required at time “X” may carry a different level of interventional risk (IR) in one risk-context versus another. For example, at tX a patient requires surgery to repair a hemorrhaging blood vessel after suffering penetrating trauma. The interventional risk (IR) associated with the procedure will be lower at a Level I Trauma Center in the US with extensive resources in a modern, sterile hospital facility than it will be in a rapidly established temporary medical facility in Afghanistan with a small surgical team working out of ruck sacks. The Level I Trauma Center is a different risk-context than the small medical facility in Afghanistan. This is an extreme example but, another example where this decision plays out every day in the US, and has already been made at a system level, is the interplay between emergency medical services (EMS) and specialty medical centers for time critical illness and injury such as Trauma, STEMI (cardiac), and Stroke centers. When patients encountered by EMS meet certain criteria (i.e. there is some relatively high level of diagnostic certainty relative to the EMS medical providers' expertise) for the conditions mentioned above, those patients are transported directly to the relevant specialty center even if it means bypassing a closer medical facility and increasing (at least part of) the time of operational risk and potentially allowing the underlying DR to progress during the increased transport time. The critical decision has been made to implement a system that trades the risk of time for lower interventional (and other risk) by placing the patient in a more favorable risk-context (the relevant specialty center). The PreDICT system has the capability to improve or alter this paradigm by both favorably altering the risk-variables within the problem-sets across all risk-contexts (i.e.—decrease risk associated with treatment at a non-specialty center vs a specialty center) and by computing the risk-variables in the decision to bypass a closer hospital for a specialty center at an individual patient level (rather than a systems level) and at machine speeds.

### Risk-Context:

The risk-context is the context in which a determinative risk (DR) manifests and this context, in turn, affects the risk-variables, particularly operational risk (OR), and, together with the determinative risk, defines the problem-set. Another way to understand this is that a particular problem-set is defined by a determinative risk in a particular risk-context. Risk-context has three domains: 1) Environment, 2) Systems, and 3) Components. The environment domain is shaped by broad forces such as climate, weather, terrain, social and cultural factors, politics, economics, security, and certain infrastructure. The systems domain considers systems that have been established to address, in full or part, determinative risks and/or other types of risk. These include the military, EMS and health systems, law enforcement, fire departments, emergency management bureaucracies, educational systems and initiatives, communications and power systems, FEMA, NOAA, DOE, and multiple other governmental agencies, non-governmental organizations (NGOs), private industry, and other civic, religious, or other entities/systems that exist to address specific risks or areas of risk. The component domain includes those components (human and material resources) that are directly part of and required to resolve the problem-set and mitigate or avert the underlying determinative risk. For example, for a patient experiencing chest pain due to a heart attack at home these components include the patient, the ability to communicate and activate the EMS system (a phone to call 9-1-1), transport to a STEMI (cardiac) center with medical care in route (an ambulance staffed with paramedics), and, upon arrival to the hospital, doctors, nurses, techs, clerks, medications, and specialized equipment to mitigate and avert the underlying risk (resolve the coronary artery blockage causing the heart attack). Components and systems have both task-specific expertise (humans) and capability (materials) and operational expertise (humans) and functionality (materials). Task-specific expertise entails the knowledge, skills, and critical decision making that component humans or systems apply to mitigate or avert the determinative risk. Task-specific capability refers to the task-specific capability of material and other resources that are implemented to mitigate or avert determinative risk. Operational expertise entails a broad and functional understanding of the risk-context (system and environment) and a decision-making framework that, together, potentiate the optimal application of task-specific expertise to mitigate or avert the determinative risk within that risk-context. Operational functionality is the principle that components and systems align with other domains of the risk-context to optimally provide an intended function to mitigate or avert risk. The environment domain determines what system and component domains can be supported. The system domain shapes the components and/or the components shape the system. Ultimately, the components coalesce within the system to (ideally) mitigate and avert the underlying determinative risk and resolve the problem-set.

Risk-contexts exist across a spectrum from predictability risk-context (PRC) to adaptability risk-context (ARC). In a predictability risk-context (PRC), components and systems are purposefully trained and designed to manage specific types of determinative risk within an environment under a certain range of conditions. Components have the task-specific expertise and capability to mitigate or avert the determinative risk and the operational expertise and functionality to optimally apply the task-specific expertise or capability in the system and environment. Likewise, the system collectively has the task-specific expertise and function to support components in mitigating or averting determinative risk and the operational expertise and functionality to optimally do so within the range of environmental conditions for which it is intended. Decision makers in a PRC are primarily dealing with known-knowns and known-unknowns. At the extreme of an adaptability risk-context (ARC), the components and systems required to mitigate or avert the determinative risk do not exist and the environment cannot, or does not easily or rapidly, support their training, design, and/or implementation. There are multiple permutations of risk-context between the extremes of predictability and adaptability. Generally speaking, a risk-context trends towards predictability when the necessary component expertise and capabilities to mitigate or avert the determinative risk are confronting the determinative risk within a system purpose built to mitigate or avert the determinative risk under environmental conditions for which the components and systems were trained, designed, and implemented to optimally function. A risk-context trends towards adaptability the less these characteristics are present. This occurs when task-specific expertise or capability does not align with the determinative risk, operational expertise does not align with the system or environment, the system does not align with the components or environment, or the environment is highly dynamic and/or presents conditions that are outside the intended parameters for optimal component or system function. From the standpoint of a decision maker, an adaptability risk-context has many more degrees of freedom affecting the fundamental risk-variables of the problem-set that must be recognized, considered, and computed in order to optimally mitigate or avert the underlying determinative risk. Decision makers in an ARC may be dealing with known-knowns and known-unknowns but they are also dealing with many unknown-unknowns and variables and cause-and-effect relationships that are opaque or unknowable, at least within the time constraints of the problem-set.

A key point for decision makers to understand is that expertise, capability, and function are contextual and, consequently, to expertly and optimally resolve a problem-set the decision maker(s) require not only expertise regarding the determinative risk but also expertise regarding the risk-context in which the determinative risk is nested. Many problem-sets may not be optimally resolved not because decision makers lacked expertise related to the determinative risk but because the expertise was applied in a risk-context for which it was not developed or intended. This can occur through a failure of recognition of a change in risk-context or a failure of acceptance of a change in risk-context. In either case, it is a failure of adaptability that humans, and perhaps more so experts, are susceptible to. Expert components (decision makers) in a problem-set will have a mental model of other components, of the system, and of the environment. This mental model is developed through experience. Within this mental model they will execute habit patterns in response to specific risk stimuli. These habit patterns have developed in a specific risk-context, and mental model, to react to and resolve specific risks. In medicine, these habit patterns are termed “scripts” and can be thought of as what we frequently refer to as standards-of-care. The standard of care for a particular determinative risk is the habit pattern that relevant experts know (or believe) will produce the highest probability of an optimal outcome for a specific determinative risk in a specific context. There are multiple recognized cognitive errors in medicine and other human domains where decision makers apply a mental model, often that they have developed through experience, that does not align with the problem-set they are confronting. Subsequently, they execute habit patterns corresponding to the mental model and not the actual problem-set. When the risk-context changes and corresponding mental models and habit patterns to do not, decision makers are susceptible to the liability of negative habit pattern transfer-a habit pattern with a salutary effect in one context is applied in another context and either does not have the intended outcome or has a negative outcome.

Consider a 20 year-old healthy male with a gunshot wound to the abdomen. Imagine this patient in the risk-context of major metropolitan area in the United States on a “normal” day. Now, imagine this same patient in a different risk-context, on a mountain in Afghanistan in the middle of a firefight at night. The determinative risk is the same in each scenario but the risk-contexts and, in turn, the problem-sets are very different. Let's consider the problem-sets through the lens of the trauma surgeon, who is the expert and decision maker ultimately responsible for mitigating and averting risk to the patient. His/her goal is to minimize the time of operational risk (tOR) and successfully intervene to avert the determinative risk. In the first scenario in the U.S., there are systems and components enabled by the environment to optimally resolve the problem-set. Much of the expertise and critical decision making required to resolve the problem-set is embedded in the system. From the trauma surgeon's perspective, he/she will predictably receive the patient via EMS and then, in response to whatever stimulus the patient presents, must efficiently execute the corresponding habit pattern in conjunction with a team who shares the same mental model and relevant habit patterns within that mental model. The trauma surgeon does not need to consider how the patient gets to the hospital, what functions other human components will perform in the trauma bay, how any necessary radiographic imaging will be performed, where they will get blood products from, what to use as a light source in the operating room, etc. He/she largely just needs to execute a habit pattern in conjunction with and supported by other medical experts. Now consider the problem-set in Afghanistan. In this case there are many more frictions that might serve to increase the tOR, increase diagnostic uncertainty at any given time, and increase the risk of intervention. For starters, there are many more decision makers involved in the problem-set and many/most are not medical experts and are not working within a system expressly designed to resolve medical problem-sets. One potential consequence of this is that they don't share a mental model of the problem-set. First, a decision needs to be made by a ground force commander if the patient needs to be evacuated to medical care and when given multiple other mission related considerations. Then, other decision makers, such as a task force commander and an air mission commander, need to release a helicopter to evacuate the patient. This all takes time and may depend on multiple variables-kinetic threats, weather, other ongoing operations with competing requirements, etc. During this time, the patient may be getting hypothermic, worsening his physiologic dysfunction and shifting time terminal to an earlier point in time. Once the patient is evacuated from the mountain, he is transported to the trauma surgeon, who is located with a small surgical team and security element in a building of opportunity a short time-of-flight from the objective where the patient was injured. The surgeon and the surgical team need a plan and resources to transport the patient into their makeshift trauma bay from the helicopter, they need light to adequately assess the patient and operate, they may need imaging capability, blood, and medications beyond whatever they have with them. This may lead to other critical decisions by the trauma surgeon whether the patient should undergo surgery at the current location or be transported, at the risk of time elapsed and worsening physiological dysfunction, to a more capable facility. Ultimately, the point is that the same determinative risk (a gunshot wound to the abdomen) in the same patient can present a very different problem-set by virtue of manifesting in a different risk-context. The second scenario (in Afghanistan), which represents an adaptability risk-context, has many more degrees of freedom affecting underlying risk-variables than the first scenario (in the U.S.), which represents a predictability risk-context.

A key function of the PreDICT system is to acquire data regarding risk-context and recommend courses of action based on the effects of risk-context on the fundamental risk-variables of the problem-set: determinative risk (DR), diagnostic uncertainty (DU), interventional risk (IR), and operational risk (OR). Human decision makers require working memory (a frontal lobe function) to process different courses of action. Under optimal cognitive circumstances, humans can process four to six courses of action. Under stressful circumstances frontal lobe function and working memory is diminished. The PreDICT system can process orders of magnitude more courses of action, at machine speeds, without being compromised by the effects of mental and physical stress, cold, hunger, fatigue, etc. Essentially, the PreDICT system can rapidly generate new mental models for dynamic and/or evolving risk-contexts and recommend optimal courses of action (i.e. habit patterns) to decision makers within the time constraints of the problem-set. This allows problem-sets with multiple decision makers, especially if they are separated in time and space, to rapidly gain understanding of the problem-set and build a shared mental model. It also diminishes the risk of the liability of negative habit pattern transfer by individuals, teams, and/or systems.

The PreDICT system will function across the risk-context spectrum from predictability to adaptability risk-context. However, many of the most compelling use cases arise in adaptability risk-context scenarios where required human expertise is either deficient or absent and/or key infrastructure, such as network access, is absent or compromised and/or the situation is highly dynamic and uncertain and/or the situation is highly complex due to multiple decision makers or other factors. The PreDICT system may employ different network and computing architecture in different risk-context scenarios in order to optimize the functionality versus the employability of the technology in the different risk-context scenarios. Below, we will consider some of the different network and computing approaches that PreDICT will employ.
Embedded Application: The PreDICT system may exist as an application on a local device (such as, but not necessarily, a smartphone) and have full functionality independent of a network. The application is periodically updated, either automatically or deliberately, when the device connects to a network/cloud.
   Advantages: Can function in austere environments where network capability is non-existent or in cases, such as natural or manmade disasters, where network infrastructure is compromised. This functionality is optimal for adaptability risk-context (ARC) scenarios. An important consideration in military applications is that any contemporary or future near-peer or peer on peer military conflicts will entail multi-domain operations (MDO) with a contested electromagnetic and communications spectrums and/or may entail extensive submarine, subterranean, or urban operations that challenge network and communications capabilities.
   Limitations:
      In the absence of a network, computing power and bandwidth is limited to the capacity of the device on which the PreDICT application is embedded at the particular time at which the PreDICT system is being employed.
      Decision makers confronting problem-sets that would benefit from the PreDICT system may not have access to, or even knowledge of, the PreDICT system. For example, a layperson out jogging witnesses a fellow jogger experience cardiac arrest while trail running in an isolated wooded park. The layperson does not have the PreDICT system on their smartphone and are not aware that such capability exists. Thus, neither the patient or decision maker (the layperson) can benefit from the PreDICT system capability in this scenario if the only mechanism of employability is a device embedded application.
   Caveats: In specific scenarios with controlled populations, one or both of the following approaches can be employed to decrease computing requirements. Consider the example of an infantry platoon consisting of forty Soldiers conducting a deliberate mission in enemy territory. They will employ the PreDICT system as an augmented intelligence capability for medical decision making and treatment as an application on a smartphone platform. The primary medical pathology of concern is trauma.
      The population is known. Baseline physiologic, voice, motion, and other medical data for each of the forty Soldiers can be collected using the PreDICT sensor capabilities and medical records data and uploaded to the PreDICT application prior to the mission.
      The most likely medical pathology to be encountered is known, trauma. The Soldiers can selectively upload and/or employ only the functionality of the application relevant to trauma pathology.
      Characteristics of risk-context are known. The Soldiers can set the parameters of the PreDICT system to discount certain risk-variables in the risk-context in order to achieve more computational bandwidth at the expense of the PreDICT system having a less complete picture of the problem-set. The PreDICT system can evaluate risk-variables in the risk-context and make recommendations to the user(s) regarding the tradeoffs between potential loss of fidelity on the problem-set and gains in bandwidth and computing power. For example, a concurrent mission in another part of the area of operations (AO) may simultaneously require medical evacuation assets if Soldiers are injured on both targets. If this contingency occurs it may affect the interventions and courses of action that the PreDICT system recommends but, accounting for this contingency requires more computing power. Prior to the mission, the PreDICT system and/or the Soldiers can evaluate the probability of this contingency occurring and the consequences if it does occur and, based on these factors, consider discounting this risk-variable from the PreDICT system's decision-making calculus regarding the problem-set.
Network/Cloud Based Application: The PreDICT system may exist as a network/cloud-based application independent of any specific platform and receive input data from multiple sensors and sources and be updated in real time as the machine learning/artificial intelligence processing and analysis “learns.”
   Advantages: Potentiates greater computing bandwidth and power and allows all users to benefit from the most up-to-date machine learning/artificial intelligence derived from all users on the network. The network/cloud based PreDICT application can utilize any/all information available to the network to make decisions and recommendations. This is ideal for predictability risk-context scenarios such as employment within a hospital functioning within baseline parameters (e.g. electrical power and network function are operational).
   Limitations: Requires an operational network and connectivity to the network.
   Caveats: Some PreDICT functionality is maintained at a local device level to protect against network outages. For example, while the PreDICT system is being applied to a specific case using, for example, a smartphone as the sensor and interface, key information and “bookmarks” about the case are downloaded on the smartphone to allow some continued PreDICT functionality regarding that specific case even if network access is lost.
Hybrid-Functionality distributed between device(s)/network(s)/cloud:
   Example 1—The PreDICT processing and analytic functionality is distributed across a device with the PreDICT application, network, and cloud.
In a predictability risk-context, such as a hospital under normal conditions, this may present as a combined sensor platform-processing-analytic device, such as a smartphone with sensor capability, communicating with a network and cloud for additional data capture (such as from a medical records system) and more robust data processing and analysis.
In an adaptability risk-context, such as caring for an injured Soldier during an ongoing kinetic engagement, the fundamental relationship between device, network, and cloud may be the same but the degree of processing at each level may differ and the nature of the network and frequency of communication with other networks or the cloud may differ. For example, the device may interface with an edge computing network that may only communicate with other networks and/or the cloud at intervals, perhaps infrequently. Depending on the problem-set and associated time-constraints, these intervals may obviate drawing on the computational power of networks beyond the edge network. In such contingencies or in expectation of such contingencies, users can implement strategies for employment to decrease bandwidth requirements, such as using baseline data for potential patients/subjects as discussed above.
   Example 2—The PreDICT processing and analytic functionality is distributed across multiple devices with the PreDICT application through Bluetooth or other local inter-device communications capabilities and/or across edge computing networks and/or across devices and edge computing networks.
   Example 3—A device without the PreDICT application connects to a network (+/− cloud) and the device is used by the network to perform some component of the data processing and analysis. For example, a layperson with a smartphone that does not have the PreDICT application contacts an emergency network/system, such as 9-1-1. The 9-1-1 system then utilizes the device to implement PreDICT functionality. Such implementation of the PreDICT system may utilize PSAPs within the emergency network. This functionality would also exist with similar network infrastructure in secure and unsecure, classified and unclassified military, maritime, disaster or other communications networks.
   Example 4—Multiple decision makers at multiple locations with different computing and connectivity resources requiring different information to make different but interdependent decisions to resolve the same problem-set.
      Consider the problem-set of a hypothetical large-scale military operation with multiple units taking casualties in multiple locations. We will examine the problem-set from the perspective of three different decision makers and the computing resources required and available to them.
      Decision Maker 1: A platoon medic treating a casualty during an ongoing firefight. He has a smartphone with the PreDICT application embedded. Successful resolution of the problem-set requires that the patient's injury (determinative risk) risk is mitigated and averted. This requires stabilizing (mitigating) treatment in the field followed by rapid evacuation to a surgical team.
      Decision Maker 2: A taskforce commander in a joint operations center (JOC) overseeing the entire military operation. The JOC has extensive network and cloud computing capability. Successful resolution of the problem-set requires that the objective of the operation is successfully prosecuted with as few friendly deaths as possible.
      Decision Maker 3: The surgical team leader at the medical facility receiving casualties from the operation. Her facility has network capabilities but not at the scale of the JOC. Successful resolution of the problem-set requires that, of the casualties sustained in the operation, her surgical team minimizes resultant morbidity and mortality.
      The goals of each decision maker intersect with respect to the injured Soldier under the care of the medic-they all want the Soldier to live. But, they all need different information at any given time and all have different resources to process and analyze that information.
      Decision Maker 1 requires specific information about the patient's condition and information about when the medical evacuation MEDEVAC) helicopter will arrive in order to optimally mitigate the injuries and associated risk over a known period of time.
      Decision Maker 2 needs to know the risk (consequence and probability) and time-constraint on that risk (i.e. what is the probability the patient will die and when) on every casualty in the battlespace and then needs to allocate MEDEVAC assets accordingly. He also needs to know what other high-risk engagements are ongoing. He doesn't need granular details about any patients' medical condition.
      Decision Maker 3 needs to how many casualties are in the battlespace, needs accurate but not granular details on their medical status, needs to know when each patient will be arriving, and needs a general understanding of the phase of the operation—is it over or will it be ongoing for another twelve hours with the potential to produce many more casualties. This allows the surgical team and facility to optimally prepare and sequence resources and capabilities.
      Decision Maker 1 only requires the computing capability for the PreDICT system to process and analyze data on his single patient. Other key information, such as when the MEDVAC helicopter will arrive can be computed on the PreDICT system at the JOC level and pushed to his PreDICT platform over a communications network.
      Decision Maker 2 has adequate computing capability to process and analyze all incoming data. However, the PreDICT capability being employed by the medic only needs to push the data required for the commander/JOC level PreDICT system to solve the MEDEVAC allocation versus total casualties in the battlespace problem-set.
      Decision Maker 3 has intermediate computing capability and also has different information requirements that are a hybrid of information at the level of all medics in the battlespace and the JOC. She needs to know how many patients require what resources and when and the probability of future resource requirements. The PreDICT capability at her location can receive only this relevant information to ensure that the network has sufficient local processing and analytic capability to determine optimal resource allocation and sequencing.

### SUMMARY

The time-constrained, future value, optimal stopping problem model described above demonstrates both a functionality of the PreDICT system and a type of problem-set that the PreDICT system will resolve. The discussion of risk-context is intended to illustrate the range of complexities that decision makers may confront in resolving a problem-set and how a range of problem-sets can exist even for the same underlying determinative risk (DR).

In both the functionality of the PreDICT system and in the realities of the human and physical world the quantitative model described above is more complex than described here for the purposes of illustration and conceptual understanding. From the standpoint of PreDICT functionality and reality, possibility-sets resolve into probability-sets which ultimately resolve into problem-sets, often in a dynamic, non-linear fashion. Thus, the model examined above is playing out multiple times in parallel and serial with forward and backward equilibrium between possibilities, probabilities, and phases and risk-variables within the model until an outcome is reached; either in the form of the DR being mitigated or averted or in the form of the terminal outcome being realized at time terminal. Furthermore, if a calculation of relative benefit (RB (t)) is desired out to a time beyond tT′ or tR, the model will effectively re-set and reapply to the new problem-set. There are also some assumptions in the model as presented above that are accounted for in the functionality of the PreDICT system. For example, in the model, interventional risk (IR) is accounted for once the intervention is complete. In reality, interventions (both diagnostic and therapeutic) impart risk prior to completion and have variable levels of risk during implementation and after completion that may or may not extinguish at some future time. The PreDICT system can account for this.

Another important concept examined above is that of “time-constraint.” There are periods of time of sufficiently short duration that most humans would agree that they present a time-constraint for resolving any problem-set within them. Furthermore, there may be a clear time-constraints on a problem-set that, while relatively long in duration, nonetheless represents a time-constraint, such as a deadline. With respect to the PreDICT system and the time-constrained problem-sets under discussion, those categories of time-constraints apply. However, what is also applicable is the concept of “risk-density”—the time-constraint (or potential time-constraint) established by the underlying determinative risk relative to the time of operational risk (tOR) required to mitigate or avert the determinative risk. In other words, how much time is afforded by the problem-set relative to the amount of time required to resolve the problem-set. At a fundamental level, with respect to time-constrained problem-sets, the function of the PreDICT system is to decrease the risk-density of time by decreasing tOR and the associated interventional risk required to ultimately mitigate or avert the DR within tOR.

Specific benefits and capabilities of the PreDICT system, relative to the model described above, are listed below. The PreDICT system achieves these capabilities by using various data inputs, processing, and analysis to elucidate patterns and indicators that are below and/or outside the threshold of human sensory capabilities and cognition at superhuman speeds and capacity. These include patterns and indicators, including capabilities, limitations, and constraints, at all levels of the problem-set to include the determinative risk and the risk-context and its three domains; environment, systems, and components.
Rapidly recognize and differentiate a problem-set from a possibility-set and probability-set resulting in an earlier time of meaningful contact (tMC). Essentially, it can recognize that a problem-set exists earlier and define that problem-set earlier than human sensory and cognitive capabilities.
Increase both the time and risk efficiency of attaining diagnostic certainty and/or the diagnostic certainty threshold:
   Rapidly attain a diagnostic certainty threshold (tDx) and/or markedly improve the ratio of diagnostic certainty relative to time. The PreDICT system can achieve an equal or higher level of diagnostic certainty in less time than humans are capable of.
   Rapidly achieve diagnostic certainty threshold (tDx) and/or markedly improve the ratio of diagnostic certainty relative to time with less interventional risk (IR) through the use of non-contact and minimal-contact sensors and data acquisition. The PreDICT system can achieve a higher level of diagnostic certainty with less interventional risk than current standards-of-care by requiring less invasive or risk-bearing diagnostic interventions.
Decrease the time to the decision to act (tDA) and the risk appropriateness of the decision to act by evaluating the risk-benefit of potential interventions (including inaction) for the determinative risk (DR) in the risk-context and by providing recommendations on the optimal sequencing and logistics of interventions in the risk-context.
Decrease the time to intervention (tI) and relative risk of therapeutic intervention by computing and recommending or enacting the most efficient intervention course(s) of action for the determinative risk in the risk-context.
Decrease the time to intervention efficacy (tIE) by calculating tIE as a component of recommended interventions.
Decrease time of operational risk (tOR) by decreasing the time and risk efficiency of its additive components: tMC, tDx, tDA, tI, tIE. The PreDICT capability can function or be employed at multiple levels to decrease one, some, or all of these components.
Enhance Adaptability:
   Non-Experts: The PreDICT system creates a “mental model” of the problem-set and recommends interventions and courses of action. Non-experts, by definition, do not have well developed mental models or habit patterns in their area of non-expertise. The PreDICT system effectively provides a level of task-specific and operational expertise to non-expert decision makers.
   Experts: The PreDICT system creates a “mental model” of the problem-set and recommends interventions and courses of action. Experts have well developed mental models and habit patterns. This makes them susceptible to the risk of the liability of negative habit pattern transfer in novel problem-sets with similar or identical cues and stimuli to familiar problem-sets. In such cases, experts may apply mental models and, in turn, habit patterns, based on prior experience that do not optimally align with the reality of the novel problem-set. While experts in such novel problem-sets may have most or all of the required task-specific expertise to mitigate or avert the determinative risk they may lack the relevant operational expertise to optimally apply their task-specific expertise in the novel risk-context. The PreDICT system effectively provides experts with operational expertise by providing a rapidly updated mental model and recommendations on interventions and courses of action to potentiate the optimal application of their task-specific expertise.
   Groups: In many cases, problem-sets require multiple simultaneous decision makers. In order for decision makers to optimally resolve the problem-set they require a shared and accurate mental model. This is difficult to achieve in complex, rapidly emerging, time constrained problem-sets, particularly if decision makers are separated in time and/or space and/or do not have access to the same information and/or a similar ability to interpret the information. The PreDICT system provides multiple decision makers, including those separated in time and/or space, with the same information and interpretation of that information to create a shared and accurate mental model and recommendations for interventions and courses of action.

The model discussed above was developed through the lens of medical determinative risk in high-consequence, dynamic, austere risk-contexts. However, this model applies across multiple human decision-making domains outside of both medicine and the risk-contexts where it was conceived. It applies whenever a decision maker confronts a potential or actual determinative risk which will, unavoidably, manifest in some risk-context and present a problem-set. The PreDICT system provides an augmented intelligence capability through the use of multiple sensors and data acquisition streams to acquire, process, and analyze information both “down and in” (the determinative risk) and “up and out” (the risk-context) and provide optimal recommendations to decision makers. Beyond the PreDICT system's medical capability and functionality there are multiple other applications, some (but not all) of which are illustrated in the use and dual-use cases section of this document.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in defeating and testing camouflage strategies, comprising:
providing a processing platform operative for one or both of a spatial analysis and a temporal analysis of sensor data; and
operating a processing platform for:
obtaining first sensor information of an area of interest;
first processing the sensor information to provide enhanced sensor information, said enhanced sensor information providing enhanced detection of a target in said sensor information;
second processing said enhanced sensor information to provide an output concerning a presence or absence of said target of interest.

2. The method of claim 1, wherein said spatial analysis comprises a computer vision analysis including one or more of object detection, edge detection, blob detection, multi-scale analysis, feature fusion, and an attention mechanism.

3. The method of claim 1, wherein said target of interest comprises a human being.

4. The method of claim 3, wherein said processing platform is operative for distinguishing a human being from another living being.

5. The method of claim 3, wherein said processing platform is operative for distinguishing a living human being from a non-living human being or non-living entity.

6. The method of claim 3, wherein said processing platform is operative for determining information concerning one or both of signs of life and status of life.

7. The method of claim 1, wherein said target of interest comprises one or more of an object, equipment, machinery, vehicles, weapons systems, RADAR and communication installations, and the like.

8. The method of claim 1, wherein said target of interest comprises one or more of a building, trench or tunnel system, airfield, infrastructure and other physical phenomenon.

9. The method of claim 1, wherein said camouflage strategies comprise one or more of a cover, a concealment, and a camouflage material.

10. The method of claim 9, wherein said camouflage strategies comprise a visual camouflage.

11. The method of claim 9, wherein said camouflage strategies comprise one or more of electromagnetic spectrum, to include ultraviolet, visible, infrared, thermal, and radio frequency, to include RADAR, acoustic, or other signature masking technique.

12. The method of claim 1, wherein said sensor information comprises one or more still images.

13. The method of claim 1, wherein said sensor information comprises a live video.

14. The method of claim 1, wherein said sensor information comprises a recorded video.

15. The method of claim 1, wherein said sensor information comprises passive sensor information including one or more of a red-green-blue (RGB) video, a grayscale video, a thermal, infrared, or night-vision video, and an ultraviolet video.

16. The method of claim 1, wherein said processing platform comprises a mobile edge device for deployment on or in one or more of a battlefield, an austere environment, or an operationally constrained environment.

17. The method of claim 1, wherein said sensor information comprises information from multiple sensor systems and said output is based on information from one or more of said multiple sensor systems.

18. The method of claim 1, wherein said first processing comprises aggregating the outputs from multiple sensors with different angles and fields of view relative to the target of interest to provide a more complete spatial picture of said target of interest.

19. The method of claim 1, wherein said second processing comprises processing said first information using artificial intelligence/machine learning.

20. The method of claim 1, wherein said processing platform further receives sensor inputs separate from said sensor information.

21. The method of claim 1, wherein said processing platform implements one or both of region of interest and signal of interest processing.

22. The method of claim 1, wherein said signature information concerns at least one of motion, vibration, emission, color change, reflectance, or a bio-physiologic signature.

23. A system for use in defeating and testing camouflage strategies, comprising:
a processing platform operative for one or both of a spatial analysis and a temporal analysis of sensor data;
said processing platform further being operative for:
obtaining sensor information of an area of interest;
first processing the sensor information to provide enhanced sensor information, said enhanced sensor information providing enhanced detection of a target of interest in said sensor information
second processing said enhanced sensor information to provide an output concerning a presence or absence of said target of interest.

24. The system of claim 23, wherein said spatial analysis comprises a computer vision analysis including one or more of object detection, edge detection, blob detection, multi-scale analysis, feature fusion, and an attention mechanism.

25.-32. (canceled)

33. The system of claim 23, wherein said camouflage strategies comprise one or more of electromagnetic spectrum, to include ultraviolet, visible, infrared, thermal, and radio frequency, to include RADAR, acoustic, or other signature masking technique.

34. The system of claim 23, wherein said sensor information comprises one or more still images.

35. The system of claim 23, wherein said sensor information comprises one or more of a live or recorded video.

36. (canceled)

37. The system of claim 23, wherein said sensor information comprises passive sensor information including one or more of a red-green-blue (RGB) video, a grayscale video, a thermal, infrared, or night-vision video, and an ultraviolet video.

38. The system of claim 23, wherein said processing platform comprises a mobile edge device for deployment on or in one or more of a battlefield, an austere environment, or an operationally constrained environment. a battlefield.

39. The system of claim 23, wherein said sensor information comprises information from multiple sensor systems and said output is based on information from one or more of said multiple sensor systems.

40. The system of claim 23, wherein said first processing comprises aggregating the outputs from multiple sensors with different angles and fields of view relative to the target of interest to provide a more complete spatial picture of said target of interest.

41. The system of claim 23, wherein said second processing comprises processing said first information using artificial intelligence/machine learning.

42. The system of claim 23, wherein said processing platform further receives sensor inputs separate from said sensor information.

43. The system of claim 23, wherein said processing platform implements one or both of region of interest and signal of interest processing.

44. The system of claim 23, wherein said signature information concerns at least one of motion, vibration, emission, color change, reflectance, or a bio-physiologic signature.

45. A method for use in defeating and testing camouflage strategies, comprising:
operating a processing platform for:
obtaining video information of an area of interest;
first processing the video information using a temporal process to obtain first signature information indicative of the presence or absence of a target of interest, said temporal process involving segmenting individual frames of said video information into elements and monitoring changes of individual ones of said elements over a timeframe of said video information;
second processing said first signature information to provide an output concerning said presence or absence of said target of interest.

46.-128. (canceled)
